(19) United States
(12) Patent Application Publication
(10) Pub. No.: US 2023/0357454 A1
(43) Pub. Date: Nov. 9, 2023

(54) Methods for Delivery of Non-Aromatic Solutions to Polymerization Reactors

(71) Applicant: ExxonMobil Chemical Patents Inc., Baytown, TX (US)

(72) Inventors: Aaron H. Reed, League City, TX (US); Chase A. Eckert, Houston, TX (US); Bradley T. Payne, Pasadena, TX (US); Catherine A. Faler, Houston, TX (US)

(21) Appl. No.: 18/040,314

(22) PCT Filed: May 13, 2021
(86) PCT No.: PCT/US2021/032236

§ 371 Date: Feb. 2, 2023

Related U.S. Application Data
(60) Provisional application No. 63/063,596, filed on Aug. 10, 2020.

(51) Int. Cl. C08F 4/659; C08F 4/6592; C08F 2/06

(52) U.S. Cl. CPC C08F 4/65908; C08F 2/06; C08F 4/65927

(57) ABSTRACT

In some embodiments, a process includes introducing a catalyst solution, via a first line, into a reactor. The catalyst solution includes a catalyst and a first non- aromatic diluent. The process includes introducing an activator solution, via a second line, into the reactor. The activator solution includes an activator and a second non-aromatic diluent. The second non-aromatic diluent is the same as or different than the first non- aromatic diluent. The process includes operating the reactor under process conditions and obtaining an effluent from the reactor. The effluent includes a polyolefin. The first line and the second line are coupled with the reactor.

### CROSS REFERENCE TO RELATED APPLICATIONS

This application claims the priority benefit of U.S.S.N. 63/063,596, filed Aug. 10, 2020, which is incorporated herein by reference.

### FIELD

The present disclosure relates to methods for delivery of non-aromatic solutions to polymerization reactors.

### BACKGROUND

Supplying catalyst to a polymerization reactor and achieving high catalyst efficiency while minimizing undesired consequences has been a challenge for many commercial processes. The problems encountered depend upon the form of the catalyst (i.e., solid, size of particles, liquid, type of diluent, etc.) and the polymerization process being used. The problems encountered can arise from catalyst degradation, poor control of catalyst feed rate, plugging of feed lines, poor mixing of the catalyst with monomers and other polymerization media, introduction of undesired quantities of carrying medium to the process, poor solubility to the polymerization medium or carrying diluent, and concerns of residual diluent in products.

Homogeneous catalysts are used in solution polymerization processes. Many olefin polymerization processes are carried out in the presence of an inert liquid organic diluent, and the polymer produced is dissolved in that inert organic diluent. In an olefin solution polymerization, solutions of catalyst and activator are typically dissolved in a carrying medium (typically an aromatic solvent such as benzene, toluene, xylene, or ethyl benzene) and delivered into the polymerization reactor in a solution form. The catalyst solution is then mixed with monomers and other polymerization medium and the polymerization takes place in the liquid state. The carrying medium can be the same as the diluent used for polymerization, or different types of diluents with better solvency may be used.

Aliphatic hydrocarbon diluents are typically used for solution polymerization of olefins. In contrast, an aromatic diluent is typically used as carrying medium due to poor solvency of catalysts and activators in aliphatic hydrocarbon diluents. It is recognized that the use of aromatic diluent is advantageous since good solubility improves catalyst efficiency. However, use of aromatic diluent can add additional requirements/cost in diluent separation from the high molecular weight polymer product and the diluent recovery and recycle back to the polymerization reactor. Prolonged exposure of catalyst to a carrying medium such as a hydrocarbon diluent might result in catalyst deactivation or cause process deficiencies.

There is a need for polymerization methods in a polymerization reactor while achieving high catalyst efficiency.

### SUMMARY

The present disclosure relates to methods for delivery of non-aromatic solutions to polymerization reactors.

In some embodiments, a process includes introducing a catalyst solution, via a first line, into a reactor. The catalyst solution includes a catalyst and a first non-aromatic diluent. The process includes introducing an activator solution, via a second line, into the reactor. The activator solution includes an activator and a second non-aromatic diluent. The second non-aromatic diluent is the same as or different than the first non-aromatic diluent. The process includes operating the reactor under process conditions and obtaining an effluent from the reactor. The effluent includes a polyolefin. The first line and the second line are coupled with the reactor.

### BRIEF DESCRIPTION OF THE DRAWINGS

So that the manner in which the above recited features of the present disclosure can be understood in detail, a more particular description of the disclosure, briefly summarized above, may be had by reference to embodiments. Certain aspects of some embodiments are illustrated in the appended figures. It is to be noted, however, that the appended figures illustrate only exemplary embodiments, and therefore are not to be considered limiting of scope, and may admit to other equally effective embodiments.

FIG. 1 is a schematic of a solution polymerization plant, according to an embodiment.

FIG. 2A is the reactor setup for Experiment A, according to an embodiment.

FIG. 2B is the reactor setup for Experiment B, according to an embodiment.

FIG. 3 is a graph illustrating reactor temperature over time, according to an embodiment.

FIG. 4 is a graph illustrating catalyst efficiency over time, according to an embodiment.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

### Definitions

All molecular weights are weight average (Mw) unless otherwise noted. All molecular weights are reported in g/mol unless otherwise noted. Melt index (MI), also referred to as I₂, reported in g/10 min, is determined according to ASTM D-1238, 190° C., 2.16 kg load. High load melt index (HLMI) also referred to as I₂₁, reported in g/10 min, is determined according to ASTM D-1238, 190° C., 21.6 kg load. Melt index ratio (MIR) is MI divided by HLMI as determined by ASTM D1238.

The specification describes catalysts that can be transition metal complexes. The term complex is used to describe molecules in which an ancillary ligand is coordinated to a central transition metal atom. The transition metal complexes are generally subjected to activation to perform their polymerization function using an activator which is believed to create a cation as a result of the removal of an anionic group, often referred to as a leaving group, from the transition metal.

For the purposes of the present disclosure, the numbering scheme for the Periodic Table Groups is the “New” notation as as described in Chemical and Engineering News, 63(5), pg. 27 (1985). Therefore, a “Group 8 metal” is an element from Group 8 of the Periodic Table, e.g., Fe, and so on.

The following abbreviations are used through this specification: Me is methyl, Ph is phenyl, Et is ethyl, Pr is propyl, iPr is isopropyl, n-Pr is normal propyl, Bu is butyl, iBu is isobutyl, tBu is tertiary butyl, p-tBu is para-tertiary butyl, nBu is normal butyl, sBu is sec-butyl, p-Me is para-methyl, Bn is benzyl (i.e., CH₂Ph), RT is room temperature (and is 23° C. unless otherwise indicated), tol is toluene, MeCy is methylcyclohexane, Cy is cyclohexyl, Ind is indenyl, and Flu is fluorenyl.

Unless otherwise indicated (e.g., the definition of “substituted hydrocarbyl”, etc.), the term “substituted” means that at least one hydrogen atom has been replaced with at least a non-hydrogen group, such as a hydrocarbyl group, a heteroatom, or a heteroatom containing group, such as halogen (such as Br, Cl, F or I) or at least one functional group such as -NR*₂, -OR*, -SeR*, -TeR*, -PR*₂, -AsR*₂, -SbR*₂, -SR*, -BR*₂, -SiR*, -SiR*₃, -GeR*, -GeR*₃, -SnR*, -SnR*₃, -PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a ring structure.

The terms “hydrocarbyl radical,” “hydrocarbyl,” and “hydrocarbyl group,” are used interchangeably throughout this disclosure. Likewise, the terms “group”, “radical”, and “substituent” are also used interchangeably in this disclosure. For purposes of this disclosure, “hydrocarbyl radical” is defined to be C₁-C₁₀₀ radicals of carbon and hydrogen, that may be linear, branched, or cyclic, and when cyclic, aromatic or non-aromatic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like.

Substituted hydrocarbyl radicals are radicals in which at least one hydrogen atom of the hydrocarbyl radical has been replaced with a heteroatom, or a heteroatom containing group, such as halogen (such as Br, Cl, F or I) or at least one functional group such as -NR*₂, -OR*, -SeR*, -TeR*, -PR*₂, -AsR*₂, -SbR*₂, -SR*, -BR*₂, -SiR*, -SiR*₃, -GeR*, -GeR*₃, -SnR*, -SnR*₃, -PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

Halocarbyl radicals (also referred to as halocarbyls, halocarbyl groups or halocarbyl substituents) are radicals in which one or more hydrocarbyl hydrogen atoms have been substituted with at least one halogen (also referred to as a “halide”) (e.g., F, Cl, Br, I) or halogen-containing group (e.g., CF₃). Substituted halocarbyl radicals are radicals in which at least one halocarbyl hydrogen or halogen atom has been substituted with at least one functional group such as NR*₂, OR*, SeR*, TeR*, PR*₂, AsR*₂, SbR*₂, SR*, BR*₂, SiR*₃, GeR*₃, SnR*₃, PbR*₃, and the like or where at least one non-carbon atom or group has been inserted within the halocarbyl radical such as —O—, —S—, —Se—, —Te—, --N(R*)--g =N--, --P(R*)--, ═P—, --As(R*)--, ═As—, --Sb(R*)--,═Sb—, --B(R*)--, ═B—, --Si(R*)₂--, --Ge(R*)₂--, --Sn(R*)₂--, --Pb(R*)₂-- and the like, where R* is independently a hydrocarbyl or halocarbyl radical provided that at least one halogen atom remains on the original halocarbyl radical. Additionally, two or more R* may join together to form a substituted or unsubstituted saturated, partially unsaturated or aromatic cyclic or polycyclic ring structure.

Hydrocarbylsilyl groups, also referred to as silylcarbyl groups (also referred to as hydrocarbyl silyl groups), are radicals in which one or more hydrocarbyl hydrogen atoms have been substituted with at least one SiR*₃ containing group or where at least one -Si(R*)₂- has been inserted within the hydrocarbyl radical where R* is independently a hydrocarbyl or halocarbyl radical, and two or more R* may join together to form a substituted or unsubstituted saturated, partially unsaturated or aromatic cyclic or polycyclic ring structure. Silylcarbyl radicals can be bonded via a silicon atom or a carbon atom.

Substituted silylcarbyl radicals are silylcarbyl radicals in which at least one hydrogen atom has been substituted with at least one functional group such as NR*₂, OR*, SeR*, TeR*, PR*₂, AsR*₂, SbR*₂, SR*, BR*₂, GeR*₃, SnR*₃, PbR₃ and the like or where at least one non-hydrocarbon atom or group has been inserted within the silylcarbyl radical, such as —O—, —S—, —Se—, —Te—, --N(R*)--, ═N—, --P(R*)--, ═P—, --As(R*)--, ═As—, --Sb(R*)--, ═Sb—, --B(R*)--, ═B—, --Ge(R*)₂--, --Sn(R*)₂--, --Pb(R*)₂-- and the like, where R* is independently a hydrocarbyl or halocarbyl radical, and two or more R* may join together to form a substituted or unsubstituted saturated, partially unsaturated or aromatic cyclic or polycyclic ring structure.

The terms “alkyl radical,” and “alkyl” are used interchangeably throughout this disclosure. For purposes of this disclosure, “alkyl radicals” are defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and the like. Substituted alkyl radicals are radicals in which at least one hydrogen atom of the alkyl radical has been substituted with at least a non-hydrogen group, such as a hydrocarbyl group, a heteroatom, or a heteroatom containing group, such as halogen (such as Br, Cl, F or I) or at least one functional group such as -NR*₂, -OR*, -SeR*, -TeR*, -PR*₂, -AsR*₂, -SbR*₂, -SR*, -BR*₂, -SiR*, -SiR*₃, -GeR*, -GeR*₃, -SnR*, -SnR*₃, -PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring.

The term “branched alkyl” means that the alkyl group contains a tertiary or quaternary carbon (a tertiary carbon is a carbon atom bound to three other carbon atoms. A quaternary carbon is a carbon atom bound to four other carbon atoms). For example, 3,5,5 trimethylhexylphenyl is an alkyl group (hexyl) having three methyl branches (hence, one tertiary and one quaternary carbon) and thus is a branched alkyl bound to a phenyl group. Unless otherwise indicated a branched alkyl includes all isomers thereof.

The term “alkenyl” means a straight-chain, branched-chain, or cyclic hydrocarbon radical having one or more carbon-carbon double bonds. These alkenyl radicals may be substituted. Examples of suitable alkenyl radicals can include ethenyl, propenyl, allyl, 1,4-butadienyl cyclopropenyl, cyclobutenyl, cyclopentenyl, cyclohexenyl, cyclooctenyl and the like.

The term “arylalkenyl” means an aryl group where a hydrogen has been replaced with an alkenyl or substituted alkenyl group. For example, styryl indenyl is an indene substituted with an arylalkenyl group (a styrene group).

The term “alkoxy”, “alkoxyl”, or “alkoxide” means an alkyl ether or aryl ether radical wherein the terms “alkyl” and “aryl” are as defined herein. Examples of suitable alkyl ether radicals can include methoxy, ethoxy, n-propoxy, iso-propoxy, n-butoxy, iso-butoxy, sec-butoxy, tert-butoxy, phenoxy, and the like.

The term “aryl” or “aryl group” means a carbon-containing aromatic ring such as phenyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic.

Heterocyclic means a cyclic group where a ring carbon atom (or two or three ring carbon atoms) has been replaced with a heteroatom, such as N, O, or S. A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom substituted ring.

Substituted heterocyclic means a heterocyclic group where at least one hydrogen atom of the heterocyclic radical has been substituted with at least a non-hydrogen group, such as a hydrocarbyl group, a heteroatom, or a heteroatom containing group, such as halogen (such as Br, Cl, F or I) or at least one functional group such as -NR*₂, -OR*, -SeR*, -TeR*, -PR*₂, -AsR*₂, -SbR*₂, -SR*, -BR*₂, -SiR*, -SiR*₃, -GeR*, -GeR*₃, -SnR*, -SnR*₃, -PbR*₃, and the like, where each R* is independently a hydrocarbyl or halocarbyl radical.

A substituted aryl is an aryl group where at least one hydrogen atom of the aryl radical has been substituted with at least a non-hydrogen group, such as a hydrocarbyl group, a heteroatom, or a heteroatom containing group, such as halogen (such as Br, Cl, F or I) or at least one functional group such as -NR*₂, -OR*, -SeR*, -TeR*, -PR*₂, -AsR*₂, -SbR*₂, -SR*, -BR*₂, -SiR*, -SiR*₃, -GeR*, -GeR*₃, -SnR*, -SnR*₃, -PbR*₃, and the like, where each R* is independently a hydrocarbyl or halocarbyl radical, and two or more R* may join together to form a substituted or unsubstituted saturated, partially unsaturated or aromatic cyclic or polycyclic ring structure, or where at least one heteroatom has been inserted within a hydrocarbyl ring, for example 3,5-dimethylphenyl is a substituted phenyl group.

The term “substituted phenyl,” or “substituted phenyl group” means a phenyl group having one or more hydrogen groups replaced by a hydrocarbyl, substituted hydrocarbyl, heteroatom or heteroatom containing group, such as halogen (such as Br, Cl, F or I) or at least one functional group such as -NR*₂, -OR*, -SeR*, -TeR*, -PR*₂, -AsR*₂, -SbR*₂, -SR*, -BR*₂, -SiR*, -SiR*₃, -GeR*, -GeR*₃, -SnR*, -SnR*₃, -PbR*₃, and the like, where each R* is independently a hydrocarbyl, halogen, or halocarbyl radical. Preferably the “substituted phenyl” group is represented by the formula:

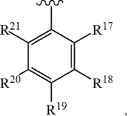

where each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom, such as halogen, or a heteroatom-containing group (provided that at least one of R¹⁷, R¹⁸, R¹⁹, R²⁰, and R²¹ is not H).

A “fluorophenyl” or “fluorophenyl group” is a phenyl group substituted with one, two, three, four or five fluorine atoms.

A “fluoroaryl” or “fluoroaryl group” is an aryl group substituted with at least one fluorine atom, such as the aryl is perfluorinated. The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl. For example in Formula (AI), the aryl portion is bound to E.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl. For example in Formula (AI), the alkyl portion is bound to E.

Reference to an alkyl, alkenyl, alkoxide, or aryl group without specifying a particular isomer (e.g., butyl) expressly discloses all isomers (e.g., n-butyl, iso-butyl, sec-butyl, and tert-butyl), unless otherwise indicated.

The term “ring atom” means an atom that is part of a cyclic ring structure. Accordingly, a benzyl group has six ring atoms and tetrahydrofuran has 5 ring atoms.

For purposes of the present disclosure, a “catalyst system” is a combination of at least one catalyst compound, an activator, and an optional support material. The catalyst systems may further comprise one or more additional catalyst compounds. For the purposes of the present disclosure, when catalyst systems are described as comprising neutral stable forms of the components, it is well understood by one of ordinary skill in the art, that the ionic form of the component is the form that reacts with the monomers to produce polymers. Catalysts of the present disclosure represented by formulas and activators represented by formulas are intended to embrace ionic forms in addition to the neutral forms of the compounds.

“Complex” as used herein, is also often referred to as catalyst precursor, precatalyst, catalyst, catalyst compound, transition metal compound, or transition metal complex. These words are used interchangeably.

A scavenger is a compound that is typically added to facilitate polymerization by scavenging impurities. Some scavengers may also act as activators and may be referred to as co-activators. A co-activator, that is not a scavenger, may also be used in conjunction with an activator in order to form an active catalyst. In some embodiments a co-activator can be premixed with the transition metal compound to form an alkylated transition metal compound.

In the description herein, a catalyst may be described as a catalyst precursor, a precatalyst compound, a catalyst compound or a transition metal compound, and these terms are used interchangeably. A polymerization catalyst system is a catalyst system that can polymerize monomers into polymer. An “anionic ligand” is a negatively charged ligand which donates one or more pairs of electrons to a metal ion. A “neutral donor ligand” is a neutrally charged ligand which donates one or more pairs of electrons to a metal ion.

A metallocene catalyst is defined as an organometallic compound with at least one π-bound cyclopentadienyl moiety or substituted cyclopentadienyl moiety (such as substituted or unsubstituted Cp, Ind, or Flu) and more frequently two (or three) π-bound cyclopentadienyl moieties or substituted cyclopentadienyl moieties (such as substituted or unsubstituted Cp, Ind, or Flu). (Cp = cyclopentadienyl, Ind= indenyl, Flu=fluorenyl).

For purposes of the present disclosure, in relation to catalyst compounds, the term “substituted” means that a hydrogen group has been replaced with a hydrocarbyl group, a heteroatom, or a heteroatom containing group. For example, methyl cyclopentadiene (Cp) is a Cp group substituted with a methyl group.

Catalyst efficiency is the steady-state average amount of polymer produced per average amount of metallocene/post-metallocene (only the metallocene not the full catalyst system of metallocene + activator + scavenger) used, on a weight basis. This definition is used for steady-state operation in a continuous polymerization reactor.

$$C E = \frac{k g / h r o f p o l y m e r p r o d u c e d}{k g / h r o f m e t a l l o c e n e u s e d}$$

Monomer conversion (fmonomer) refers to the amount (either mass or molar basis) of monomer that is converted into polymer in the reactor. More specifically, conversion may be with respect to ethylene conversion, propylene conversion, or any other α-olefin added to the reactor.

$${f}_{m o n o m e r} = \frac{k g / h r m o n o m e r i n p o l y m e r}{k g / h r t o t a l m o n o m e r a d d e d t o R x}$$

Monomer conversion in a continuous reactor is related to the monomer concentration of the reactor at steady-state. The higher the steady-state monomer conversion, the lower the steady-state monomer concentration in the reactor. Monomer conversion in a batch reactor is related to the extent of reaction in the batch reactor, with the monomer concentration in the batch reactor decreasing in time as the monomer is converted to polymer.

For purposes herein an “olefin,” alternatively referred to as “alkene,” is a linear, branched, or cyclic compound comprising carbon and hydrogen having at least one double bond. For purposes of this specification and the claims appended thereto, when a polymer or copolymer is referred to as comprising an olefin, the olefin present in such polymer or copolymer is the polymerized form of the olefin. For example, when a copolymer is said to have a “propylene” content of 35 wt% to 55 wt%, it is understood that the mer unit in the copolymer is derived from propylene in the polymerization reaction and the derived units are present at 35 wt% to 55 wt%, based on the weight of the copolymer.

For purposes herein a “polymer” has two or more of the same or different monomer (“mer”) units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically. Accordingly, copolymer, as used herein, can include terpolymers and the like. An “ethylene polymer” or “ethylene copolymer” is a polymer or copolymer comprising at least 50 mole% ethylene derived units, a “propylene polymer” or “propylene copolymer” is a polymer or copolymer comprising at least 50 mole% propylene derived units, and so on.

As used herein, Mn is number average molecular weight, Mw is weight average molecular weight, and Mz is z average molecular weight, wt% is weight percent, and mol% is mole percent. Molecular weight distribution (MWD), also referred to as polydispersity index (PDI), is defined to be Mw divided by Mn.

The term “continuous” means a system that operates without interruption or cessation for a period of time, such as where reactants are continually fed into a reaction zone and products are continually or regularly withdrawn without stopping the reaction in the reaction zone. For example, a continuous process to produce a polymer would be one where the reactants are continually introduced into one or more reactors and polymer product is continually withdrawn.

A “solution polymerization” means a polymerization process in which the polymerization is conducted in a liquid polymerization medium, such as an inert solvent or monomer(s) or their blends. A solution polymerization is typically homogeneous. A homogeneous polymerization is one where the polymer product is dissolved in the polymerization medium. Such systems are typically not turbid as described in Oliveira, J. V. et al. (2000) “High-Pressure Phase Equilibria for Polypropylene-Hydrocarbon Systems,” Ind. Eng. Chem. Res., v.39, pp. 4627-4633.

A bulk polymerization means a polymerization process in which the monomers and or comonomers being polymerized are used as a solvent or diluent using little or no inert solvent or diluent. A small fraction of inert solvent might be used as a carrier for catalyst and scavenger. A bulk polymerization system contains less than about 25 wt% of inert solvent or diluent, such as less than about 10 wt%, such as less than about 1 wt%, such as 0 wt%.

As used herein, “elastomer” or “elastomeric composition” refers to a polymer or composition of polymers (such as blends of polymers) consistent with the ASTM D1566 definition. Elastomer includes mixed blends of polymers such as melt mixing and/or reactor blends of polymers.

As used herein, “plastomer” shall mean ethylene based copolymers having a density in the range of about 0.85 to 0.915 g/cm³ ASTM D 4703 Method B and ASTM D 1505. Plastomers described herein include copolymers of ethylene derived units and higher α-olefin derived units such as propylene, 1-butene, 1-hexene, and 1-octene.

The present disclosure relates to methods for delivery of non-aromatic solutions to polymerization reactors. In some embodiments, a process includes introducing a catalyst solution, via a first line, into a reactor. The catalyst solution includes a catalyst and a first non-aromatic diluent. The process includes introducing an activator solution, via a second line, into the reactor. The activator solution includes an activator and a second non-aromatic diluent. The second non-aromatic diluent is the same as or different than the first non-aromatic diluent. The process includes operating the reactor under process conditions and obtaining an effluent from the reactor. The effluent includes a polyolefin. The first line and the second line are coupled with the reactor.

It has been discovered that activators of the present disclosure can be partially or completely soluble in non-aromatic diluent. However, it has been further discovered that premixing the activator and catalyst prior to introducing the activator and catalyst to a reactor, results in poor reactor temperature control and inconsistency of the polymer products (and polymer properties thereof) that are obtained. It has been discovered that direct injection of activator in non-aromatic solvent and direct injection of catalyst in non-aromatic solvent independently into a reactor provides reduced or eliminated temperature variations during polymerization. Once in the reactor, the concentration of the activated catalyst complex that results is low enough to prevent precipitation. Surprisingly, catalyst efficiency is also maintained or improved (as compared to polymerizations using premixing of catalyst with activator in toluene before injection of the mixture/activated catalyst into the reactor), even though direct injection of catalyst and activator in non-aromatic solvent provides very dilute concentrations of catalyst and activator in the reactor before the catalyst is activated. Because of the reduced temperature variations of the processes (as compared to conventional polymerization processes), processes of the present disclosure can provide uniform polymer properties in addition to low aromatic content of the polymers formed.

### Continuous Solution Polymerization Plant

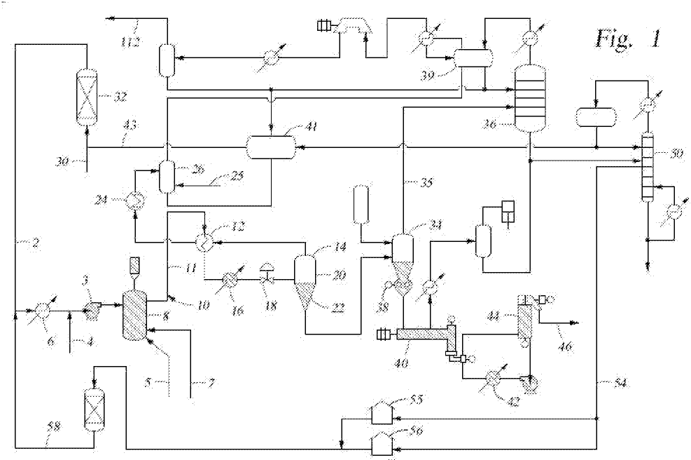

FIG. 1 is a plant for continuous solution polymerization. A feed for polymerization is passed through conduit (2), a chiller or cooler (6), a centrifugal pump (3), into a polymerization reactor (8). The feed may contain: A) a diluent, such as isohexane, B) monomer, such as a predominant monomer of ethylene or propylene, and optionally C) comonomer which may be any suitable copolymerizable α-olefin, and optionally D) a diene or other polyene or cyclic copolymerizable material. The feed is passed through a chiller or cooler (6) in which the feed is optionally chilled to a low temperature for subsequent polymerization in one or more continuous stirred tank reactors (8). In some embodiments, two or more continuous stirred tank reactors may be operated in series or parallel (however, for simplicity, only one reactor is depicted in FIG. 1).

An activator solution (7) is introduced to reactor(s) (8), and a catalyst solution (5) is introduced to reactor(s) (8). The activator solution includes an activator and a non-aromatic diluent. The catalyst solution includes a catalyst and a diluent (such as a non-aromatic diluent). Activator solution (7) and catalyst solution (5) are independently introduced to reactor(s) (8) without premixing the activator and catalyst before introducing the activator and catalyst to reactor(s) (8). It has been discovered that activators of the present disclosure can be partially or completely soluble in non-aromatic diluent. However, it has been further discovered that premixing the activator and catalyst in non-aromatic diluent prior to introducing the activator and catalyst to a reactor, results in poor reactor temperature control and inconsistency of the polymer products (and polymer properties thereof) that are obtained. Without being bound by theory, it is believed that during premixing, the activator and catalyst can form an active catalyst complex that is not soluble in non-aromatic diluents at the concentrations used for injection into the polymerization reactor. It has been discovered that direct injection of activator in non-aromatic diluent and direct injection of catalyst in non-aromatic diluent independently into a reactor provides reduced or eliminated temperature variations during polymerization (e.g., provides a consistent polymerization having a low temperature delta, as described in more detail below). Once in the reactor, the concentration of the activated catalyst complex that results is low enough to prevent precipitation. Suprisingly, catalyst efficiency is also maintained or improved (as compared to polymerizations using premixing of catalyst with activator in toluene before injection of the mixture/activated catalyst into the reactor), even though direct injection of catalyst and activator provides very dilute concentrations of catalyst and activator in the reactor before the catalyst is activated. In other words, the catalyst and the activator may readily form activated catalyst even under very dilute conditions.

A concentration of activator in the activator solution can be about 0.01 wt% to about 20 wt%, such as about 0.05 wt% to about 5 wt%, such as about 0.1 wt% to about 1 wt%, such as about 0.1 wt% to about 0.5 wt%, such as about 0.15 wt% to about 0.3 wt%, such as about 0.2 wt%. A feed rate of activator solution into a reactor can be about 0.01 kg/hr to about 40 kg/hr, such as about 0.2 kg/hr to about 23 kg/hr. In some embodiments, a feed rate of activator solution into a reactor is about 0.02 L/hr to about 60 L/hr, such as about 0.28 L/hr to about 34 L/hr.

A concentration of catalyst in the catalyst solution can be about 0.01 wt% to about 20 wt%, such as about 0.01 wt% to about 5 wt%, such as about 0.01 wt% to about 1 wt%, such as about 0.02 wt% to about 0.25 wt%, such as about 0.05 wt% to about 0.1 wt%, such as about 0.08 wt%. A feed rate of catalyst solution into a reactor can be about 0.003 kg/hr to about 40 kg/hr, such as about 0.06 kg/hr to about 7 kg/hr. In some embodiments, a feed rate of catalyst solution into a reactor is about 0.004 L/hr to about 60 L/hr, such as about 0.09 L/hr to about 10 L/hr.

A scavenger, such as an alkyl aluminum, for example tri-isobutyl aluminum or tri-n-octyl aluminum, may be added through conduit (4) to minimize the impact of poisons in the feed and in the reactor on the catalyst activity.

To complement the molecular weight control provided by controlling the polymerization temperature, hydrogen may be added to one or both reactors (8) through conduits (not shown).

The polymer-containing polymerization mixture, which emerges from the reactors (8) through a conduit (11), may first be treated with a catalyst killer, for example with water, sorbitan monooleate, and/or methanol, added at (10). In some embodiments, the catalyst killer may be introduced to the system in a molecular solution in isohexane diluent to terminate the polymerization reaction.

A heat exchanger (12) may be arranged as part of a heat integrating arrangement and heated by a polymer-lean phase emerging from an upper layer (20) in a liquid phase separator (14), and provide an initial increase in the temperature of the polymer-containing polymerization reactor effluent in the conduit (11). A trim heat exchanger (16), which may be heated by steam, hot oil or other high temperature fluid, further increases the temperature of the polymer-containing polymerization reactor effluent to a level suitable for liquid phase separation. The solution then passes through a let-down valve (18) where a pressure drop is created which causes the separation of the polymer-containing polymerization reactor effluent into the polymer-lean phase (20) and a polymer-rich phase (22).

The density of the polymer-rich phase may be at least 40 kg/m³, or at least 50 kg/m³, or at least 60 kg/m³ higher than the density of the polymer-lean phase, thus allowing gravity settling of the polymer-rich phase in the liquid-liquid separator. The polymer-lean phase may have a residence time of at least 5 minutes, or at least 10 minutes within the liquid-liquid separator. The polymer-rich phase may have a residence time of at least 10 minutes, or at least 15 minutes, or at least 20 minutes within the liquid-liquid separator.

In some embodiments, the liquid-liquid separator may be designed to have a conical shaped bottom to enhance the drainage of the polymer-rich phase. In some embodiments, the vessel walls of the liquid-liquid separator may be heated (such as via a steam jacket) to further enhance the separation of the phases and to reduce the viscosity of the boundary between the two phases.

The interface between the polymer-rich phase and the polymer-lean phase in the liquid-liquid separator may be detected by a sonic detector or by nuclear-density gauges. In embodiments where nuclear-density gauges are utilized, there may be an array of radiation sources deployed inside an internal pipe well that runs parallel to the wall of the separator, and an array of detectors deployed outside the vessel along the wall radially in-line with the radiation sources. The radiation sources may be partially shielded in such a way that as much of the radiation is directed towards the detector with which it is paired. The pairings may be horizontally aligned, but may also have a staggered alignment such that a radiation source is aimed at a detector that is positionally above or below the detector at which it is aimed.

The lean phase (20), after being cooled by the heat exchanger (12), may be cooled further by a cooling device (24), and pass through a surge tank (26) adapted for stripping out containments, such as hydrogen. Fresh monomer or comonomer may be added through conduit (25) and used as stripping vapor in the surge tank (26). The cooled lean phase may pass to collector (41) and then through conduit (43), and may be passed to dryer (32). Fresh feed of diluent and monomer (30) may be added to conduit (43) to provide the desired concentrations for the polymerization reaction. The dryer (32) may be used to remove any unreacted methanol used as the catalyst killer or other containments present in the fresh feed supplied or any impurity in the recycled diluent and monomer. The recycle feed from the dryer (32) may then be passed through conduit (2) back to the polymerization reactor (8).

The vapor from the conduit at the top of the surge tank (26) may be routed to a reflux drum (39) of tower (36). The vapor may be processed to recover valuable components, such as monomers such as ethylene and propylene, by fractionating tower (36) and its overhead vapor compression/condensation system. The recovered components may be recycled through conduit (43) to the inlet side of the drier (32). Alternatively, excess components may be vented or flared (112).

Returning to the liquid phase separator (14), the concentrated polymer-rich phase (22) may be passed to a low-pressure separator (34) where evaporated diluent and monomer are separated from the more concentrated polymer solution emerging from the liquid phase separator (14).

The evaporated diluent and monomer phase may be passed through conduit (35) in a vapor phase to the purification/fractionation tower (36) which may operate by distillation to separate a light fraction of the highly volatile diluent and unreacted ethylene and propylene from the heavier less volatile components such as hexane and any toluene used to dissolve catalyst or activator and unreacted diene type comonomers.

A gear pump (38) may convey the concentrated polymer in the low-pressure separator (34) to a vacuum devolatilizing extruder or mixer (40), where again a vapor phase is drawn off for purification, condensed and then pumped to a purification tower (50). The vacuum devolatizer may be as described in PCT Publication WO 2011/087730. A heavy fraction of toluene used as catalyst diluent and any comonomers used are recovered by this purification tower (50). Recovered comonomer can be recycled through outlet (54), and in some embodiments excess comonomer may be stored in separate storage vessels (55), (56). The recycled comonomer can then be reintroduced to the polymerization reactors via conduit (58).

The polymer melt emerging from the vacuum devolatilizing extruder or mixer (40) can then be pelletized in an underwater pelletizer, fed with water chilled at (42), washed and spun dried at (44) to form pellets suitable for bagging or baling at (46).

The vapor from the devolatilizer (40) may be treated to recover and recycle the diluent. In some embodiments, the vapors may pass through a wash tower, a refrigerated heat exchanger and then through a series of compressors and pumps.

Some of the equipment components described above may contain external jacketing for the circulation of heating or cooling fluids. The equipment may also contain a central shaft or adjacent shafts that are used to convey and/or agitate the polymer solution or polymer melt in the equipment. Metallic protuberances may also be provided along the barrel walls, such as breaker bars or other stationary elements that aid in the mixing, conveying, and/or heating or cooling of the contents. In some embodiments, the equipment may have drilled holes that are flooded with pressurized nitrogen or other inert gas in the stationary and/or moving parts of the machinery. Pressure detectors may then be used to monitor the equipment, with decreases in the pressure of the nitrogen indicating a breakage or crack in the equipment. Alternatively, the flow of the inert gas may be monitored with a flow metering device. In some embodiments, helium or another inert component which is not usually present in the apparatus, may be used to pressurize the apertures within the stationary and/or moving parts of the machinery. In such embodiments, the concentration of helium can then be measured by a helium analyzer in the stream leaving the equipment. The presence of helium in the stream would then indicate a break or crack in the machinery.

### Polymerization to Produce Polymers

The operation of the plant of FIG. 1 is further illustrated with reference to Table 1. Table 1 provides examples of polymerization processes to make: (1) a plastomer, (2) an elastomer, such as an ethylene-propylene-diene-rubber, and (3) a propylene-based polymer.

TABLE 1

Process Conditions of the Plant/Process in Varying Operating Modes

| | | | | | | |
|---|---|---|---|---|---|---|
| Polymers Produced | Feed Into Reactor | Polymerization Inside Reactor | Polymer Solution Upstream Let-Down Valve | Polymer Solution Downstream Let-Down Valve | Polymer Lean Phase | Polymer Rich Phase |
| Plastomer | 50 to down to -15° C.; 120 bar total; 50 bar monomer partial pressure | 130 to 200° C.; 100 to 130 bar; 7 to 22 wt % polymer | 220° C. to 230° C.; 100 to 130 bar; 15 to 22 wt % polymer | 220° C. to 230° C.; 30 to 45 bar; 15 to 22 wt % polymer | 220° C. to 230° C.; 30 to 45 bar; <0.3 wt % polymer | 220° C. to 230° C.; 30 to 40 bar; 25 to 40 wt % polymer |
| Elastomer | 50 to down to -15° C.; 120 bar total; 50 bar monomer partial pressure | 85 to 150° C.; 100 to 130 bar; 8 to 15 wt% polymer | 185° C. to 210° C.; 100 to 130 bar; 8 to 15 wt% polymer | 185° C. to 210° C.; 30 to 45 bar; 8 to 15 wt% polymer | 185° C. to 210° C.; 30 to 45 bar; <0.3 wt% polymer | 185° C. to 210° C.; 30 to 40 bar; 25 to 40 wt% polymer |
| Propylene-based Polymer | 50 to down to -35° C.; 120 bar total; 50 bar monomer partial pressure | 50 to 80° C.; 100 to 130 bar; 5 to 15 wt% polymer | 200° C. to 220° C.; 100 to 130 bar; 5 to 15 wt% polymer | 200° C. to 220° C.; 30 to 45 bar; 5 to 15 wt% polymer | 200° C. to 220° C.; 30 to 45 bar; <0.3 wt% polymer | 200° C. to 220° C.; 30 to 40 bar; 20 to 40 wt% polymer |

With reference to FIG. 1 and Table 1, plastomers can be made using the processes described herein. For example, the temperature of the feed being introduced into the reactor (8) can be reduced by the chiller (6) to a temperature of 50° C. to -15° C., for example about 0° C. The pressure of the feed may be raised by the centrifugal pump (3) to about 120 bar. The feed comprising largely diluent and up to about 50 bar partial pressure of ethylene and a comonomer, such as for example butene, hexene, or octene, then enters the reactor (8) (or first of two series reactors if two reactors are used). Catalyst and activator are added to the reactor (8) in amounts to create the desired polymerization temperature which in turn is related to the desired molecular weight. The heat of polymerization increases the temperature to about 130° C. to 200° C., or about 150° C. to about 200° C. The plastomer may be formed with or without the use of hydrogen. At the outlet of the reactor (or the second reactor if two are used in series), the polymer concentration may be from 7 wt% to 22 wt%, or from 15 to 22 wt%. The heat exchanger (12) may be used to raise the temperature initially and then the further heat exchanger (16) may cause a further temperature rise to within about 50° C. of the critical temperature. A rapid pressure drop results as the polymerization mixture passes through the let-down valve (18) into the liquid phase separator (14), with the pressure dropping quickly from about a pressure in the range of about 100 to 130 bar to a pressure in the range of about 30 to 45 bar. In some embodiments, the pressure differential between the outlet of the pump (3) and the outlet of the let-down valve (18) is solely responsible for causing the feed and the polymerization mixture to flow through the reactor (8) and the conduit (11) including the heat exchangers (12) and (16). Inside the separator (14) an upper lean phase is formed with less than about 0.3 wt% polymer, or less than about 0.1 wt% of polymer, and a lower polymer rich phase with about 25 to 40 wt% polymer, or from about 30 wt% to 40 wt% of polymer. Further removal of diluent and monomer from the polymer rich phase may occur in the low-pressure separator (34) and the extruder/devolatizer (40). Polymer can be removed from the plant containing less than 1 wt %, preferably with 0.3 wt % or less, even more preferably less than 0.1 wt % of volatiles, including water. Other general conditions for producing plastomers are described in WO 1997/22635 and WO 1999/45041.

With reference to FIG. 1 and Table 1, elastomers can be made using the processes described herein. As seen in Table 1, while the polymerization temperature may be lower for the production of elastomers than for plastomers, and the polymer concentration emerging from the reactor may also be lower (however the viscosity of the polymer concentration will be similar to that for plastomers), the same separation processes, catalyst injections processes, and/or activator injection processes. Thus, the feed being introduced into the reactor may be at a temperature of 50° C. to -15° C., for example about 0° C. The pressure of the feed may be raised to about 120 bar. The feed comprising largely diluent and up to about 50 bar partial pressure of ethylene and comonomer, such as for example propylene and, optionally, diene, then enters the reactor (or first of two series reactors if two reactors are used). The heat of polymerization increases the temperature to about 85° C. to 150° C., or about 95° C. to about 130° C.

A maximum fluctuation in temperature during a polymerization (after an initial temperature increase when polymerization begins) is referred to herein as a “temperature delta”. In at least one embodiment, a temperature delta is about 0° C. to about 20° C., such as about 0° C. to about 10° C., such as about 0.5° C. to about 5° C., such as about 1° C. to about 3° C. Temperature delta of processes of the present disclosure are lower than temperature delta of conventional processes. Processes of the present disclosure provide low temperature delta for processes using non-aromatic solvents. In contrast, a process having a high temperature delta promotes inconsistent polymer properties of polymers formed during polymerization. Accordingly, processes of the present disclosure can provide uniform polymer properties and low aromatic content of the polymers formed. For example, a polymer formed using processes of the present disclosure can have an aromatic content (such as toluene content) of 1 wt% or less, such as 0.5 wt% or less, such as 0.1 wt% or less, such as 0 wt%, based on the weight of the polymer (e.g., pelletized polymer).

At the outlet of the reactor (or the second reactor if two are used in series), the polymer concentration may be from 8 wt% to 15 wt%, or from 10 to 15 wt%. The heat exchanger (12) may be used to raise the temperature initially and then the further heat exchanger (16) may cause a further temperature rise to within 50° C. of the critical temperature. A rapid pressure drop results as the polymerization mixture passes through the let-down valve (18) into the liquid phase separator (14), with the pressure dropping quickly from about a pressure of about 100 to 130 bar to a pressure within 50 psig of the critical temperature, such as a pressure of about 30 to 45 bar. Inside the separator (14) an upper lean phase is formed with less than about 0.3 wt% polymer, or less than about 0.1 wt% of polymer, and a lower polymer rich phase with about 20 to 40 wt% polymer, or from about 30 wt% to 40 wt% of polymer. The upper lean phase can have an aromatic diluent content of less than 1 wt%, such as less than 0.5 wt%, such as less than 0.1 wt%, such as less than 0.05 wt%, such as less than 0.01 wt%, such as 0 wt%, based on the weight of the upper lean phase. The lower polymer rich phase can have an aromatic diluent content of less than 1 wt%, such as less than 0.5 wt%, such as less than 0.1 wt%, such as less than 0.05 wt%, such as less than 0.01 wt%, such as 0 wt%, based on the weight of the lower polymer rich phase.

Polymer can be removed from the plant containing less than 1 wt%, such as with 0.3 wt% or less, such as less than 0.1 wt% of volatiles, including water. Other general conditions for producing elastomers using two reactors in series are described in WO 99/45047. Typically, in a series reactor process the first reactor may operate at temperatures from 0° C. to 110° C., or from 10° C. to 90° C., or 20° C. to 79° C., and the second reactor may operate from 40° C. to 140° C., or from 50° C. to 120° C., or from 60° C. to 110° C. Activator solution(s) and catalyst solution(s) as described herein may be utilized in one or more of the reactors in series or in parallel.

General conditions for producing propylene-based polymers are also described in WO 00/01745. As compared to the processes described in Table 1 for producing plastomers and elastomers, the polymerization temperature when producing propylene-based polymers may be reduced. Thus, the feed being introduced into the reactor may be at a temperature of about 50° C. to about -35° C., for example about 0° C. The pressure of the feed may be raised to about 120 bar. The feed comprising largely diluent and up to about 50 bar partial pressure of propylene and comonomer, such as for example ethylene and, optionally, diene, then enters the reactor (or reactors if two parallel reactors are used). The heat of polymerization increases the temperature to about 50° C. to 80° C., or about 55° C. to about 75° C. After this initial temperature increase, in at least one embodiment, a temperature delta is about 0° C. to about 20° C., such as about 0° C. to about 10° C., such as about 0.5° C. to about 5° C., such as about 1° C. to about 3° C. At the outlet of the reactor (or the second reactor if two are used in series), the polymer concentration may be from 5 wt% to 15 wt%, or from 7 wt% to 12 wt%. The heat exchanger (12) may be used to raise the temperature initially and then the further heat exchanger (16) may cause a further temperature rise to within 50° C. of the critical temperature. A rapid pressure drop results as the polymerization mixture passes through the let-down valve (18) into the liquid phase separator (14), with the pressure dropping quickly from a pressure in the range of about 100 to 130 bar to a pressure within 50 psig of the critical temperature, such as a pressure in the range of about 30 to 45 bar. Inside the separator (14) an upper lean phase is formed with less than about 0.3 wt% polymer, or less than about 0.1 wt% of polymer, and a lower polymer rich phase with about 20 to about 40 wt% polymer, or from about 30 wt% to about 40 wt% of polymer. Polymer can be removed from the plant containing less than 1 wt%, such as with 0.3 wt% or less, such as less than 0.1 wt% of volatiles, including water.

Processes of the present disclosure have been described as being performed as solution polymerizations. In some embodiments, processes of the present disclosure can be performed as a gas phase polymerization or slurry phase polymerization. For example, a catalyst solution and activator solution can be introduced independently to a gas phase polymerization reactor or to a slurry phase polymerization reactor. In such embodiments, the catalyst solution includes a supported catalyst (catalyst supported on a support, such as silica, alumina, etc.). Because of the presence of a support, additional solvent and/or increased flow velocities of the catalyst solution and/or activator solution may be used, as compared to solution polymerization processes. In such processes, after an initial polymerization temperature increase, a temperature delta may be about 0° C. to about 20° C., such as about 0° C. to about 10° C., such as about 0.5° C. to about 5° C., such as about 1° C. to about 3° C.

### Gas Phase Polymerization

Generally, in a fluidized gas bed process used for producing polymers, a gaseous stream containing one or more monomers is continuously cycled through a fluidized bed in the presence of a catalyst under reactive conditions. The gaseous stream is withdrawn from the fluidized bed and recycled back into the reactor. Simultaneously, polymer product is withdrawn from the reactor and fresh monomer is added to replace the polymerized monomer. (See, for example, U.S. Pat. Nos. 4,543,399; 4,588,790; 5,028,670; 5,317,036; 5,352,749; 5,405,922; 5,436,304; 5,453,471; 5,462,999; 5,616,661; and 5,668,228; all of which are fully incorporated herein by reference.)

### Slurry Phase Polymerization

A slurry polymerization process generally operates between 1 to about 50 atmosphere pressure range (15 psi to 735 psi, 103 kPa to 5068 kPa) or even greater and temperatures in the range of 0° C. to about 120° C. In a slurry polymerization, a suspension of solid, particulate polymer is formed in a liquid polymerization diluent medium to which monomer and comonomers, along with catalysts, are added. The suspension including diluent is intermittently or continuously removed from the reactor where the volatile components are separated from the polymer and recycled, optionally after a distillation, to the reactor. The liquid diluent used in the polymerization medium is typically an alkane having from 3 to 7 carbon atoms, such as a branched alkane. The medium employed should be liquid under the conditions of polymerization and relatively inert. When a propane medium is used, the process must be operated above the reaction diluent critical temperature and pressure. For example, a hexane or an isobutane medium is employed.

In at least one embodiment, a polymerization process is a particle form polymerization, or a slurry process, where the temperature is kept below the temperature at which the polymer goes into solution. Such technique is well known in the art, and described in for instance U.S. Pat. No. 3,248,179 which is fully incorporated herein by reference. The temperature in the particle form process can be from about 85° C. to about 110° C. Two example polymerization methods for the slurry process are those using a loop reactor and those utilizing a plurality of stirred reactors in series, parallel, or combinations thereof. Non-limiting examples of slurry processes include continuous loop or stirred tank processes. Also, other examples of slurry processes are described in U.S. Pat. No. 4,613,484, which is herein fully incorporated by reference.

In another embodiment, the slurry process is carried out continuously in a loop reactor. The catalyst, as a slurry in isohexane or as a dry free flowing powder, is injected regularly to the reactor loop, which is itself filled with circulating slurry of growing polymer particles in a diluent of isohexane containing monomer and optional comonomer. Hydrogen, optionally, may be added as a molecular weight control. (In one embodiment hydrogen is added from 50 ppm to 500 ppm, such as from 100 ppm to 400 ppm, such as 150 ppm to 300 ppm.)

The reactor may be maintained at a pressure of 2,000 kPa to 5,000 kPa, such as from 3,620 kPa to 4,309 kPa, and at a temperature of from about 60° C. to about 120° C. depending on the desired polymer melting characteristics. Reaction heat is removed through the loop wall since much of the reactor is in the form of a double-jacketed pipe. The slurry is allowed to exit the reactor at regular intervals or continuously to a heated low pressure flash vessel, rotary dryer and a nitrogen purge column in sequence for removal of the isohexane diluent and all unreacted monomer and comonomer. The resulting hydrocarbon free powder is then compounded for use in various applications.

Other additives may also be used in a polymerization, as desired, such as one or more scavengers, promoters, modifiers, chain transfer agents (such as diethyl zinc), reducing agents, oxidizing agents, hydrogen, aluminum alkyls, or silanes.

Useful chain transfer agents are typically alkylalumoxanes, a compound represented by the formula AlR₃, ZnR₂ (where each R is, independently, a C₁-C₈ hydrocarbyl, such as methyl, ethyl, propyl, butyl, penyl, hexyl octyl or an isomer thereof). Examples can include diethyl zinc, methylalumoxane, trimethylaluminum, triisobutylaluminum, trioctylaluminum, or a combination thereof.

### Catalyst

The catalyst compounds of the present disclosure may be stored in a storage tank by themselves or dissolved in hydrocarbon diluent(s), such as aliphatic hydrocarbons, at a suitable concentration, a “catalyst solution.” A catalyst solution may be measured using measurement techniques for liquids including the use of flowmeters to measure the quantity of catalyst solution added or removed from a storage tank. Additionally or alternatively, weight scales on the storage tank may be used to determine the quantity of catalyst solution added to the reactor.

The catalysts may be diluted (e.g., dissolved) in hydrocarbon diluent at a suitable concentration in a storage tank, a mixing tank, or inline mixer. Dissolution may be accomplished by determination of the flow or weight of catalyst and adding the appropriate amount of hydrocarbon diluent. Suitable hydrocarbon diluents include aliphatic and aromatic hydrocarbons. While aromatic hydrocarbons are suitable diluents, their use may be reduced or eliminated because the production of polyolefins free of aromatic hydrocarbons increases the value of the polymer and decreases cost of polymer devolatilization. Suitable hydrocarbon diluents include non-coordinating, inert liquids. Examples of diluents may include straight and branched-chain hydrocarbons, such as 2-methyl-pentane, isobutane, butane, n-pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar®); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable diluents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon diluents are used, such as isobutane, butane, n-pentane, isopentane, hexanes, isohexane, heptane, octane, dodecane, or mixtures thereof; and/or cyclic and alicyclic hydrocarbons, such as cyclohexane, cycloheptane, methylcyclohexane, methylcycloheptane, or mixtures thereof. In another embodiment, the diluent is not aromatic, such as aromatics are present in the diluent at less than 1 wt%, such as less than 0.5 wt%, such as less than 0.1 wt%, such as less than 0.05 wt%, such as less than 0.01 wt%, such as 0 wt%, based on the combined weight of diluents present.

The systems of the present disclosure (such as the plant of FIG. 1) may include a storage tank (not shown in FIG. 1) suitable for storage of catalyst or catalyst solution. In at least one embodiment, the catalyst storage tank is fluidly connected to a polymerization reactor (such as reactor (8) via catalyst solution line (5)). In another embodiment, the catalyst storage tank is fluidly connected with a pump station (not shown) that is fluidly connected to a polymerization reactor (such as reactor (8) via catalyst solution line (5)). It may be advantageous to allow for dilution of the catalyst or catalyst solution to allow for precise introduction of small quantities of catalyst to the polymerization reactor. Dilution may occur in a mixing vessel, an inline mixer, a charge vessel, or direct dilution of activator in a storage tank.

The processes of the present disclosure may use any catalyst system capable of polymerizing the monomers disclosed herein if that catalyst system is sufficiently active under the polymerization conditions disclosed herein. In some embodiments, the catalyst compound is a metallocene catalyst compound which may be part of a catalyst system.

Catalyst systems of the present disclosure may be formed by combining the catalysts with activators, including supporting the catalyst systems for use in slurry or gas phase polymerization. The catalyst systems may also be added to or generated in solution polymerization or bulk polymerization (in the monomer, i.e., little or no solvent).

A transition metal compound capable of catalyzing a polymerization upon activation with an activator as described above is suitable for use in a polymerization reactor of the present disclosure. Transition metal compounds known as metallocenes are exemplary catalyst compounds according to the present disclosure.

In at least one embodiment, the present disclosure provides a catalyst system including a catalyst compound having a metal atom. The catalyst compound can be a metallocene catalyst compound. The metal can be a Group 3 through Group 12 metal atom, such as Group 3 through Group 10 metal atoms, or lanthanide Group atoms. The catalyst compound having a Group 3 through Group 12 metal atom can be monodentate or multidentate, such as bidentate, tridentate, or tetradentate, where a heteroatom of the catalyst, such as phosphorous, oxygen, nitrogen, or sulfur is chelated to the metal atom of the catalyst. Non-limiting examples include bis(phenolate)s. In at least one embodiment, the Group 3 through Group 12 metal atom is selected from Group 5, Group 6, Group 8, or Group 10 metal atoms. In at least one embodiment, a Group 3 through Group 10 metal atom is selected from Cr, Sc, Ti, Zr, Hf, V, Nb, Ta, Mn, Re, Fe, Ru, Os, Co, Rh, Ir, and Ni. In at least one embodiment, a metal atom is selected from Groups 4, 5, and 6 metal atoms. In at least one embodiment, a metal atom is a Group 4 metal atom selected from Ti, Zr, or Hf. The oxidation state of the metal atom can be from 0 to +7, for example +1, +2, +3, +4, or +5, such as +2, +3, or +4.

### Metallocene Catalyst Compounds

A “metallocene” catalyst compound is a transition metal catalyst compound having one, two or three, typically one or two, substituted or unsubstituted cyclopentadienyl ligands (such as substituted or unsubstituted Cp, Ind or Flu) bound to the transition metal. Metallocene catalyst compounds include metallocenes including Group 3 to Group 12 metal complexes, such as, Group 4 to Group 6 metal complexes, for example, Group 4 metal complexes. The metallocene catalyst compound of catalyst systems of the present disclosure may be unbridged metallocene catalyst compounds represented by the formula: Cp^{A}Cp^{B}M′X′ₙ, where each Cp^{A} and Cp^{B} is independently selected from cyclopentadienyl ligands (for example, Cp, Ind, or Flu) and ligands isolobal to cyclopentadienyl, one or both Cp^{A} and Cp^{B} may contain heteroatoms, and one or both Cp^{A} and Cp^{B} may be substituted by one or more R″ groups; M′ is selected from Groups 3 through 12 atoms and lanthanide Group atoms; X′ is an anionic leaving group; n is 0 or an integer from 1 to 4; each R″ is independently selected from alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, ether, and thioether.

In at least one embodiment, each Cp^{A} and Cp^{B} is independently selected from cyclopentadienyl, indenyl, fluorenyl, indacenyl, tetrahydroindenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated and substituted versions thereof. Each Cp^{A} and Cp^{B} may independently be indacenyl or tetrahydroindenyl.

The metallocene catalyst compound may be a bridged metallocene catalyst compound represented by the formula: Cp^{A}(T)Cp^{B}M′X′n, where each Cp^{A} and Cp^{B} is independently selected from cyclopentadienyl ligands (for example, Cp, Ind, or Flu) and ligands isolobal to cyclopentadienyl, where one or both Cp^{A} and Cp^{B} may contain heteroatoms, and one or both Cp^{A} and Cp^{B} may be substituted by one or more R″ groups; M′ is selected from Groups 3 through 12 atoms and lanthanide Group atoms, such as Group 4; X′ is an anionic leaving group; n is 0 or an integer from 1 to 4; (T) is a bridging group selected from divalent alkyl, divalent substituted alkyl, divalent heteroalkyl, divalent alkenyl, divalent substituted alkenyl, divalent heteroalkenyl, divalent alkynyl, divalent substituted alkynyl, divalent heteroalkynyl, divalent alkoxy, divalent aryloxy, divalent alkylthio, divalent arylthio, divalent aryl, divalent substituted aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocycle, divalent heteroaryl, a divalent heteroatom-containing group, divalent hydrocarbyl, divalent substituted hydrocarbyl, divalent heterohydrocarbyl, divalent silyl, divalent boryl, divalent phosphino, divalent phosphine, divalent amino, divalent ether, divalent thioether. R″ is selected from alkyl, substituted alkyl, heteroalkyl, alkenyl, substituted alkenyl, heteroalkenyl, alkynyl, substituted alkynyl, heteroalkynyl, alkoxy, aryloxy, alkylthio, arylthio, aryl, substituted aryl, heteroaryl, aralkyl, aralkylene, alkaryl, alkarylene, haloalkyl, haloalkenyl, haloalkynyl, heteroalkyl, heterocycle, heteroaryl, a heteroatom-containing group, hydrocarbyl, substituted hydrocarbyl, heterohydrocarbyl, silyl, boryl, phosphino, phosphine, amino, germanium, ether, and thioether.

In at least one embodiment, each of Cp^{A} and Cp^{B} is independently selected from cyclopentadienyl, indenyl, fluorenyl, cyclopentaphenanthreneyl, benzindenyl, fluorenyl, octahydrofluorenyl, cyclooctatetraenyl, cyclopentacyclododecene, phenanthrindenyl, 3,4-benzofluorenyl, 9-phenylfluorenyl, 8-H-cyclopent[a]acenaphthylenyl, 7-H-dibenzofluorenyl, indeno[1,2-9]anthrene, thiophenoindenyl, thiophenofluorenyl, hydrogenated, and substituted versions thereof, such as cyclopentadienyl, n-propylcyclopentadienyl, indenyl, pentamethylcyclopentadienyl, tetramethylcyclopentadienyl, and n-butylcyclopentadienyl. Each Cp^{A} and Cp^{B} may independently be indacenyl or tetrahydroindenyl.

(T) is a bridging group containing at least one Group 13, 14, 15, or 16 element, in particular boron or a Group 14, 15 or 16 element, such as where (T) is O, S, NR′, or SiR′₂, where each R′ is independently hydrogen or C₁-C₂₀ hydrocarbyl.

In another embodiment, the metallocene catalyst compound is represented by the formula:

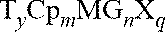

where Cp is independently a substituted or unsubstituted cyclopentadienyl ligand (for example, substituted or unsubstituted Cp, Ind, or Flu) or substituted or unsubstituted ligand isolobal to cyclopentadienyl; M is a Group 4 transition metal; G is a heteroatom group represented by the formula JR*_{z} where J is N, P, O or S, and R* is a linear, branched, or cyclic C₁-C₂₀ hydrocarbyl; z is 1 or 2; T is a bridging group; y is 0 or 1; X is a leaving group; m=1, n= 1, 2 or 3, q=0, 1, 2 or 3, and the sum of m+n+q is equal to the coordination number of the transition metal.

In at least one embodiment, J is N, and R* is methyl, ethyl, propyl, butyl, pentyl, hexyl, heptyl, octyl, nonyl, cyclooctyl, cyclododecyl, decyl, undecyl, dodecyl, adamantyl or an isomer thereof.

In at least one embodiment, the catalyst compound is represented by formula (II) or formula (III):

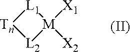

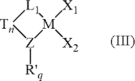

where in each of formula (II) and formula (III):
M is the metal center, and is a Group 4 metal, such as titanium, zirconium or hafnium, such as zirconium or hafnium when L₁ and L₂ are present and titanium when Z is present;
n is 0 or 1;
T is an optional bridging group which, if present, is a bridging group containing at least one Group 13, 14, 15, or 16 element, in particular boron or a Group 14, 15 or 16 element (such as where T is selected from dialkylsilyl, diarylsilyl, dialkylmethyl, ethylenyl ——CH₂———CH₂———) or hydrocarbylethylenyl where one, two, three or four of the hydrogen atoms in ethylenyl are substituted by hydrocarbyl, where hydrocarbyl can be independently C₁ to C₁₆ alkyl or phenyl, tolyl, xylyl and the like), and when T is present, the catalyst represented can be in a racemic or a meso form;
L₁ and L₂ are independently cyclopentadienyl, indenyl, tetrahydroindenyl or fluorenyl, optionally substituted, that are each bonded to M, or L₁ and L₂ are independently cyclopentadienyl, indenyl, tetrahydroindenyl or fluorenyl, which are optionally substituted, in which two adjacent substituents on L¹ and L₂ are optionally joined to form a substituted or unsubstituted, saturated, partially unsaturated, or aromatic cyclic or polycyclic substituent;
Z is nitrogen, oxygen, sulfur, or phosphorus (such as nitrogen);
q is 1 or 2 (such as where q is 1 when Z is N);
R′ is a cyclic, linear or branched C₁ to C₄₀ alkyl or substituted alkyl group;
X₁ and X₂ are, independently, hydrogen, halogen, hydride radicals, hydrocarbyl radicals, substituted hydrocarbyl radicals, halocarbyl radicals, substituted halocarbyl radicals, silylcarbyl radicals, substituted silylcarbyl radicals, germylcarbyl radicals, or substituted germylcarbyl radicals; or X₁ and X₂ are joined and bound to the metal atom to form a metallacycle ring containing from about 3 to about 20 carbon atoms; or both together can be an olefin, diolefin or aryne ligand.

In some embodiments, T is present and is a bridging group containing at least one element from Group 13, 14, 15, or 16 of the periodic table of the elements, in particular a Group 14 element. Examples of suitable bridging groups include P(=S)R′, P(=Se)R′, P(=O)R′, R′₂C, R′₂Si, R′₂Ge, R′₂CCR′₂, R′₂CCR′₂CR′₂, R′₂CCR′₂CR′₂CR′₂, R′C=CR′, R′C=CR′CR′₂, R′₂CCR′=CR′CR′₂, R′C=CR′CR′=CR′, R′C=CR′CR′₂CR′₂, R′₂CSiR′₂, R′₂SiSiR′₂, R′₂SiOSiR′₂, R′₂CSiR′₂CR′₂, R′₂SiCR′₂SiR′₂, R′C=CR′SiR′₂, R′₂CGeR′₂, R′₂GeGeR′₂, R′₂CGeR′₂CR′₂, R′₂GeCR′₂GeR′₂, R′₂SiGeR′₂, R′C=CR′GeR′₂, R′B, R′₂C-BR′, R′₂C-BR′-CR′₂, R′₂C-O-CR′₂, R′₂CR′₂C-0-CR′₂CR′₂, R′₂C-O-CR′₂CR′₂, R′₂C-O-CR′=CR′, R′₂C-S-CR′₂, R′₂CR′₂C-S-CR′₂CR′₂, R′₂C-S-CR′₂CR′₂, R′₂C-S-CR′=CR′, R′₂C-Se-CR′₂, R′₂CR′₂C-Se-CR′₂CR′₂, R′₂C-Se-CR′₂CR′₂, R′₂C-Se-CR′=CR′, R′₂C-N=CR′, R′₂C-NR′-CR′₂, R′₂C-NR′-CR′₂CR′₂, R′₂C-NR′-CR′=CR′, R′₂CR′₂C-NR′-CR′₂CR′₂, R′₂C-P=CR′, R′₂C-PR′-CR′₂, O, S, Se, Te, NR′ PR′, AsR′, SbR′, O—O, S—S, R′N-NR′, R′P-PR′, O—S, O-NR′, O-PR′, S-NR′, S-PR′, and R′N-PR′ where R′ is hydrogen or a C₁-C₂₀ containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent. Examples for the bridging group T include CH₂, CH₂CH₂, SiMe₂, SiPh₂, SiMePh, Si(CH₂)₃, Si(CH₂)₄, O, S, NPh, PPh, NMe, PMe, NEt, NPr, NBu, PEt, PPr, Me₂SiOSiMe₂, and PBu.

In some embodiments of formulas of the present disclosure, T is represented by the formula R^{a}₂J or (R^{a}₂J)₂, where J is C, Si, or Ge, and each R^{a} is, independently, hydrogen, halogen, C₁ to C₂₀ hydrocarbyl (such as methyl, ethyl, propyl, butyl, pentyl, hexyl, heptyl, octyl, nonyl, decyl, undecyl, or dodecyl) or a C₁ to C₂₀ substituted hydrocarbyl, and two R^{a} can form a cyclic structure including aromatic, partially saturated, or saturated cyclic or fused ring system. In some embodiments, T is a bridging group including carbon or silica, such as dialkylsilyl, such as where T is selected from CH₂, CH₂CH₂, C(CH₃)₂, SiMe₂, SiPh₂, SiMePh, silylcyclobutyl (Si(CH₂)₃), (Ph)₂C, (p-(Et)₃SiPh)₂C, Me₂SiOSiMe₂, and cyclopentasilylene (Si(CH₂)₄).

In at least one embodiment, the catalyst compound has a symmetry that is C2 symmetrical.

Suitable metallocenes include, but are not limited to, the metallocenes disclosed and referenced in the U.S. Pat. cited above, as well as those disclosed and referenced in U.S. Pat. 7,179,876; 7,169,864; 7,157,531; 7,129,302; 6,995,109; 6,958,306; 6,884,748; 6,689,847; U.S. Pat. publication 2007/0055028, and published PCT Applications WO 97/22635; WO 00/699/22; WO 01/30860; WO 01/30861; WO 02/46246; WO 02/50088; WO 04/026921; and WO 06/019494, all incorporated by reference. Additional suitable catalysts include those referenced in U.S. Pat. 6,309,997; 6,265,338; U.S. Pat. publication 2006/019925, and the following articles: Resconi, L. et al. (2000) “Selectivity in Propene Polymerization with Metallocene Catalysts,” Chem. Rev., v.100(4), pp. 1253-1346; Gibson, V. C. et al. (2003) “Advances in Non-Metallocene Olefin Polymerization Catalysis,” Chem. Rev., v.103(1), pp. 283-316; Nakayama, Y. et al. (2006) “MgCl₂/R′nAl(OR)₃₋ₙ: An Excellent Activator/Support for Transition-Metal Complexes for Olefin Polymerization,” Chem. Eur. J., v.12, pp. 7546-7556; Nakayama, Y et al. (2004), “Olefin Polymerization Behavior of bis(phenoxy-imine) Zr, Ti, and V complexes with MgCl₂-based Cocatalysts,” J. Mol. Catalysis A: Chemical, v.213, pp. 141-150; Nakayama, Y. et al. (2005), Propylene Polymerization Behavior of Fluorinated Bis(phenoxy-imine) Ti Complexes with an MgCl₂-Based Compound (MgCl₂-Supported Ti-Based Catalysts),” Macromol. Chem. Phys., v.206(18), pp. 1847-1852; and Matsui, S. et al. (2001) “A Family of Zirconium Complexes Having Two Phenoxy-Imine Chelate Ligands for Olefin Polymerization,” J. Am. Chem. Soc., v.123(28), pp. 6847-6856..

Exemplary metallocene compounds include:
bis(cyclopentadienyl)zirconium dichloride,
bis(n-butylcyclopentadienyl)zirconium dichloride,
bis(n-butylcyclopentadienyl)zirconium dimethyl,
bis(pentamethylcyclopentadienyl)zirconium dichloride,
bis(pentamethylcyclopentadienyl)zirconium dimethyl,
bis(pentamethylcyclopentadienyl)hafnium dichloride,
bis(pentamethylcyclopentadienyl)zirconium dimethyl,
bis(1-methyl-3-n-butylcyclopentadienyl)zirconium dichloride,
bis(1-methyl-3-n-butylcyclopentadienyl)zirconium dimethyl,
bis(1-methyl-3-n-butylcyclopentadienyl)hafnium dichloride,
bis(1-methyl-3-n-butylcyclopentadienyl)zirconium dimethyl,
bis(indenyl)zirconium dichloride,
bis(indenyl)zirconium dimethyl,
bis(tetrahydro-1-indenyl)zirconium dichloride,
bis(tetrahydro-1-indenyl)zirconium dimethyl,
(n-propyl cyclopentadienyl, pentamethyl cyclopentadienyl)zirconium dichloride, and
(n-propyl cyclopentadienyl, pentamethyl cyclopentadienyl)zirconium dimethyl.

In at least one embodiment, the catalyst compound may be selected from:
dimethylsilylbis(tetrahydroindenyl)MX,
dimethylsilylbis(2-methylindenyl)MXₙ,
dimethylsilylbis(2-methylfluorenyl)MX_{n,}
dimethylsilylbis(2-methyl-5,7-propylindenyl)MXₙ,
dimethylsilylbis(2-methyl-4-phenylindenyl)MXₙ,
dimethylsilylbis(2-ethyl-5-phenylindenyl)MXₙ,
dimethylsilylbis(2-methyl-4-biphenylindenyl)MXₙ,
dimethylsilylenebis(2-methyl-4-carbazolylindenyl)MXₙ,
rac-dimethylsilyl-bis-(5,6,7,8-tetrahydro-5,5,8,8-tetramethyl-2-methyl-1H-benz(f)indene )MXₙ,
diphenylmethylene (cyclopentadienyl)(fluorenyl)MXₙ,
bis(methylcyclopentadienyl)MXₙ,
rac-dimethylsilylbis(2-methyl,3-propyl indenyl)MXₙ,
dimethylsilylbis(indenyl)MXₙ,
Rac-meso-diphenylsilyl-bis(n-propylcyclopentadienyl)MXₙ,
1,1′-bis(4-triethylsilylphenyl)methylene-(cyclopentadienyl)(3,8-di-tertiary-butyl-1-fluorenyl)MXₙ (bridge is considered the 1 position),
bis-trimethylsilylphenyl-methylene(cyclopentadienyl)(di-t-butylfluorenyl)MXn,
bis-trimethylsilylphenyl-methylene(cyclopentadienyl)(fluorenyl)MXn,
bisphenylmethylene(cyclopentadienyl)(dimethylfluorenyl)MXn,
bis(n-propylcyclopentadienyl)MXₙ,
bis(n-butylcyclopentadienyl)MXₙ,
bis(n-pentylcyclopentadienyl)MXₙ,
(n-propyl cyclopentadienyl)(n-butylcyclopentadienyl)MXₙ,
bis[(2-trimethylsilylethyl)cyclopentadienyl]MXₙ,
bis(trimethylsilyl cyclopentadienyl)MXₙ,
dimethylsilylbis(n-propylcyclopentadienyl)MXₙ,
dimethylsilylbis(n-butylcyclopentadienyl)MXₙ,
bis( 1-n-propyl-2-methylcyclopentadienyl)MXₙ,
(n-propylcyclopentadienyl)(1-n-propyl-3-n-butylcyclopentadienyl)MXₙ,
bis(1-methyl, 3-n-butyl cyclopentadienyl)MXₙ,
bis(indenyl)MXₙ,
dimethylsilyl (tetramethylcyclopentadienyl)(cyclododecylamido)MXₐ,
dimethylsilyl (tetramethylcyclopentadienyl)(t-butylamido)MXₙ,
µ-(CH₃)₂Si(cyclopentadienyl)(1-adamantylamido)MXₙ,
µ-(CH₃)₂Si(3-tertbutylcyclopentadienyl)(1-adamantylamido)MXₙ,
µ-(CH₃)₂(tetramethylcyclopentadienyl)(1-adamantylamido)MXₙ,
µ-(CH₃)₂Si(tetramethylcyclopentadienyl)(1-adamantylamido)MXₙ,
µ-(CH₃)₂C(tetramethylcyclopentadienyl)(1-adamantylamido)MXₙ,
µ-(CH₃)₂Si(tetramethylcyclopentadienyl)(1-tertbutylamido)MXₙ,
µ-(CH₃)₂Si(fluorenyl)(1-tertbutylamido)MXₙ,
µ-(CH₃)₂Si(tetramethylcyclopentadienyl)(1-cyclododecylamido)MXₙ,
µ-(C₆H₅)₂C(tetramethylcyclopentadienyl)(1-cyclododecylamido)N4X.,
µ-(CH₃)₂Si(η⁵-2,6,6-trimethyl-1,5,6,7-tetrahydro-s-indacen-1-yl)(tertbutylamido)MXₙ,
where M is selected from Ti, Zr, and Hf; where X is selected from the group consisting of halogens, hydrides, C₁₋₁₂ alkyls, C₂₋₁₂ alkenyls, C₆₋₁₂ aryls, C₇₋₂₀ alkylaryls, C₁₋₁₂ alkoxys, C₆₋₁₆ aryloxys, C₇₋₁₈ alkylaryloxys, C₁₋₁₂ fluoroalkyls, C₆₋₁₂ fluoroaryls, and C₁₋₁₂ heteroatom-containing hydrocarbons, substituted derivatives thereof, and combinations thereof, and where n is zero or an integer from 1 to 4, such as where X is selected from halogens (such as bromide, fluoride, chloride), or C₁ to C₂₀ alkyls (such as methyl, ethyl, propyl, butyl, and pentyl) and n is 1 or 2.

In other embodiments, the catalyst is one or more of:
bis(1-methyl, 3-n-butyl cyclopentadienyl) M(R)₂;
dimethylsilyl bis(indenyl)M(R)₂;
bis(indenyl)M(R)₂;
dimethylsilyl bis(tetrahydroindenyl)M(R)₂;
bis(n-propylcyclopentadienyl)M(R)₂;
dimethylsilyl (tetramethylcyclopentadienyl)(cyclododecylamido)M(R)₂;
dimethylsilyl (tetramethylcyclopentadienyl)(cyclododecylamido)M(R)₂;
dimethylsilyl (tetramethylcyclopentadienyl)(t-butylamido)M(R)₂;
dimethylsilyl (tetramethylcyclopentadienyl)(t-butylamido)M(R)₂;
µ-(CH₃)₂Si(cyclopentadienyl)(1-adamantylamido)M(R)₂;
µ-(CH₃)₂Si(3-tertbutylcyclopentadienyl)(1-adamantylamido)M(R)₂;
µ-(CH₃)₂(tetramethylcyclopentadienyl)(1-adamantylamido)M(R)₂;
µ-(CH₃)₂Si(tetramethylcyclopentadienyl)(1-adamantylamido)M(R)₂;
µ-(CH₃)₂C(tetramethylcyclopentadienyl)(1-adamantylamido)M(R)₂;
µ-(CH₃)₂Si(tetramethylcyclopentadienyl)(1-tertbutylamido)M(R)₂;
µ-(CH₃)₂Si(fluorenyl)(1-tertbutylamido)M(R₂;
µ-(CH₃)₂Si(tetramethylcyclopentadienyl)(1-cyclododecylamido)M(R)₂;
µ-(C₆H₅)₂C(tetramethylcyclopentadienyl)(1-cyclododecylamido)M(R)₂;
µ-(CH₃)₂Si(η⁵-2,6,6-trimethyl-1,5,6,7-tetrahydro-s-indacen-1-yl)( tertbutylamido)M(R)₂;
where M is selected from Ti, Zr, and Hf; and R is selected from halogen or C₁ to C₅ alkyl.

In at least one embodiment, the catalyst compound is one or more of:
dimethylsilyl (tetramethylcyclopentadienyl)(cyclododecylamido)titanium dimethyl;
dimethylsilyl (tetramethylcyclopentadienyl)(cyclododecylamido)titanium dimethyl;
dimethylsilyl (tetramethylcyclopentadienyl)(t-butylamido)titanium dimethyl;
dimethylsilyl (tetramethylcyclopentadienyl)(t-butylamido)titanium dimethyl;
µ-(CH₃)₂Si(cyclopentadienyl)(1-adamantylamido)titanium dimethyl;
p-(CH₃)₂Si(3-tertbutylcyclopentadienyl)(1-adamantylamido)titanium dimethyl;
µ-(CH₃)₂(tetramethylcyclopentadienyl)(1-adamantylamido)titanium dimethyl;
µ-(CH₃)₂Si(tetramethylcyclopentadienyl)(1-adamantylamido)titanium dimethyl;
µ-(CH₃)₂C(tetramethylcyclopentadienyl)(1-adamantylamido)titanium dimethyl;
µ-(CH₃)₂Si(tetramethylcyclopentadienyl)(1-tertbutylamido)titanium dimethyl;
p -(CH₃)₂Si(fluorenyl)(I -tertbutylamido)titanium dimethyl;
µ-(CH₃)₂Si(tetramethylcyclopentadienyl)(1-cyclododecylamido)titanium dimethyl;
µ-(C₆H₅)₂C(tetramethylcyclopentadienyl)(1-cyclododecylamido)titanium dimethyl; and/or
µ-(CH₃)₂Si(η⁵-2,6,6-trimethyl-1,5,6,7-tetrahydro-s-indacen-1-yl)(tertbutylamido)titanium dimethyl.

In at least one embodiment, the catalyst is rac-dimethylsilyl-bis(indenyl)hafnium dimethyl and or 1,1′-bis(4-triethylsilylphenyl)methylene-(cyclopentadienyl)(3,8-di-tertiarybutyl-1-fluorenyl)hafnium dimethyl.

In at least one embodiment, the catalyst compound is one or more of:
bis(1-methyl, 3-n-butyl cyclopentadienyl)hafnium dimethyl,
bis(1-methyl, 3-n-butyl cyclopentadienyl)zirconium dimethyl,
dimethylsilyl bis(indenyl)zirconium dimethyl,
dimethylsilyl bis(indenyl)hafnium dimethyl,
bis(indenyl)zirconium dimethyl,
bis(indenyl)hafnium dimethyl,
dimethylsilyl bis(tetrahydroindenyl)zirconium dimethyl,
bis(n-propylcyclopentadienyl)zirconium dimethyl,
dimethylsilylbis(tetrahydroindenyl)hafnium dimethyl,
dimethylsilyl bis(2-methylindenyl)zirconium dimethyl,
dimethylsilyl bis(2-methylfluorenyl)zirconium dimethyl,
dimethylsilyl bis(2-methylindenyl)hafnium dimethyl,
dimethylsilyl bis(2-methylfluorenyl)hafnium dimethyl,
dimethylsilyl bis(2-methyl-5,7-propylindenyl) zirconium dimethyl,
dimethylsilyl bis(2-methyl-4-phenylindenyl) zirconium dimethyl,
dimethylsilyl bis(2-ethyl-5-phenylindenyl) zirconium dimethyl,
dimethylsilyl bis(2-methyl-4-biphenylindenyl) zirconium dimethyl,
dimethylsilylenebis(2-methyl-4-carbazolylindenyl) zirconium dimethyl,
rac-dimethylsilyl-bis-(5,6,7,8-tetrahydro-5,5,8,8-tetramethyl-2-methyl-1H-benz(f)indene)hafnium dimethyl,
diphenylmethylene (cyclopentadienyl)(fluorenyl)hafnium dimethyl,
bis(methylcyclopentadienyl)zirconium dimethyl,
rac-dimethylsilylbis(2-methyl,3-propyl indenyl)hafnium dimethyl,
dimethylsilylbis(indenyl)hafnium dimethyl,
dimethylsilylbis(indenyl)zirconium dimethyl,
dimethyl rac-dimethylsilyl-bis-(5,6,7,8-tetrahydro-5,5,8,8-tetramethyl-2-methyl-1H-benz(f)indene)hafnium dimethyl,
Rac-meso-diphenylsilyl-bis(n-propylcyclopentadienyl)hafnium dimethyl,
1,1′-bis(4-triethylsilylphenyl)methylene-(cyclopentadienyl)(3,8-di-tertiary-butyl-1-fluorenyl)hafnium Xₙ (bridge is considered the 1 position),
bis-trimethylsilylphenyl-methylene(cyclopentadienyl)(di-t-butylfluorenyl)hafnium dimethyl,
bis-trimethylsilylphenyl-methylene(cyclopentadienyl)(fluorenyl)hafnium dimethyl,
bisphenylmethylene(cyclopentadienyl)(dimethylfluorenyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl,
bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl,
bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl, and
dimethylsilyl(3-n-propylcyclopentadienyl)(tetramethylcyclopentadienyl)zirconium dimethyl.

### Non-Metallocene Catalyst Compounds

Transition metal complexes for polymerization processes can include an olefin polymerization catalyst. Suitable catalyst components may include “non-metallocene complexes” that are defined to be transition metal complexes that do not feature a cyclopentadienyl anion or substituted cyclopentadienyl anion donors (e.g., cyclopentadienyl, fluorenyl, indenyl, methylcyclopentadienyl). Examples of families of non-metallocene complexes that may be suitable can include late transition metal pyridylbisimines (e.g., U.S. 7,087,686), group 4 pyridyldiamidos (e.g., U.S. 7,973,116), quinolinyldiamidos (e.g., U.S. Pub. No. 2018/0002352 A1), pyridylamidos (e.g., U.S. 7,087,690), phenoxyimines (e.g., Accounts of Chemical Research 2009, 42, 1532-1544), and bridged bi-aromatic complexes (e.g., U.S. 7,091,292), the disclosures of which are incorporated by reference.

Catalyst complexes that are suitable for use in combination with the activators include: pyridyldiamido complexes; quinolinyldiamido complexes; phenoxyimine complexes; bisphenolate complexes; cyclopentadienyl-amidinate complexes; and iron pyridyl bis(imine) complexes or combinations thereof, including any suitable combination with metallocene complexes.

The term “pyridyldiamido complex” or “pyridyldiamide complex” or “pyridyldiamido catalyst” or “pyridyldiamide catalyst” refers to a class of coordination complexes described in U.S. Pat. No. 7,973,116B2, US 2012/0071616A1, US 2011/0224391A1, US 2011/0301310A1, US 2015/0141601A1, U.S. 6,900,321 and U.S. 8,592,615 that feature a dianionic tridentate ligand that is coordinated to a metal center through one neutral Lewis basic donor atom (e.g., a pyridine group) and a pair of anionic amido or phosphido (i.e., deprotonated amine or phosphine) donors. In these complexes the pyridyldiamido ligand is coordinated to the metal with the formation of one five membered chelate ring and one seven membered chelate ring. It is possible for additional atoms of the pyridyldiamido ligand to be coordinated to the metal without affecting the catalyst function upon activation; an example of such coordination could be a cyclometalated substituted aryl group that forms an additional bond to the metal center.

The term “quinolinyldiamido complex” or “quinolinyldiamido catalyst” or “quinolinyldiamide complex” or “quinolinyldiamide catalyst” refers to a related class of pyridyldiamido complex/catalyst described in US 2018/0002352 where a quinolinyl moiety is present instead of a pyridyl moiety.

The term “phenoxyimine complex” or “phenoxyimine catalyst” refers to a class of coordination complexes described in EP 0 874 005 that feature a monoanionic bidentate ligand that is coordinated to a metal center through one neutral Lewis basic donor atom (e.g., an imine moiety) and an anionic aryloxy (i.e., deprotonated phenoxy) donor. Typically two of these bidentate phenoxyimine ligands are coordinated to a group 4 metal to form a complex that is useful as a catalyst component.

The term “bisphenolate complex” or “bisphenolate catalyst” refers to a class of coordination complexes described in U.S. 6,841,502, WO 2017/004462, and WO 2006/020624 that feature a dianionic tetradentate ligand that is coordinated to a metal center through two neutral Lewis basic donor atoms (e.g., oxygen bridge moieties) and two anionic aryloxy (i.e., deprotonated phenoxy) donors.

The term “cyclopentadienyl-amidinate complex” or “cyclopentadienyl-amidinate catalyst” refers to a class of coordination complexes described in U.S. 8,188,200 that typically feature a group 4 metal bound to a cyclopentadienyl anion, a bidentate amidinate anion, and a couple of other anionic groups.

The term “iron pyridyl bis(imine) complex” refers to a class of iron coordination complexes described in US 7,087,686 that typically feature an iron metal center coordinated to a neutral, tridentate pyridyl bis(imine) ligand and two other anionic ligands.

Non-metallocene complexes can include iron complexes of tridentate pyridylbisimine ligands, zirconium and hafnium complexes of pyridylamido ligands, zirconium and hafnium complexes of tridentate pyridyldiamido ligands, zirconium and hafnium complexes of tridentate quinolinyldiamido ligands, zirconium and hafnium complexes of bidentate phenoxyimine ligands, and zirconium and hafnium complexes of bridged bi-aromatic ligands.

Suitable non-metallocene complexes can include zirconium and hafnium non-metallocene complexes. In at least one embodiment, non-metallocene complexes for the present disclosure include group 4 non-metallocene complexes including two anionic donor atoms and one or two neutral donor atoms. Suitable non-metallocene complexes for the present disclosure include group 4 non-metallocene complexes including an anionic amido donor. Suitable non-metallocene complexes for the present disclosure include group 4 non-metallocene complexes including an anionic aryloxide donor atom. Suitable non-metallocene complexes for the present disclosure include group 4 non-metallocene complexes including two anionic aryloxide donor atoms and two additional neutral donor atoms.

A catalyst compounds can be a quinolinyldiamido (QDA) transition metal complex represented by Formula (BI), such as by Formula (BII), such as by Formula (BIII):

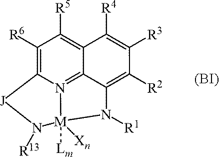

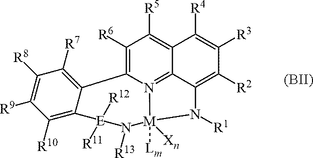

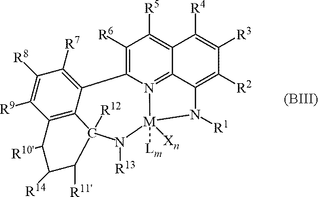

where:
M is a group 3, 4, 5, 6, 7, 8, 9, 10, 11, or 12 metal, such as a group 4 metal;
J is group including a three-atom-length bridge between the quinoline and the amido nitrogen, such as a group containing up to 50 non-hydrogen atoms;
E is carbon, silicon, or germanium;
X is an anionic leaving group, (such as a hydrocarbyl group or a halogen);
L is a neutral Lewis base;
R¹ and R¹³ are independently selected from the group including of hydrocarbyls, substituted hydrocarbyls, and silyl groups;
R², R³, R⁴, R⁵, R⁶, R⁷, R⁸, R⁹, R¹⁰, R^{10′}, R¹¹, R^{11′}, R¹², and R¹⁴ are independently hydrogen, hydrocarbyl, alkoxy, silyl, amino, aryloxy, substituted hydrocarbyl, halogen, or phosphino;
n is 1 or 2;
m is 0, 1, or 2, where
n+m is not greater than 4; and
two R groups (e.g., R¹ & R², R² & R₃, R¹⁰ and R¹¹, etc.) may be joined to form a substituted hydrocarbyl, unsubstituted hydrocarbyl, substituted heterocyclic, or unsubstituted heterocyclic, saturated or unsaturated ring, where the ring has 5, 6, 7, or 8 ring atoms and where substitutions on the ring can join to form additional rings;
two X groups may be joined together to form a dianionic group;
two L groups may be joined together to form a bidentate Lewis base; and
an X group may be joined to an L group to form a monoanionic bidentate group.

In at least one embodiment, M is a group 4 metal, such as zirconium or hafnium, such as M is hafnium.

Representative non-metallocene transition metal compounds usable for forming poly(alpha-olefin)s of the present disclosure also include tetrabenzyl zirconium, tetra bis(trimethylsilymethyl) zirconium, oxotris(trimethlsilylmethyl) vanadium, tetrabenzyl hafnium, tetrabenzyl titanium, bis(hexamethyl disilazido)dimethyl titanium, tris(trimethyl silyl methyl) niobium dichloride, and tris(trimethylsilylmethyl) tantalum dichloride.

In at least one embodiment, J is an aromatic substituted or unsubstituted hydrocarbyl having from 3 to 30 non-hydrogen atoms, such as J is represented by the formula:

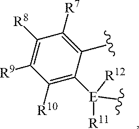

such as J is

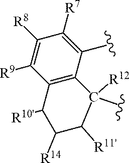

where R⁷, R⁸, R⁹, R¹⁰, R^{10′}, R¹¹, R^{11′}, R¹², R¹⁴ and E are as defined above, and two R groups (e.g., R⁷ & R⁸, R⁸ & R⁹, R⁹ & R¹⁰, R¹⁰ & R¹¹, etc.) may be joined to form a substituted or unsubstituted hydrocarbyl or heterocyclic ring, where the ring has 5, 6, 7, or 8 ring atoms (such as 5 or 6 atoms), and said ring may be saturated or unsaturated (such as partially unsaturated or aromatic), such as J is an arylalkyl (such as arylmethyl, etc.) or dihydro-1H-indenyl, or tetrahydronaphthalenyl group.

In at least one embodiment, J is selected from the following structures:

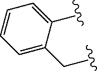

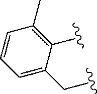

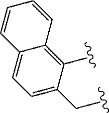

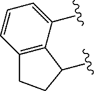

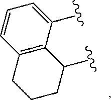

where

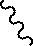

indicates connection to the complex.

In at least one embodiment, E is carbon.

X may be an alkyl (such as alkyl groups having 1 to 10 carbons, such as methyl, ethyl, propyl, butyl, pentyl, hexyl, heptyl, octyl, nonyl, decyl, and isomers thereof), aryl, hydride, alkylsilane, fluoride, chloride, bromide, iodide, triflate, carboxylate, amido (such as NMe₂), or alkylsulfonate.

In at least one embodiment, L is an ether, amine or thioether.

In at least one embodiment, R⁷ and R⁸ are joined to form a six-membered aromatic ring with the joined R⁷/R⁸ group being —CH═CHCH═CH—.

R¹⁰ and R¹¹ may be joined to form a five-membered ring with the joined R¹⁰R¹¹ group being —CH₂CH₂—.

In at least one embodiment, R¹⁰ and R¹¹ are joined to form a six-membered ring with the joined R¹⁰R¹¹ group being —CH₂CH₂CH₂—.

R¹ and R¹³ may be independently selected from phenyl groups that are variously substituted with zero to five substituents that include F, Cl, Br, I, CF₃, NO₂, alkoxy, dialkylamino, aryl, and alkyl groups having 1 to 10 carbons, such as methyl, ethyl, propyl, butyl, pentyl, hexyl, heptyl, octyl, nonyl, decyl, and isomers thereof.

In at least one embodiment, the QDA transition metal complex represented by the Formula (II) above where:
M is a group 4 metal (such hafnium);
E is selected from carbon, silicon, or germanium (such as carbon);
X is an alkyl, aryl, hydride, alkylsilane, fluoride, chloride, bromide, iodide, triflate, carboxylate, amido, alkoxo, or alkylsulfonate;
L is an ether, amine, or thioether;
R¹ and R¹³ are independently selected from the group consisting of hydrocarbyls, substituted hydrocarbyls, and silyl groups (such as aryl);
R², R³, R⁴, R⁵, R⁶, R⁷, R⁸, R⁹, R¹⁰, R¹¹, and R¹² are independently hydrogen, hydrocarbyl, alkoxy, silyl, amino, aryloxy, substituted hydrocarbyls, halogen, and phosphino;
n is 1 or 2;
m is 0, 1, or 2;
n+m is from 1 to 4;
two X groups may be joined together to form a dianionic group;
two L groups may be joined together to form a bidentate Lewis base;
an X group may be joined to an L group to form a monoanionic bidentate group;
R⁷ and R⁸ may be joined to form a ring (such as an aromatic ring, a six-membered aromatic ring with the joined R⁷R⁸ group being —CH═CHCH═CH—); and
R¹⁰ and R¹¹ may be joined to form a ring (such as a five-membered ring with the joined R¹⁰R¹¹ group being —CH₂CH₂—, a six-membered ring with the joined R¹⁰R¹ ¹ group being —CH₂CH₂CH₂—).

In at least one embodiment of Formula (BI), (BII), and (BIII), R⁴, R⁵, and R⁶ are independently selected from the group including hydrogen, hydrocarbyls, substituted hydrocarbyls, alkoxy, aryloxy, halogen, amino, and silyl, and where adjacent R groups (R⁴ and R⁵ and/or R⁵ and R⁶) are joined to form a substituted hydrocarbyl, unsubstituted hydrocarbyl, unsubstituted heterocyclic ring or substituted heterocyclic ring, where the ring has 5, 6, 7, or 8 ring atoms and where substitutions on the ring can join to form additional rings.

In at least one embodiment of Formula (BI), (BII), and (BIII), R⁷, R⁸, R⁹, and R¹⁰ are independently selected from the group including hydrogen, hydrocarbyls, substituted hydrocarbyls, alkoxy, halogen, amino, and silyl, and where adjacent R groups (R⁷ and R⁸ and/or R⁹ and R¹⁰) may be joined to form a saturated, substituted hydrocarbyl, unsubstituted hydrocarbyl, unsubstituted heterocyclic ring or substituted heterocyclic ring, where the ring has 5, 6, 7, or 8 ring carbon atoms and where substitutions on the ring can join to form additional rings.

In at least one embodiment of Formula (BI), (BII), and (BIII), R² and R³ are each, independently, selected from the group including hydrogen, hydrocarbyls, and substituted hydrocarbyls, alkoxy, silyl, amino, aryloxy, halogen, and phosphino, R² and R³ may be joined to form a saturated, substituted or unsubstituted hydrocarbyl ring, where the ring has 4, 5, 6, or 7 ring carbon atoms and where substitutions on the ring can join to form additional rings, or R² and R³ may be joined to form a saturated heterocyclic ring, or a saturated substituted heterocyclic ring where substitutions on the ring can join to form additional rings.

In at least one embodiment of Formula (BI), (BII), and (BIII), R¹¹ and R¹² are each, independently, selected from the group including hydrogen, hydrocarbyls, and substituted hydrocarbyls, alkoxy, silyl, amino, aryloxy, halogen, and phosphino, R¹¹ and R¹² may be joined to form a saturated, substituted or unsubstituted hydrocarbyl ring, where the ring has 4, 5, 6, or 7 ring carbon atoms and where substitutions on the ring can join to form additional rings, or R¹¹ and R¹² may be joined to form a saturated heterocyclic ring, or a saturated substituted heterocyclic ring where substitutions on the ring can join to form additional rings, or R¹¹ and R¹⁰ may be joined to form a saturated heterocyclic ring, or a saturated substituted heterocyclic ring where substitutions on the ring can join to form additional rings.

In at least one embodiment of Formula (BI), (BII), and (BIII), R¹ and R¹³ are independently selected from phenyl groups that are variously substituted with zero to five substituents that include F, Cl, Br, I, CF₃, NO₂, alkoxy, dialkylamino, aryl, and alkyl groups having 1 to 10 carbons, such as methyl, ethyl, propyl, butyl, pentyl, hexyl, heptyl, octyl, nonyl, decyl, and isomers thereof.

In at least one embodiment of Formula (BII), suitable R¹²-E-R¹¹ groups include CH₂, CMe₂, SiMe₂, SiEt₂, SiPr₂, SiBu₂, SiPh₂, Si(aryl)₂, Si(alkyl)₂, CH(aryl), CH(Ph), CH(alkyl), and CH(2-isopropylphenyl), where alkyl is a C₁ to C₄₀ alkyl group (such as C₁ to C₂₀ alkyl, such as one or more of methyl, ethyl, propyl, butyl, pentyl, hexyl, heptyl, octyl, nonyl, decyl, undecyl, dodecyl, and isomers thereof), aryl is a C₅ to C₄₀ aryl group (such as a C₆ to C₂₀ aryl group, such as phenyl or substituted phenyl, such as phenyl, 2-isopropylphenyl, or 2-tertbutylphenyl).

In at least one embodiment of Formula (BIII), R¹¹, R¹², R⁹, R¹⁴, and R¹⁰ are independently selected from the group consisting of hydrogen, hydrocarbyls, substituted hydrocarbyls, alkoxy, halogen, amino, and silyl, and where adjacent R groups (R¹⁰ and R¹⁴, and/or R¹¹ and R¹⁴, and/or R⁹ and R¹⁰) may be joined to form a saturated, substituted hydrocarbyl, unsubstituted hydrocarbyl, unsubstituted heterocyclic ring or substituted heterocyclic ring, where the ring has 5, 6, 7, or 8 ring carbon atoms and where substitutions on the ring can join to form additional rings.

The R groups above (such as, individually R² to R¹⁴) and other R groups mentioned hereafter may contain from 1 to 30, such as 2 to 20 carbon atoms, such as from 6 to 20 carbon atoms. The R groups above (such as, individually R² to R¹⁴) and other R groups mentioned hereafter, may be independently selected from the group including hydrogen, methyl, ethyl, phenyl, isopropyl, isobutyl, trimethylsilyl, and —CH₂—Si(Me)₃.

In at least one embodiment, the quinolinyldiamide complex is linked to one or more additional transition metal complex, such as a quinolinyldiamide complex or another suitable non-metallocene, through an R group in such a fashion as to make a bimetallic, trimetallic, or multimetallic complex that may be used as a catalyst component for olefin polymerization. The linker R-group in such a complex may contain 1 to 30 carbon atoms.

In at least one embodiment, E is carbon and R¹¹ and R¹² are independently selected from phenyl groups that are substituted with 0, 1, 2, 3, 4, or 5 substituents selected from the group consisting of F, Cl, Br, I, CF₃, NO₂, alkoxy, dialkylamino, hydrocarbyl, and substituted hydrocarbyl groups with from one to ten carbons.

In at least one embodiment of Formula (BII) or (BIII), R¹¹ and R¹² are independently selected from hydrogen, methyl, ethyl, phenyl, isopropyl, isobutyl, —CH₂—Si(Me)₃, and trimethylsilyl.

In at least one embodiment of Formula (BII), and (BIII), R⁷, R⁸, R⁹, and R¹⁰ are independently selected from hydrogen, methyl, ethyl, propyl, isopropyl, phenyl, cyclohexyl, fluoro, chloro, methoxy, ethoxy, phenoxy, —CH₂—Si(Me)₃, and trimethylsilyl.

In at least one embodiment of Formula (BI), (BII), and (BIII), R², R³, R⁴, R⁵, and R⁶ are independently selected from the group consisting of hydrogen, hydrocarbyls, alkoxy, silyl, amino, substituted hydrocarbyls, and halogen.

In at least one embodiment of Formula (BIII), R¹⁰, R¹¹ and R¹⁴ are independently selected from hydrogen, methyl, ethyl, phenyl, isopropyl, isobutyl, —CH₂—Si(Me)₃, and trimethylsilyl.

In at least one embodiment of Formula (BI), (BII), and (BIII), each L is independently selected from Et₂O, MeOtBu, Et₃N, PhNMe₂, MePh₂N, tetrahydrofuran, and dimethylsulfide.

In at least one embodiment of Formula (BI), (BII), and (BIII), each X is independently selected from methyl, benzyl, trimethylsilyl, neopentyl, ethyl, propyl, butyl, phenyl, hydrido, chloro, fluoro, bromo, iodo, dimethylamido, diethylamido, dipropylamido, and diisopropylamido.

In at least one embodiment of Formula (BI), (BII), and (BIII), R¹ is 2,6-diisopropylphenyl, 2,4,6-triisopropylphenyl, 2,6-diisopropyl-4-methylphenyl, 2,6-diethylphenyl, 2-ethyl-6-isopropylphenyl, 2,6-bis(3-pentyl)phenyl, 2,6-dicyclopentylphenyl, or 2,6-dicyclohexylphenyl.

In at least one embodiment of Formula (BI), (BII), and (BIII), R¹³ is phenyl, 2-methylphenyl, 2-ethylphenyl, 2-propylphenyl, 2,6-dimethylphenyl, 2-isopropylphenyl, 4-methylphenyl, 3,5-dimethylphenyl, 3,5-di-tert-butylphenyl, 4-fluorophenyl, 3-methylphenyl, 4-dimethylaminophenyl, or 2-phenylphenyl.

In at least one embodiment of Formula (BII), J is dihydro-1H-indenyl and R¹ is 2,6-dialkylphenyl or 2,4,6-trialkylphenyl.

In at least one embodiment of Formula (BI), (BII), and (BIII), R¹ is 2,6-diisopropylphenyl and R¹³ is a hydrocarbyl group containing 1, 2, 3, 4, 5, 6, or 7 carbon atoms.

An exemplary catalyst used for polymerizations of the present disclosure is (QDA-1)HfMe₂, as described in U.S. Pub. No. 2018/0002352 A1.

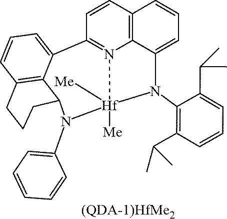

In at least one embodiment, the catalyst compound is a bis(phenolate) catalyst compound represented by Formula (CI):

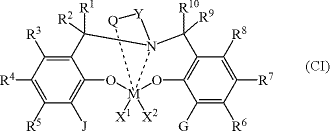

M is a Group 4 metal, such as Hf or Zr. X¹ and X² are independently a univalent C₁-C₂₀ hydrocarbyl, C₁-C₂₀ substituted hydrocarbyl, a heteroatom or a heteroatom-containing group, or X¹ and X² join together to form a C₄-C₆₂ cyclic or polycyclic ring structure. R¹, R², R³, R⁴, R⁵, R⁶, R⁷, R³, R⁹, and R¹⁰ is independently hydrogen, C₁-C₄₀ hydrocarbyl, C₁-C₄₀ substituted hydrocarbyl, a heteroatom or a heteroatom-containing group, or two or more of R¹, R², R³, R⁴, R⁵, R⁶, R⁷, R⁸, R⁹, or R¹⁰ are joined together to form a C₄-C₆₂ cyclic or polycyclic ring structure, or a combination thereof; Q is a neutral donor group; J is heterocycle, a substituted or unsubstituted C₇-C₆₀ fused polycyclic group, where at least one ring is aromatic and where at least one ring, which may or may not be aromatic, has at least five ring atoms’ G is as defined for J or may be hydrogen, C₂-C₆₀ hydrocarbyl, C₁-C₆₀ substituted hydrocarbyl, or may independently form a C₄-C₆₀ cyclic or polycyclic ring structure with R⁶, R⁷, or R⁸ or a combination thereof; Y is divalent C₁-C₂₀ hydrocarbyl or divalent C₁-C₂₀ substituted hydrocarbyl or (-Q-Y-) together form a heterocycle; and heterocycle may be aromatic and/or may have multiple fused rings.

In at least one embodiment, the catalyst compound represented by Formula (CI) is represented by Formula (CII) or Formula (CIII):

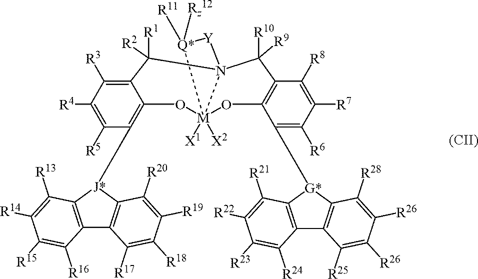

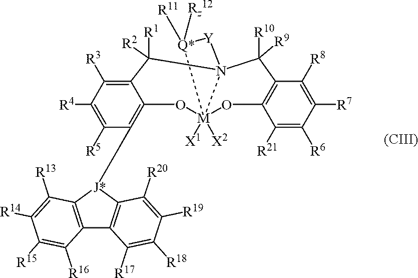

M is Hf, Zr, or Ti. X¹, X², R¹, R², R³, R⁴, R⁵, R⁶, R⁷, R⁸, R⁹, R¹⁰, and Y are as defined for Formula (CI). R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²⁸ is independently a hydrogen, C₁-C₄₀ hydrocarbyl, C₁-C₄₀ substituted hydrocarbyl, a functional group including elements from Groups 13 to 17, or two or more of R¹, R², R³, R⁴, R⁵, R⁶, R⁷, R⁸, R⁹, R¹⁰ R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, and R²¹ may independently join together to form a C₄-C₆₂ cyclic or polycyclic ring structure, or a combination thereof; R¹¹ and R¹² may join together to form a five- to eight-membered heterocycle; Q* is a group 15 or 16 atom; z is 0 or 1; J* is CR” or N, and G* is CR” or N, where R″ is C₁-C₂₀ hydrocarbyl or carbonyl-containing C₁-C₂₀ hydrocarbyl; and z = 0 if Q* is a group 16 atom, and z = 1 if Q* is a group 15 atom.

In at least one embodiment the catalyst is an iron complex represented by formula (DI):

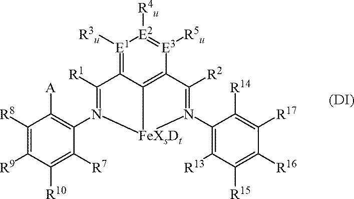

where:
A is chlorine, bromine, iodine, —CF₃ or -OR¹¹;
each of R¹ and R² is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or five-, six- or seven-membered heterocyclyl including at least one atom selected from the group consisting of N, P, O and S;
where each of R¹ and R² is optionally substituted by halogen, -NR¹¹₂, -OR¹¹ or -SiR¹²₃;
where R¹ optionally bonds with R³, and R² optionally bonds with R⁵, in each case to independently form a five-, six- or seven-membered ring;
R⁷ is a C₁-C₂₀ alkyl;
each of R³, R⁴, R⁵, R⁸, R⁹, R¹⁰, R¹⁵, R¹⁶, and R¹⁷ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, -NR¹¹₂, -OR¹¹, halogen, -SiR¹²₃ or five-, six- or seven-membered heterocyclyl including at least one atom selected from the group consisting of N, P, O, and S; where R³, R⁴, R⁵, R⁷, R⁸, R⁹, R¹⁰, R¹⁵, R¹⁶, and R¹⁷ are optionally substituted by halogen, -NR¹¹₂, -OR¹¹ or -SiR¹²₃;
where R³ optionally bonds with R⁴, R⁴ optionally bonds with R⁵, R⁷ optionally bonds with R¹⁰, R¹⁰ optionally bonds with R⁹, R⁹ optionally bonds with R⁸, R¹⁷ optionally bonds with R¹⁶, and
R¹⁶ optionally bonds with R¹⁵, in each case to independently form a five-, six- or seven-membered carbocyclic or heterocyclic ring, the heterocyclic ring including at least one atom from the group consisting of N, P, O and S;
R¹³ is C₁-C₂₀-alkyl bonded with the aryl ring via a primary or secondary carbon atom;
R¹⁴ is chlorine, bromine, iodine, —CF₃ or -OR¹¹, or C₁-C₂₀-alkyl bonded with the aryl ring;
each R¹¹ is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or -SiR¹²₃, where R¹¹ is optionally substituted by halogen, or two R¹¹ radicals optionally bond to form a five- or six-membered ring;
each R¹² is independently hydrogen, C₁-C₂₂-alkyl, C₂-C₂₂-alkenyl, C₆-C₂₂-aryl, arylalkyl where alkyl has from 1 to 10 carbon atoms and aryl has from 6 to 20 carbon atoms, or two R¹² radicals optionally bond to form a five- or six-membered ring;
each of E¹, E², and E³ is independently carbon, nitrogen or phosphorus;
each u is independently 0 if E¹, E², and E³ is nitrogen or phosphorus and is 1 if E¹, E², and E³ is carbon;
each X is independently fluorine, chlorine, bromine, iodine, hydrogen, C₁-C₂₀-alkyl, C₂-C₁₀-alkenyl, C₆-C₂₀-aryl, arylalkyl where alkyl has from 1 to 10 carbon atoms and aryl has from 6 to 20 carbon atoms, -NR¹⁸₂, -OR¹⁸, -SR¹⁸, -SO₃R¹⁸, -OC(O)R¹⁸, —CN, —SCN, β-diketonate, —CO, —BF₄⁻, —PF₆⁻ or bulky non-coordinating anions, and the radicals X can be bonded with one another;
each R¹⁸ is independently hydrogen, C₁-C₂₀-alkyl, C₂-C₂₀-alkenyl, C₆-C₂₀-aryl, arylalkyl where alkyl has from 1 to 10 carbon atoms and aryl has from 6 to 20 carbon atoms, or -SiR¹⁹₃, where R¹⁸ can be substituted by halogen or nitrogen- or oxygen-containing groups and two R¹⁸ radicals optionally bond to form a five- or six-membered ring;
each R¹⁹ is independently hydrogen, C₁-C₂₀-alkyl, C₂-C₂₀-alkenyl, C₆-C₂₀-aryl or arylalkyl where alkyl has from 1 to 10 carbon atoms and aryl has from 6 to 20 carbon atoms, where R¹⁹ can be substituted by halogen or nitrogen- or oxygen-containing groups or two R¹⁹ radicals optionally bond to form a five- or six-membered ring;
s is 1, 2, or 3;
D is a neutral donor; and
t is 0 to 2.

In another embodiment, the catalyst is a phenoxyimine compound represented by the formula (EI):

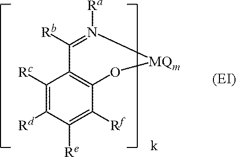

where M represents a transition metal atom selected from the groups 3 to 11 metals in the periodic table; k is an integer of 1 to 6; m is an integer of 1 to 6; R^{a} to R^{f} may be the same or different from one another and each represent a hydrogen atom, a halogen atom, a hydrocarbyl group, a heterocyclic compound residue, an oxygen-containing group, a nitrogen-containing group, a boron-containing group, a sulfur-containing group, a phosphorus-containing group, a silicon-containing group, a germanium-containing group or a tin-containing group, among which 2 or more groups may be bound to each other to form a ring; when k is 2 or more, R^{a} groups, R^{b} groups, R^{c} groups, R^{d} groups, R^{e} groups, or R^{f} groups may be the same or different from one another, one group of R^{a} to R^{f} contained in one ligand and one group of R^{a} to R^{f} contained in another ligand may form a linking group or a single bond, and a heteroatom contained in R^{a} to R^{f} may coordinate with or bind to M; m is a number satisfying the valence of M; Q represents a hydrogen atom, a halogen atom, an oxygen atom, a hydrocarbon group, an oxygen-containing group, a sulfur-containing group, a nitrogen-containing group, a boron-containing group, an aluminum-containing group, a phosphorus-containing group, a halogen-containing group, a heterocyclic compound residue, a silicon-containing group, a germanium-containing group or a tin-containing group; when m is 2 or more, a plurality of groups represented by Q may be the same or different from one another, and a plurality of groups represented by Q may be mutually bound to form a ring.

In another embodiment, the catalyst is a bis(imino)pyridyl of the formula (FI):

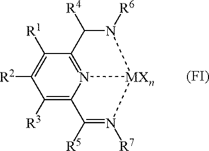

where:
M is Co or Fe; each X is an anion; n is 1, 2 or 3, so that the total number of negative charges on said anion or anions is equal to the oxidation state of a Fe or Co atom present in (FI);
R¹, R² and R³ are each independently hydrogen, hydrocarbyl, substituted hydrocarbyl, or an inert functional group;
R⁴ and R⁵ are each independently hydrogen, hydrocarbyl, an inert functional group or substituted hydrocarbyl;
R⁶ is formula (IX):

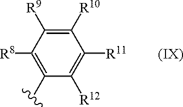

and R⁷ is formula (X):

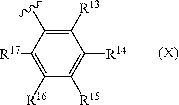

R⁸ and R¹³ are each independently hydrocarbyl, substituted hydrocarbyl or an inert functional group;
R⁹, R¹⁰, R¹¹, R¹⁴, R¹⁵ and R¹⁶ are each independently hydrogen, hydrocarbyl, substituted hydrocarbyl or an inert functional group;
R¹² and R¹⁷ are each independently hydrogen, hydrocarbyl, substituted hydrocarbyl or an inert functional group;
and provided that two of R⁸, R⁹, R¹⁰, R¹¹, R¹², R¹³, R¹⁴, R¹⁵, R¹⁶ and R¹⁷ that are adjacent to one another, together may form a ring.

In at least one embodiment, the catalyst compound is represented by the formula (GI):

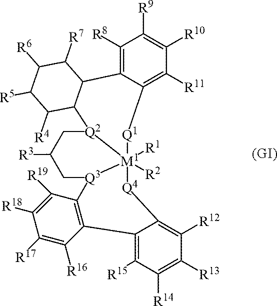

M¹ is selected from the group consisting of titanium, zirconium, hafnium, vanadium, niobium, tantalum, chromium, molybdenum and tungsten. In at least one embodiment, M¹ is zirconium.

Each of Q¹, Q², Q³, and Q⁴ of formula (GI) is independently oxygen or sulfur. In at least one embodiment, at least one of Q¹, Q², Q³, and Q⁴ is oxygen, alternately all of Q¹, Q², Q₃, and Q⁴ are oxygen.

R¹ and R² of formula (GI) are independently hydrogen, halogen, hydroxyl, hydrocarbyl, or substituted hydrocarbyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen). R¹ and R² can be a halogen selected from fluorine, chlorine, bromine, or iodine. In at least one embodiment, R¹ and R² are chlorine.

Alternatively, R¹ and R² of formula (GI) may also be joined together to form an alkanediyl group or a conjugated C₄-C₄₀ diene ligand which is coordinated to M¹. R¹ and R² may also be identical or different conjugated dienes, optionally substituted with one or more hydrocarbyl, tri(hydrocarbyl) silyl or tri(hydrocarbyl) silylhydrocarbyl, the dienes having up to 30 atoms not counting hydrogen and/or forming a π-complex with M¹.

Exemplary groups suitable for R¹ and or R² of formula (GI) can include 1,4-diphenyl, 1,3-butadiene, 1,3-pentadiene, 2-methyl 1,3-pentadiene, 2,4-hexadiene, 1-phenyl, 1,3-pentadiene, 1,4-dibenzyl, 1,3-butadiene, 1,4-ditolyl-1,3-butadiene, 1,4-bis (trimethylsilyl)-1,3-butadiene, and 1,4-dinaphthyl-1,3-butadiene. R¹ and R² can be identical and are C₁-C₃ alkyl or alkoxy, C₆-C₁₀ aryl or aryloxy, C₂-C₄ alkenyl, C₇-C₁₀ arylalkyl, C₇-C₁₂ alkylaryl, or halogen.

Each of R⁴, R⁵, R⁶, R⁷, R⁸, R⁹, R¹⁰, R¹¹, R¹², R¹³, R¹⁴, R¹⁵, R¹⁶, R¹⁷, R¹⁸, and R¹⁹ of formula (GI) is independently hydrogen, halogen, C₁-C₄₀ hydrocarbyl or C₁-C₄₀ substituted hydrocarbyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen), -NR′₂, -SR′, -OR, -OSiR′₃, -PR′₂, where each R′ is hydrogen, halogen, C₁-C₁₀ alkyl, or C₆-C₁₀ aryl, or one or more of R⁴ and R⁵, R⁵ and R⁶, R⁶ and R⁷, R⁸ and R⁹, R⁹ and R¹⁰, R¹⁰ and R¹¹, R¹² and R¹³, R¹³ and R¹⁴, R¹⁴ and R¹⁵, R¹⁶ and R¹⁷, R¹⁷ and R¹⁸, and R¹⁸ and R¹⁹ are joined to form a saturated ring, unsaturated ring, substituted saturated ring, or substituted unsaturated ring. In at least one embodiment, C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl. In at least one embodiment, R¹¹ and R¹² are C₆-C₁₀ aryl such as phenyl or naphthyl optionally substituted with C₁-C₄₀ hydrocarbyl, such as C₁-C₁₀ hydrocarbyl. In at least one embodiment, R⁶ and R¹⁷ are C₁-₄₀ alkyl, such as C₁-C₁₀ alkyl.

In at least one embodiment, each of R⁴, R⁵, R⁶, R⁷, R⁸, R⁹, R¹⁰, R¹³, R¹⁴, R¹⁵, R¹⁶, R¹⁷, R¹⁸, and R¹⁹ of formula (GI) is independently hydrogen or C₁-C₄₀ hydrocarbyl. In at least one embodiment, C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl. In at least one embodiment, each of R⁶ and R¹⁷ is C₁-C₄₀ hydrocarbyl and R⁴, R⁵, R⁷, R⁸, R⁹, R¹⁰, R¹³, R¹⁴, R¹⁵, R¹⁶, R¹⁸, and R¹⁹ is hydrogen. In at least one embodiment, C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl.

R³ of formula (GI) is a C₁-C₄₀ unsaturated alkyl or substituted C₁-C₄₀ unsaturated alkyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen).

In at least one embodiment, R³ of formula (GI) is a hydrocarbyl including a vinyl moiety. The terms “vinyl” and “vinyl moiety” are used interchangeably and include a terminal alkene, e.g., represented by the structure

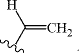

Hydrocarbyl of R³ may be further substituted (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen). In at least one embodiment, R³ is C₁-C₄₀ unsaturated alkyl that is vinyl or substituted C₁-C₄₀ unsaturated alkyl that is vinyl. R³ can be represented by the structure -R′CH=CH₂ where R′ is C₁-C₄₀ hydrocarbyl or C₁-C₄₀ substituted hydrocarbyl (such as C₁-C₁₀ alkyl, C₁-C₁₀ alkoxy, C₆-C₂₀ aryl, C₆-C₁₀ aryloxy, C₂-C₁₀ alkenyl, C₂-C₄₀ alkenyl, C₇-C₄₀ arylalkyl, C₇-C₄₀ alkylaryl, C₈-C₄₀ arylalkenyl, or conjugated diene which is optionally substituted with one or more hydrocarbyl, tri(hydrocarbyl) silyl or tri(hydrocarbyl) silylhydrocarbyl, the diene having up to 30 atoms other than hydrogen). In at least one embodiment, C₁-C₄₀ hydrocarbyl is selected from methyl, ethyl, propyl, n-propyl, isopropyl, n-butyl, isobutyl, sec-butyl, n-pentyl, isopentyl, sec-pentyl, n-hexyl, isohexyl, sec-hexyl, n-heptyl, isoheptyl, sec-heptyl, n-octyl, isooctyl, sec-octyl, n-nonyl, isononyl, sec-nonyl, n-decyl, isodecyl, and sec-decyl.

In at least one embodiment, R³ of formula (GI) is 1-propenyl, 1-butenyl, 1-pentenyl, 1-hexenyl, 1-heptenyl, 1-octenyl, 1-nonenyl, or 1-decenyl.

In at least one embodiment, the catalyst is a Group 15-containing metal compound represented by formulas (XII) or (XIII):

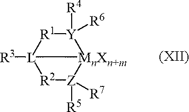

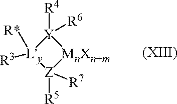

where M is a Group 3 to 12 transition metal or a Group 13 or 14 main group metal, a Group 4, 5, or 6 metal. In some embodiments, M is a Group 4 metal, such as zirconium, titanium, or hafnium. Each X is independently a leaving group, such as an anionic leaving group. The leaving group may include a hydrogen, a hydrocarbyl group, a heteroatom, a halogen, or an alkyl; y is 0 or 1 (when y is 0 group L′ is absent). The term “n” is the oxidation state of M. In various embodiments, n is +3, +4, or +5. In some embodiments, n is +4. The term “m” represents the formal charge of the YZL or the YZL′ ligand, and is 0, -1, -2 or -3 in various embodiments. In some embodiments, m is -2. L is a Group 15 or 16 element, such as nitrogen or oxygen; L′ is a Group 15 or 16 element or Group 14 containing group, such as carbon, silicon or germanium. Y is a Group 15 element, such as nitrogen or phosphorus. In some embodiments, Y is nitrogen. Z is a Group 15 element, such as nitrogen or phosphorus. In some embodiments, Z is nitrogen. R¹ and R² are, independently, a C₁ to C₂₀ hydrocarbyl group, a heteroatom containing group having up to twenty carbon atoms, silicon, germanium, tin, lead, or phosphorus. In some embodiments, R¹ and R² are a C₂ to C₂₀ alkyl, aryl or aralkyl group, such as a C₂ to C₂₀ linear, branched or cyclic alkyl group, or a C₂ to C₂₀ hydrocarbyl group. R¹ and R² may also be interconnected to each other. R³ may be absent or may be a hydrocarbyl group, a hydrogen, a halogen, a heteroatom containing group. In some embodiments, R³ is absent, for example, if L is an oxygen, or a hydrogen, or a linear, cyclic, or branched alkyl group having 1 to 20 carbon atoms. R⁴ and R⁵ are independently an alkyl group, an aryl group, substituted aryl group, a cyclic alkyl group, a substituted cyclic alkyl group, a cyclic aralkyl group, a substituted cyclic aralkyl group, or multiple ring system, often having up to 20 carbon atoms. In some embodiments, R⁴ and R⁵ have 3 to 10 carbon atoms, or are a C₁ to C₂₀ hydrocarbon group, a C₁ to C₂₀ aryl group or a C₁ to C₂₀ aralkyl group, or a heteroatom containing group. R⁴ and R⁵ may be interconnected to each other. R⁶ and R⁷ are independently absent, hydrogen, an alkyl group, halogen, heteroatom, or a hydrocarbyl group, such as a linear, cyclic or branched alkyl group having 1 to 20 carbon atoms. In some embodiments, R⁶ and R⁷ are absent. R* may be absent, or may be a hydrogen, a Group 14 atom containing group, a halogen, or a heteroatom containing group.

The term “formal charge of the YZL or YZL′ ligand,” means the charge of the entire ligand absent the metal and the leaving groups X. By “R¹ and R² may also be interconnected” it is meant that R¹ and R² may be directly bound to each other or may be bound to each other through other groups. By “R⁴ and R⁵ may also be interconnected” it is meant that R⁴ and R⁵ may be directly bound to each other or may be bound to each other through other groups. An alkyl group may be linear, branched alkyl radicals, alkenyl radicals, alkynyl radicals, cycloalkyl radicals, aryl radicals, acyl radicals, aroyl radicals, alkoxy radicals, aryloxy radicals, alkylthio radicals, dialkylamino radicals, alkoxycarbonyl radicals, aryloxycarbonyl radicals, carbomoyl radicals, alkyl- or dialkyl- carbamoyl radicals, acyloxy radicals, acylamino radicals, aroylamino radicals, straight, branched or cyclic, alkylene radicals, or combination thereof. An aralkyl group is defined to be a substituted aryl group.

In one or more embodiments, R⁴ and R⁵ formulas (XII) or (XIII) are independently a group represented by structure (XIV):

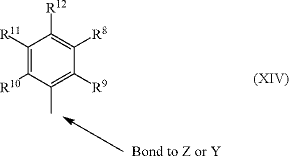

where R⁸ to R¹² are each independently hydrogen, a C₁ to C₄₀ alkyl group, a halide, a heteroatom, a heteroatom containing group containing up to 40 carbon atoms. In some embodiments, R⁸ to R¹² are a C₁ to C₂₀ linear or branched alkyl group, such as a methyl, ethyl, propyl, or butyl group. Two of the R groups may form a cyclic group and/or a heterocyclic group. The cyclic groups may be aromatic. In at least one embodiment R⁹, R¹⁰ and R¹² are independently a methyl, ethyl, propyl, or butyl group (including all isomers). In another embodiment, R⁹, R¹⁰ and R¹² are methyl groups, and R⁸ and R¹¹ are hydrogen.

In one or more embodiments, R⁴ and R⁵ formulas (XII) or (XIII) are both a group represented by structure (XV):

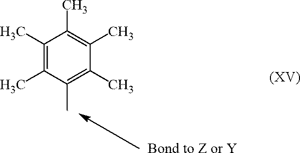

where M is a Group 4 metal, such as zirconium, titanium, or hafnium. In at least one embodiment, M is zirconium. Each of L, Y, and Z may be a nitrogen. Each of R¹ and R² may be —CH₂—CH₂—. R³ may be hydrogen, and R⁶ and R⁷ may be absent.

In one or more embodiments, the catalyst compounds described in PCT/US2018/051345, filed Sep. 17, 2018 may be used with the activators, including the catalyst compounds described at Page 16 to Page 32 of the application as filed.

In some embodiments, a co-activator is combined with the catalyst compound (such as halogenated catalyst compounds described above) to form an alkylated catalyst compound. Organoaluminum compounds which may be utilized as co-activators include, for example, trialkyl aluminum compounds, such as trimethylaluminum, triethylaluminum, triisobutylaluminum, tri-n-hexylaluminum, tri-n-octylaluminum, and the like, or alumoxanes. Multiple Catalysts

In some embodiments, two or more different catalyst compounds are present in the catalyst system. In some embodiments, two or more different catalyst compounds are present in the reaction zone where the polymerization process(es) occur. The two or more different catalyst compounds can be introduced to a reactor (such as reactor (8) of FIG. 1) separately via two or more lines (e.g., catalyst solution line (5) and one or more additional lines (not shown) in fluid communication (e.g., directly coupled) with reactor (8)). The two or more different catalysts can be stored in two or more storage tanks. Alternatively, the two or more catalysts are combined in a single storage tank, diluted with one or more diluents, and introduced together via a line to a reactor (e.g., via catalyst solution line (5)).

When two transition metal compound based catalysts are used in one reactor as a mixed catalyst system, the two transition metal compounds may be chosen such that the two are compatible. A simple screening method such as by ¹H or ¹³C NMR, can be used to determine which transition metal compounds are compatible. It is preferable to use the same activator for the transition metal compounds, however, two different activators can be used in combination. If one or more transition metal compounds contain an anionic ligand as a leaving group which is not a hydride, hydrocarbyl, or substituted hydrocarbyl, then the alumoxane or other alkyl aluminum is typically contacted with the transition metal compounds prior to addition of the non-coordinating anion activator.

The two transition metal compounds (pre-catalysts) may be used in any suitable ratio. Molar ratios of (A) transition metal compound to (B) transition metal compound may (A:B) may be from 1:1000 to 1000:1, from 1:100 to 500:1, from 1:10 to 200:1, from 1:1 to 100:1, from 1:1 to 75:1, or from 5:1 to 50:1. The particular ratio chosen will depend on the exact pre-catalysts chosen, the method of activation, and the end product. In a particular embodiment, when using the two pre-catalysts, where both are activated with the same activator, useful mole percent, based on the molecular weight of the pre-catalysts, are 10 to 99.9 mol% A to 0.1 to 90 mol% B, 25 to 99 mol% A to 0.5 to 50 mol% B, 50 to 99 mol% A to 1 to 25 mol% B, or 75 to 99 mol% A to 1 to 10 mol% B.

### Activators

The activator compounds of the present disclosure may be stored in a storage tank by themselves or dissolved in hydrocarbon diluent(s), such as aliphatic hydrocarbons, at a suitable concentration, an “activator solution.” An activator solution may be measured using measurement techniques for liquids including the use of flowmeters to measure the quantity of activator solution added or removed from a storage tank. Additionally or alternatively, weight scales on the storage tank may be used to determine the quantity of activator solution added to the reactor.

The activators may be diluted (e.g., dissolved) in hydrocarbon diluent at a suitable concentration in a storage tank, a mixing tank, or inline mixer. Dissolution may be accomplished by determination of the flow or weight of activator and adding the appropriate amount of hydrocarbon diluent. Suitable hydrocarbon diluents include aliphatic and aromatic hydrocarbons. While aromatic hydrocarbon are suitable diluents, their use may be reduced or eliminated because the production of polyolefins free of aromatic hydrocarbons increases the value of the polymer and decreases cost of polymer devolatilization. Suitable hydrocarbon diluents include non-coordinating, inert liquids. Examples of diluents may include straight and branched-chain hydrocarbons, such as 2-methyl-pentane, isobutane, butane, n-pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (Isopar®); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable diluents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon diluents are used, such as isobutane, butane, n-pentane, isopentane, hexanes, isohexane, heptane, octane, dodecane, or mixtures thereof; and/or cyclic and alicyclic hydrocarbons, such as cyclohexane, cycloheptane, methylcyclohexane, methylcycloheptane, or mixtures thereof. In another embodiment, the diluent is not aromatic, such as aromatics are present in the diluent at less than 1 wt%, such as less than 0.5 wt%, such as less than 0.1 wt%, such as less than 0.05 wt%, such as less than 0.01 wt%, such as 0 wt%, based on the combined weight of diluents present.

The systems of the present disclosure (such as the plant of FIG. 1) may include a storage tank (not shown) suitable for storage of activator or activator solution. In at least one embodiment, the activator storage tank is fluidly connected to a polymerization reactor (such as reactor (8) via activator solution line (7)). In another embodiment, the activator storage tank is fluidly connected with a pump station (not shown) that is fluidly connected to a polymerization reactor (such as reactor (8) via activator solution line (7)). It may be advantageous to allow for dilution of the activator or activator solution to allow for precise introduction of small quantities of activator to the polymerization reactor. Dilution may occur in a mixing vessel, an inline mixer, a charge vessel, or direct dilution of activator in a storage tank.

In some embodiments, the activator is stored in a vessel at concentrations up to nearly 100 wt% (although the neat form and a highly concentrated solution are very viscous). In some embodiments, the activator is stored in a storage vessel at a concentration of about 10 wt% to about 50 wt%. The activator solution may be diluted to less than 1 wt% during a polymerization process (e.g., in a mixing tank) to increase the volumetric flow rate to a flow that is reasonable for most pumps. If the concentration of the activator solution is too high, the flow rate to the reactor may be too small to meter accurately.

In the present disclosure, activators are described that feature ammonium groups with long-chain aliphatic hydrocarbyl groups for improved solubility of the activator in aliphatic solvents, as compared to conventional activator compounds. Useful borate groups of the present disclosure include fluoroaryl (such as fluoronaphthyl borates and or fluorophenyl borates).

The terms “cocatalyst” and “activator” are used herein interchangeably and are a compound which can activate any one of the catalyst compounds of the present disclosure by converting the neutral catalyst compound to a catalytically active catalyst compound cation. Activators of the present disclosure have one or more non-coordinating anions (NCAs). Non-coordinating anion (NCA) means an anion either that does not coordinate to the catalyst metal cation or that does coordinate to the metal cation, but only weakly. The term NCA is also defined to include multicomponent NCA-containing activators, such as N,N-dimethylanilinium tetrakis(perfluoronaphthyl)borate, that contain an acidic cationic group and the non-coordinating anion. The term NCA is also defined to include neutral Lewis acids, such as tris(pentafluoronaphthyl)boron, that can react with a catalyst to form an activated species by abstraction of an anionic group. An NCA coordinates weakly enough that a neutral Lewis base, such as an olefinically or acetylenically unsaturated monomer can displace it from the catalyst center. Any metal or metalloid that can form a compatible, weakly coordinating complex may be used or contained in the non-coordinating anion. Suitable metals can include aluminum, gold, and platinum. Suitable metalloids can include boron, aluminum, phosphorus, and silicon. The term non-coordinating anion activator includes neutral activators, ionic activators, and Lewis acid activators.

“Compatible” non-coordinating anions can be those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization.

The present disclosure provides activators, such as ammonium or phosphonium metallate or metalloid activator compounds, the activators comprising (1) ammonium or phosphonium groups and long-chain aliphatic hydrocarbyl groups and (2) metallate or metalloid anions, such as borates or aluminates. When an activator of the present disclosure is used with one or more catalyst compounds in an olefin polymerization, a polymer can be formed. In addition, it has been discovered that activators of the present disclosure are soluble in aliphatic solvent.

Regarding solubility, in one or more embodiments, a 10 wt% mixture (such as a 20 wt% mixture) of the activator compound in n-hexane, isohexane, cyclohexane, methylcyclohexane, or a combination thereof, forms a clear homogeneous solution at 25° C., such as a 30 wt% mixture of the compound in n-hexane, isohexane, cyclohexane, methylcyclohexane, or a combination thereof, forms a clear homogeneous solution at 25° C.

In one or more embodiments, a 10 wt% mixture (such as a 20 wt% mixture) of the catalyst system in n-hexane, isohexane, cyclohexane, methylcyclohexane, or a combination thereof, forms a clear homogeneous solution at 25° C., such as a 30 wt% mixture of the compound in n-hexane, isohexane, cyclohexane, methylcyclohexane, or a combination thereof, forms a clear homogeneous solution at 25° C.

In some embodiments, the activators described herein have a solubility of more than 10 mM (or more than 20 mM, or more than 50 mM) at 25° C. (stirred 2 hours) in methylcyclohexane (MeCy).

In some embodiments, the activators described herein have a solubility of more than 1 mM (or more than 10 mM, or more than 20 mM) at 25° C. (stirred 2 hours) in isohexane.

In some embodiments, the activators described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

In some embodiments, the catalyst systems described herein have a solubility of more than 10 mM (or more than 20 mM, or more than 50 mM) at 25° C. (stirred 2 hours) in methylcyclohexane and a solubility of more than 1 mM (or more than 10 mM, or more than 20 mM) at 25° C. (stirred 2 hours) in isohexane.

The catalyst systems used herein preferably contain 0 ppm (alternately less than 1 ppm, alternately less than 1 ppb) of aromatic hydrocarbon. For example, the catalyst systems used herein contain 0 ppm (alternately less than 1 ppm, alternately less than 1 ppb) of toluene.

The present disclosure provides activator compounds represented by Formula (AI):

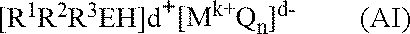

wherein:
E is nitrogen or phosphorous, preferably nitrogen;
each d is the same and is 1, 2 or 3 (such as 3); k is 1, 2, or 3(such as 3); n is 1, 2, 3, 4, 5, or 6 (such as 4, 5, or 6); n - k = d (preferably d is 1, 2 or 3; k is 3; n is 4, 5, or 6, preferably when M is B, n is 4);
each of R¹, R², and R³ is independently H, optionally substituted C₁-C₄₀ alkyl (such as branched or linear alkyl), or optionally substituted C₅-C₅₀-aryl (alternately each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl); wherein R¹, R², and R³ together comprise 15 or more carbon atoms;
M is an element selected from group 13 of the Periodic Table of the Elements, preferably B or Al, preferably B; and
each Q is independently a hydrogen, bridged or unbridged dialkylamido, halide, alkoxide, aryloxide, hydrocarbyl, substituted hydrocarbyl, halocarbyl, substituted halocarbyl, or halosubstituted-hydrocarbyl radical, preferably a fluorinated aryl group, such fluoro-phenyl or fluoro-naphthyl, more preferably perfluorophenyl or perfluoronaphthyl.

In some embodiments of activator compounds represented by Formula (AI), at least one of R¹, R², and R³ is a linear or branched C₃-C₄₀ alkyl group (alternately such as a linear or branched C₇ to C₄₀ alkyl group).

The present disclosure also provides activator compounds represented by Formula (AI), described above where R¹ is a C₁-C₃₀ alkyl group (preferably a C₁-C₁₀ alkyl group, preferably C₁ to C₂ alkyl, preferably methyl), wherein R¹ is optionally substituted, and each of R² and R³ is independently an optionally substituted branched or linear C₁-C₄₀ alkyl group or meta and or para-substituted phenyl group, where the meta and para substituents are, independently, an optionally substituted C₁ to C₄₀ hydrocarbyl group, an optionally substituted alkoxy group, an optionally substituted silyl group, a halogen, or a halogen containing group, wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms) and at least one of R¹, R², and R³ is a linear or branched alkyl (such as a C₃-C₄₀ branched alkyl, alternately C₇-C₄₀ branched alkyl). The present disclosure further provides catalyst systems including activator compounds represented by Formula (AI), as described above where R¹ is methyl; and each of R² and R³ is independently C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; wherein R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms).

The present disclosure also provides catalyst systems having activator compounds represented by Formula (I):

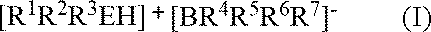

where:
E is nitrogen or phosphorous;
each of R¹, R², and R³ is independently C₁-C₄₀ linear or branched alkyl or C₅-C₅₀-aryl (such as C₅ to C₂₂), where each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; where R¹, R², and R³ together comprise 15 or more carbon atoms (such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms); and
each of R⁴, R⁵, R⁶, and R⁷ is phenyl or naphthyl, wherein at least one of R⁴, R⁵, R⁶, and R⁷ is substituted with from one to seven fluorine atoms.

In some embodiments, at least one of R¹, R², and R³ is a linear or branched C₃-C₄₀ alkyl (such as a linear or branched C₇ to C₄₀ alkyl). The present disclosure further provides catalyst systems including activator compounds represented by Formula (AI) as described above, where each of R¹, R², and R³ is independently C₁-C₄₀ linear or branched alkyl, C₅-C₅₀-aryl (such as C₅ to C₂₂), wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; wherein R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms. In some embodiments, at least one of R¹, R², and R³ is a linear or branched alkyl (such as a linear or branched C₃-C₄₀ alkyl), such as at least two of R¹, R², and R³ are a branched alkyl (such as a C₃-C₄₀ branched alkyl), such as each of R¹, R², and R³ is a branched alkyl (such as a C₁₀-C₄₀ branched alkyl).

In at least one embodiment of formula (AI) or (I) herein, M is an element selected from group 13 of the Periodic Table of the Elements, preferably boron or aluminum, preferably B.

In at least one embodiment of formula (AI) or (I) herein, each Q is independently selected from a hydrogen, bridged or unbridged dialkylamido, halide, alkoxide, aryloxide, hydrocarbyl, substituted hydrocarbyl, halocarbyl, substituted halocarbyl, or halosubstituted-hydrocarbyl radical. Preferably, each Q is a fluorinated hydrocarbyl group having 1 to 30 carbon atoms, more preferably each Q is a fluorinated aryl (such as phenyl or naphthyl) group, and most preferably each Q is a perflourinated aryl (such as phenyl or naphthyl) group.

In at least one embodiment of formula (AI) herein, examples of suitable [M^{k+}Qₙ]^{d-} also include diboron compounds as disclosed in U.S. Pat. No. 5,447,895, which is fully incorporated herein by reference.

In at least one embodiment, the activator is represented by Formula (I):

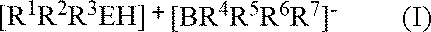

wherein:
E is nitrogen or phosphorous, preferably nitrogen;
each of R¹, R², and R³ is independently C₁-C₄₀ linear or branched alkyl, C₅-C₂₂-aryl, arylalkyl where the alkyl has from 1 to 30 carbon atoms and the aryl has from 6 to 20 carbon atoms, or five-, six- or seven-membered heterocyclyl comprising at least one atom selected from N, P, O and S, wherein each of R¹ R², and R³ is optionally substituted by halogen, wherein R² optionally bonds with R⁵ to independently form a five-, six- or seven-membered ring, preferably wherein, R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms; each of R⁴, R⁵, R⁶, and R⁷ is independently is independently a hydrogen, bridged or unbridged dialkylamido, halide, alkoxide, aryloxide, hydrocarbyl, substituted hydrocarbyl, halocarbyl, substituted halocarbyl, or halosubstituted-hydrocarbyl radical, preferably, each of R⁴, R⁵, R⁶, and R⁷ is independently is a fluorinated hydrocarbyl group having 1 to 30 carbon atoms, more preferably each Q is a fluorinated aryl (such as phenyl or naphthyl) group (substituted with from one to seven fluorine atoms), and most preferably each Q is a perflourinated aryl (such as phenyl or naphthyl) group.

In some embodiments of the activator represented by Formula (I), at least one of R¹, R², and R³ is a branched alkyl (such as a C₇-C₄₀ branched alkyl), alternately at least two of R¹, R², and R³ are a branched alkyl (such as a C₇-C₄₀ branched alkyl), alternately all three of R¹, R², and R³ are a branched alkyl (such as a C₇-C₄₀ branched alkyl).

In at least one embodiment, an activator is an ionic ammonium or phosphonium borate represented by Formula (I):

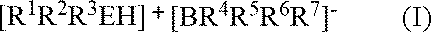

where:
E is nitrogen or phosphorous;
R¹ is a C₁-C₄₀ linear alkyl, preferably methyl;
each of R², and R³ is independently C₁-C₄₀ linear or branched alkyl, C₅-C₂₂-aryl, C₅ to C₅₀ arylalkyl where the alkyl has from 1 to 30 carbon atoms and the aryl has from 6 to 20 carbon atoms, or five-, six- or seven-membered heterocyclyl comprising at least one atom selected from N, P, O and S, wherein each of R¹ R², and R³ is optionally substituted by halogen, wherein R² optionally bonds with R⁵ to independently form a five-, six- or seven-membered ring, preferably wherein, R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms; and
each of R⁴, R⁵, R⁶, and R⁷ is independently each a fluorinated hydrocarbyl group having 1 to 30 carbon atoms, more preferably each of R⁴, R⁵, R⁶, and R⁷ is independently is a fluorinated aryl (such as phenyl or naphthyl) group, and most preferably each of R⁴, R⁵, R⁶, and R⁷ is independently is a perflourinated aryl (such as phenyl or naphthyl) group, wherein at least one of R⁴, R⁵, R⁶, and R⁷ is substituted with from one to seven fluorine atoms.

The present disclosure also provides catalyst systems including activator compounds represented by Formula (I):

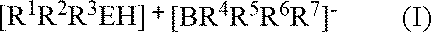

where:
E is nitrogen or phosphorous, preferably nitrogen;
each of R¹, R², and R³ is independently C₁-C₄₀ linear or branched alkyl, C₅-C₅₀-aryl, wherein each of R¹, R², and R³ is independently unsubstituted or substituted with at least one of halide, C₁-C₅₀ alkyl, C₅-C₅₀ aryl, C₆-C₃₅ arylalkyl, or C₆-C₃₅ alkylaryl, wherein R¹, R², and
R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 40 or more carbon atoms, provided that at least one of R¹, R², and R³ is a C₃-C₄₀ branched alkyl, alternately at least two of R¹, R², and R³ are a C₃-C₄₀ branched alkyl; and each of R⁴, R⁵, R⁶, and R⁷ is naphthyl, wherein at least one of R⁴, R⁵, R⁶, and R⁷ is substituted with from one to seven fluorine atoms, preferbly seven fluorine atoms.

In a preferred aspect, the activator is an ionic ammonium borate represented by Formula (I):

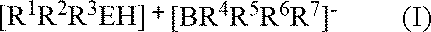

where:
E is nitrogen or phosphorous;
R¹ is a methyl group;
R² is C₆-C₅₀ aryl which is optionally substituted with at least one of halide, C₁-C₃₅ alkyl, C₅-C₁₅ aryl, C₆-C₃₅ arylalkyl, and C₆-C₃₅ alkylaryl;
R³ is C₁-C₄₀ branched alkyl which is optionally substituted with at least one of halide, C₁-C₃₅ alkyl, C₅-C₁₅ aryl, C₆-C₃₅ arylalkyl, and C₆-C₃₅ alkylaryl, wherein R² optionally bonds with R³ to independently form a five-, six- or seven-membered ring, and R² and R³ together comprise 20 or more carbon atoms, such as 21 or more carbon atoms, such as 22 or more carbon atoms, such as 25 or more carbon atoms, such as 30 or more carbon atoms, such as 35 or more carbon atoms, such as 40 or more carbon atoms, and
each of R⁴, R⁵, R⁶, and R⁷ is independently each a fluorinated hydrocarbyl group having 1 to 30 carbon atoms, wherein at least one of R⁴, R⁵, R⁶, and R⁷ is independently substituted with from one, two, three, four, five, six, or seven fluorine atoms, more preferably each of R⁴, R⁵, R⁶, and R⁷ is independently a fluorinated aryl (such as phenyl or naphthyl) group, and most preferably each of R⁴, R⁵, R⁶, and R⁷ is independently is a perflourinated aryl (such as phenyl or naphthyl) group.

Both the cation part of formulas (AI) and (I) as well as the anion part thereof, which is an NCA, will be further illustrated below. Any combinations of cations and NCAs disclosed herein are suitable to be used in the processes of the present disclosure and are thus incorporated herein.

### Activators-The Cations

The cation component of the activators described herein (such as those of formulas (AI) and (I) above), is a protonated Lewis base that can be capable of protonating a moiety, such as an alkyl or aryl, from the transition metal compound. Thus, upon release of a neutral leaving group (e.g. an alkane resulting from the combination of a proton donated from the cationic component of the activator and an alkyl substituent of the transition metal compound) transition metal cation results, which is the catalytically active species.

In at least one embodiment of formula (I) or (AI), where the cation is [R¹R²R³EH]⁺, E is nitrogen or phosphorous, preferably nitrogen; each of R¹, R², and R³ is independently hydrogen, C₁-C₄₀ branched or linear alkyl or C₅-C₅₀-aryl, wherein each of R¹, R², and R³ is independently unsubstituted or substituted with at least one of halide, C₅-C₅₀ aryl, C₆-C₃₅ arylalkyl, C₆-C₃₅ alkylaryl and, in the case of the C₅-C₅₀-aryl, C₁-C₅₀ alkyl; where R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 37 or more carbon atoms, such as 40 or more carbon atoms, such as 45 or more carbon atoms.In some embodiments, at least one (alternately one, two or three) of R¹, R², and R³ is a linear or branched alkyl, (such as a linear or branched C₃-C₄₀ alkyl, alternately such as a linear or branched C₇ to C₄₀ alkyl).

In at least one embodiment of formula (I) or (AI), where the cation is [R¹R²R³EH]⁺, E is nitrogen or phosphorous, and each of R¹, R², and R³ is independently C₁-C₄₀ linear or branched alkyl, C₅-C₅₀-aryl (such as C₅-C₂₂-aryl, preferably an arylalkyl (where the alkyl has from 1 to 10 carbon atoms and the aryl has from 6 to 20 carbon atoms), or five-, six- or seven-membered heterocyclyl comprising at least one atom selected from N, P, O and S, where each of R¹ R², and R³ is optionally substituted by halogen, -NR′₂, -OR′ or -SiR′₃ (where R′ is independently hydrogen or C₁-C₂₀ hydrocarbyl), where R² optionally bonds with R⁵ to independently form a five-, six- or seven-membered ring. R¹, R², and R³ together comprise 15 or more carbon atoms, such as 18 or more carbon atoms, such as 20 or more carbon atoms, such as 22 or more carbon atoms, such as 25 or more carbon atoms, such as 30 or more carbon atoms, such as 35 or more carbon atoms, such as 37 or more carbon atoms, such as 40 or more carbon atoms, such as 45 or more carbon atoms. In some embodiments, at least one of R¹, R², and R³ is a linear or branched C₃-C₄₀ alkyl, alternately at least two of R¹, R², and R³ are a linear or branched C₃-C₄₀ alkyl.

In at least one embodiment of formula (I) or (AI) described herein one, two or three of R¹, R² and R³ may independently be represented by the formula (AIII):

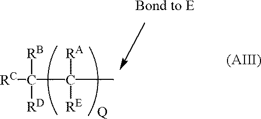

where each of R^{A} and R^{E} are independently H, a C₁-C₄₀ linear or branched alkyl or C₅-C₅₀-aryl, where each of R^{A} and R^{E} is optionally substituted with one or more of halide, C₅-C₅₀ aryl, C₆-C₃₅ arylalkyl, C₆-C₃₅ alkylaryl and, in the case of the C₅-C₅₀-aryl, C₁-C₅₀ alkyl, provided that in at least one (R^{A} -C- R^{E}) group, one or both of R^{A} and R^{E} is not H; and R^{C}, R^{B} and R^{D} are hydrogen; and Q is an integer from 5 to 40.

In at least one embodiment of activator of formula (I) or (AI) herein, one, two or three of R¹, R² and R³ may independently be represented by the formula (IV) where:

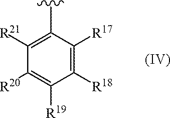

where each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom, such as halogen, a heteroatom-containing group, for example at least one of R¹⁷, R¹⁸, R¹⁹, R²⁰, and R²¹ is not hydrogen.

In at least one embodiment of formula (I) or (AI) one, two or three of R¹, R² and R³ may independently be represented by the formula (AIII) or (IV):

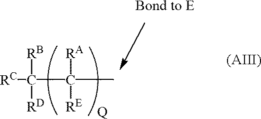

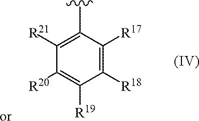

where each of R^{A} and R^{E} are independently selected from H, a C₁-C₄₀ linear or branched alkyl or C₅-C₅₀-aryl, where each of R^{A} and R^{E} is optionally substituted with one or more of halide, C₅-C₅₀ aryl, C₆-C₃₅ arylalkyl, C₆-C₃₅ alkylaryl and, in the case of the C₅-C₅₀-aryl, C₁-C₅₀ alkyl, provided that in at least one (R^{A} -C- R^{E}) group, one or both of R^{A} and R^{E} is not H;
R^{C}, R^{B} and R^{D} are hydrogen; and
Q is an integer from 5 to 40,
each of R¹⁷, R¹⁸, R¹⁹, R²⁰, and R²¹ is independently selected from hydrogen, C₁-C₄₀ hydrocarbyl or C₁-C₄₀ substituted hydrocarbyl, a heteroatom, such as halogen, a heteroatom-containing group, or is represeted by formula (AIII). In some embodiments, at least one of R¹⁷, R¹⁸, R¹⁹, R²⁰, and R²¹ is a linear or branched alkyl, such as one, two, three, four, or five of R¹⁷, R¹⁸, R¹⁹, R²⁰, and R²¹ are represented by formula (AIII)).

In at least one embodiment, the branched alkyl may have 1 to 30 tertiary or quaternary carbons, alternately 2 to 10 tertiary or quaternary carbons, alternately 2 to 4 tertiary or quaternary carbons, alternately the branched alkyl has 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 tertiary or quaternary carbons.

In at least one embodiment of formula (I) or (AI), each of R¹, R² and R³ may independently be selected from:
1) optionally substituted linear alkyls (such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, or n-tricontyl);
2) optionally substituted branched alkyls (such as alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, alkyl-icosyl (including multi-alkyl analogs, i.e, dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), and isomers thereof where each alkyl group is independently a C₁ to C₄₀, (alternately C₂ to C₃₀, alterntely C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl);
3) optionally substituted arylalkyls, such as (methylphenyl, ethylphenyl, propylphenyl, butylphenyl, pentylphenyl, hexylphenyl, heptylphenyl, octylphenyl, nonylphenyl, decylphenyl, undecylphenyl, dodecylphenyl, tridecylphenyl, tetradecylphenyl, pentadecylphenyl, hexadecylphenyl, heptadecylphenyl, octadecylphenyl, nonadecylphenyl, icosylphenyl, henicosylphenyl, docosylphenyl, tricosylphenyl, tetracosylphenyl, pentacosylphenyl, hexacosylphenyl, heptacosylphenyl, octacosylphenyl, nonacosylphenyl, tricontylphenyl, 3,5,5-trimethylhexylphenyl, dioctylphenyl, 3,3,5-trimethylhexylphenyl, 2,2,3,3,4 pentamethypentylylphenyl, and the like);
4) optionally substituted silyl groups, such as a trialkylsilyl group, where each alkyl is independently an optionally substituted C₁ to C₂₀ alkyl (such as trimethylsilyl, triethylsilyl, tripropylsilyl, tributylsilyl, trihexylsilyl, triheptylsilyl, trioctylsilyl, trinonylsilyl, tridecylsilyl, triundecylsilyl, tridodecylsilyl, tri-tridecylsilyl, tri-tetradecylsilyl, tri-pentadecylsilyl, tri-hexadecylsilyl, tri-heptadecylsilyl, tri-octadecylsilyl, tri-nonadecylsilyl, tri-icosylsilyl);
5) optionally substituted alkoxy groups (such as -OR*, where R* is an optionally substituted C₁ to C₂₀ alkyl or aryl (such as methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, phenyl, alkylphenyl (such as methyl phenyl, propyl phenyl, etc.), naphthyl, or anthracenyl);
6) halogens (such as Br or Cl); and
7) halogen containing groups (such as bromomethyl, bromophenyl, and the like).

In at least one embodiment of formula (I) or (AI), R¹ is methyl.

In at least one embodiment of formula (I) or (AI), R² is unsubstituted phenyl or substituted phenyl. In at least one embodiment, R² is phenyl, methyl phenyl, n-butyl phenyl, n-octadecyl-phenyl, or an isomer thereof, preferably R² is meta or para substituted phenyl, such as meta- or para- substituted alkyl substituted phenyl.

In at least one embodiment of formula (I) or (AI), R³ is linear or branched alkyl such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoicosyl, isohenicosyl, isodocosyl, isotricosyl, isotetracosyl, isopentacosyl, isohexacosyl, isoheptacosyl, isooctacosyl, isononacosyl, or isotricontyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, alkyl-icosyl (including multi-alkyl analogs, i.e, dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl), and isomers thereof where each alkyl group is independently a C₁ to C₄₀, (alternately C₂ to C₃₀, alterntely C₃ to C₂₀) linear, branched or cyclic alkyl group, preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl).

In at least one embodiment of formula (I) or (AI), R¹ is methyl, and R² is phenyl, methyl phenyl, n-butyl phenyl, n-octadecyl-phenyl, or an isomer thereof, preferably R² is meta or para substituted phenyl, such as meta- or para- substituted alkyl substituted phenyl, and R³ is linear or branched alkyl.

In at least one embodiment of formula (I) or (AI), R¹ is methyl, and R² is branched alkyl, and R³ is linear or branched alkyl.

In a preferred embodiment, R¹ is methyl, R² is substituted phenyl, R³ is C₁₀ to C₃₀ linear or branched alkyl.

In some embodiments, R² is not meta substituted phenyl. In some embodiments, R² is not ortho substituted phenyl.

In at least one embodiment, R¹ is methyl, R² is C₁ to C₃₅ alkyl substituted phenyl (preferably ortho- or meta- substituted), R³ is C₈ to C₃₀ branched alkyl.

In at least one embodiment, R¹ is C₁ to C₁₀ alkyl, R² is C₁ to C₃₅ alkyl substituted phenyl (preferably para substituted phenyl), R³ is C₈ to C₃₀ linear or branched alkyl.

In at least one embodiment, R¹ is methyl; R² is C₁ to C₃₅ alkyl substituted phenyl, such as methylphenyl, ethylphenyl, n-propylphenyl, n-butylphenyl, n-pentylphenyl, n-hexylphenyl, n-heptylphenyl, n-octylphenyl, n-nonylphenyl, n-decylphenyl, n-undecyl,phenyl n-dodecylphenyl, n-tridecylphenyl, n-butadecylphenyl, n-pentadecylphenyl, n-hexadecylphenyl, n-heptadecylphenyl, n-octadecylphenyl, n-nonadecylphenyl, and n-icosylphenyl, n-henicosylphenyl, n-docosylphenyl, n-tricosylphenyl, n-tetracosylphenyl, n-pentacosylphenyl, n-hexacosylphenyl, n-heptacosylphenyl, n-octacosylphenyl, n-nonacosylphenyl, n-triacontylphenyl; and R³ is C₈ to C₃₀ linear or branched alkyl, such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, i-propyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, and alkyl-icosyl (such as 2-alkyl-pentyl, 2-alkyl-hexyl, 2-alkyl-heptyl, 2-alkyl-octyl, 2-alkyl-nonyl, 2-alkyl-decyl, 2-alkyl-undecyl, 2-alkyl-dodecyl, 2-alkyl-tridecyl, 2-alkyl-butadecyl, 2-alkyl-pentadecyl, 2-alkyl-hexadecyl, 2-alkyl-heptadecyl, 2-alkyl-octadecyl, 2-alkyl-nonadecyl, 2-alkyl-icosyl or a multi-alkyl analogs, i.e, dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), or an isomer thereof where each alkyl group is independently a C₁ to C₄₀, (alternately C₂ to C₃₀, alterntely C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl).

In some embodiments, R² is C₁ to C₃₅ alkyl substituted phenyl, such as methylphenyl, ethylphenyl, n-propylphenyl, n-butylphenyl, n-pentylphenyl, n-hexylphenyl, n-heptylphenyl, n-octylphenyl, n-nonylphenyl, n-decylphenyl, n-undecyl,phenyl n-dodecylphenyl, n-tridecylphenyl, n-butadecylphenyl, n-pentadecylphenyl, n-hexadecylphenyl, n-heptadecylphenyl, n-octadecylphenyl, n-nonadecylphenyl, and n-icosylphenyl, n-henicosylphenyl, n-docosylphenyl, n-tricosylphenyl, n-tetracosylphenyl, n-pentacosylphenyl, n-hexacosylphenyl, n-heptacosylphenyl, n-octacosylphenyl, n-nonacosylphenyl, n-triacontylphenyl; and R³ is C₈ to C₃₀ linear or branched alkyl, such as methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, i-propyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, and alkyl-icosyl (such as 2-alkyl-pentyl, 2-alkyl-hexyl, 2-alkyl-heptyl, 2-alkyl-octyl, 2-alkyl-nonyl, 2-alkyl-decyl, 2-alkyl-undecyl, 2-alkyl-dodecyl, 2-alkyl-tridecyl, 2-alkyl-butadecyl, 2-alkyl-pentadecyl, 2-alkyl-hexadecyl, 2-alkyl-heptadecyl, 2-alkyl-octadecyl, 2-alkyl-nonadecyl, 2-alkyl-icosyl or a multi-alkyl analog, i.e, dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, and trialkyl-icosyl, etc.), or an isomer thereof where each alkyl group is independently a C₁ to C₄₀, (alternately C₂ to C₃₀, alterntely C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl).

In at least one embodiment of formula (I), R¹ is methyl, R² is substituted phenyl, R³ is C₈ to C₃₀ linear or branched alkyl, and R⁴, R⁵, R⁶, R⁷ are perfluoronaphthyl.

In at least one embodiment embodiment of formula (AI), R¹ is methyl, R² is substituted phenyl, R³ is C₈ to C₃₀ linear or branched alkyl, E is nitrogen, and each Q is perfluoronaphthyl.

In a preferred embodiment, R¹ is methyl; R² is C₁ to C₃₅ alkyl substituted phenyl, such as as methylphenyl, ethylphenyl, n-propylphenyl, n-butylphenyl, n-pentylphenyl, n-hexylphenyl, n-heptylphenyl, n-octylphenyl, n-nonylphenyl, n-decylphenyl, n-undecyl,phenyl n-dodecylphenyl, n-tridecylphenyl, n-butadecylphenyl, n-pentadecylphenyl, n-hexadecylphenyl, n-heptadecylphenyl, n-octadecylphenyl, n-nonadecylphenyl, and n-icosylphenyl, n-henicosylphenyl, n-docosylphenyl, n-tricosylphenyl, n-tetracosylphenyl, n-pentacosylphenyl, n-hexacosylphenyl, n-heptacosylphenyl, n-octacosylphenyl, n-nonacosylphenyl, n-triacontylphenyl; R³ is a linear or branched alkyl (such as C₁₀ to C₃₀ branched alkyl) or alternately is methyl, ethyl, n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-icosyl, n-henicosyl, n-docosyl, n-tricosyl, n-tetracosyl, n-pentacosyl, n-hexacosyl, n-heptacosyl, n-octacosyl, n-nonacosyl, n-tricontyl, i-propyl, alkyl-butyl, alkyl-pentyl, alkyl-hexyl, alkyl-heptyl, alkyl-octyl, alkyl-nonyl, alkyl-decyl, alkyl-undecyl, alkyl-dodecyl, alkyl-tridecyl, alkyl-butadecyl, alkyl-pentadecyl, alkyl-hexadecyl, alkyl-heptadecyl, alkyl-octadecyl, alkyl-nonadecyl, and alkyl-icosyl (such as 2-alkyl-pentyl, 2-alkyl-hexyl, 2-alkyl-heptyl, 2-alkyl-octyl, 2-alkyl-nonyl, 2-alkyl-decyl, 2-alkyl-undecyl, 2-alkyl-dodecyl, 2-alkyl-tridecyl, 2-alkyl-butadecyl, 2-alkyl-pentadecyl, 2-alkyl-hexadecyl, 2-alkyl-heptadecyl, 2-alkyl-octadecyl, 2-alkyl-nonadecyl, and 2-alkyl-icosyl or a multi-alkyl analog, i.e, dialkyl-butyl, dialkyl-pentyl, dialkyl-hexyl, dialkyl-heptyl, dialkyl-octyl, dialkyl-nonyl, dialkyl-decyl, dialkyl-undecyl, dialkyl-dodecyl, dialkyl-tridecyl, dialkyl-butadecyl, dialkyl-pentadecyl, dialkyl-hexadecyl, dialkyl-heptadecyl, dialkyl-octadecyl, dialkyl-nonadecyl, dialkyl-icosyl, trialkyl-butyl, trialkyl-pentyl, trialkyl-hexyl, trialkyl-heptyl, trialkyl-octyl, trialkyl-nonyl, trialkyl-decyl, trialkyl-undecyl, trialkyl-dodecyl, trialkyl-tridecyl, trialkyl-butadecyl, trialkyl-pentadecyl, trialkyl-hexadecyl, trialkyl-heptadecyl, trialkyl-octadecyl, trialkyl-nonadecyl, trialkyl-icosyl, etc.), or an isomer thereof where each alkyl group is independently a C₁ to C₄₀, (alternately C₂ to C₃₀, alterntely C₃ to C₂₀) linear, branched or cyclic alkyl group), preferably the alkyl group is methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl); and each of R⁴, R⁵, R⁶, R⁷ are perfluoronaphthyl.

In at least one embodiment herein the branched alkyl can be isopropyl, isobutyl, isopentyl, isohexyl, isoheptyl, isooctyl, isononyl, isodecyl, isoundecyl, isododecyl, isotridecyl, isotetradecyl, isopentadecyl, isohexadecyl, isoheptadecyl, isooctadecyl, isononadecyl, isoicosyl, isohenicosyl, isodocosyl, isotricosyl, isotetracosyl, isopentacosyl, isohexacosyl, isoheptacosyl, isooctacosyl, isononacosyl, or isotricontyl.

In at least one embodiment, R¹ is o-MePh, R² and R³ are iso-octadecyl.

In at least one embodiment, R¹, R² and R³ together comprise 20 or more carbon atoms, such as 21 or more carbon atoms, such as 22 or more carbon atoms, such as 25 or more carbon atoms, such as 30 or more carbon atoms, such as 35 or more carbon atoms, such as 37 or more carbon atoms, such as 40 or more carbon atoms, such as 45 or more carbon atoms.

### Activators-The Anion

The anion component of the activators described herein includes those represented by the formula [M^{k+}Q_{n]} where k is 1, 2, or 3; n is 1, 2, 3, 4, 5, or 6 (preferably 1, 2, 3, or 4); M is an element selected from Group 13 of the Periodic Table of the Elements, preferably boron or aluminum, and Q is independently a hydrogen, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. For example, each Q can be a fluorinated hydrocarbyl group, optionally having 1 to 20 carbon atoms, such as each Q is a fluorinated aryl group, such as each Q is a perfluorinated aryl group. For example, at least one Q is not substituted phenyl, such as perfluorophenyl, such as all Q are not substituted phenyl, such as perfluorophenyl.

Alternately, in at least one embodiment described herein, at least one Q is not substituted phenyl, alternately all Q are not substituted phenyl. Alternately, at least one Q is not fluoro-substituted phenyl, alternately all Q are not fluoro-substituted phenyl. Alternately, at least one Q is not perfluorophenyl, alternately, all Q are not perfluorophenyl.

In at least one embodiment of Formula (AI), when R¹ is methyl, R² is C₁₈ and R³ is C₁₈, then each Q is not perfluorophenyl.

In at least one embodiment, for the borate moiety ([BR⁴R⁵R⁶R⁷]⁻) of the activator represented by formula (I), each of R⁴, R⁵, R⁶, and R⁷ is independently aryl (such as naphthyl), where at least one of R⁴, R⁵, R⁶, and R⁷ is substituted with from one to seven fluorine atoms. In at least one embodiment, each of R⁴, R⁵, R⁶, and R⁷ is naphthyl, where at least one of R⁴, R⁵, R⁶, and R⁷ is substituted with from one to seven fluorine atoms.

In at least one embodiment, each of R⁴, R⁵, R⁶, and R⁷ is independently naphthyl comprising one fluorine atom, two fluorine atoms, three fluorine atoms, four fluorine atoms, five fluorine atoms, six fluorine atoms, or seven fluorine atoms.

In at least one embodiment of formula (I), when R¹ is methyl, R² is C₁₈ and R³ is C₁₈, then each of R⁴, R⁵, R⁶, and R⁷ is not perfluorophenyl.

In at least one embodiment, R⁴ is independently naphthyl comprising one fluorine atom, two fluorine atoms, three fluorine atoms, four fluorine atoms, five fluorine atoms, six fluorine atoms, or seven fluorine atoms, and each of R⁵, R⁶, and R⁷ is independently phenyl comprising one fluorine atom, two fluorine atoms, three fluorine atoms, four fluorine atoms, or five fluorine atoms or naphthyl comprising one fluorine atom, two fluorine atoms, three fluorine atoms, four fluorine atoms, five fluorine atoms, six fluorine atoms, or seven fluorine atoms.

In at least one embodiment of formula (I) or (AI), each of R⁴, R⁵, R⁶, and R⁷ is independently naphthyl, where at least one of R⁴, R⁵, R⁶, and R⁷ is naphthyl substituted with one, two, three, four, five, six or seven fluorine atoms.

In at least one embodiment of formula (I) or (AI), each of R⁴, R⁵, R⁶, and R⁷ is independently phenyl, where at least one of R⁴, R⁵, R⁶, and R⁷ is phenyl substituted with one, two, three, four, or five fluorine atoms.

Alternately, in at least one embodiment of formula (I) or (AI), preferably at least one R⁴, R⁵, R⁶, and R⁷ is not substituted phenyl, preferably all of R⁴, R⁵, R⁶, and R⁷ are not substituted phenyl. In a preferred embodiment, R¹ is not methyl, R² is not C₁₈ and R³ is not C₁₈.

In at least one embodiment of formula (I) or (AI), preferably all Q or all of R⁴, R⁵, R⁶, and R⁷ are not perfluoroaryl, such as perfluorophenyl.

In at least one embodiment of formula (I) or (AI), all of R⁴, R⁵, R⁶, and R⁷ are naphthyl, where at least one, two, three, or four of R⁴, R⁵, R⁶, and R⁷ is/are substituted with one, two, three, four, five, six or seven fluorine atoms.

In at least one embodiment, preferably each of R⁴, R⁵, R⁶, and R⁷ is independently a naphthyl comprising one fluorine atom, two fluorine atoms, three fluorine atoms, four fluorine atoms, five fluorine atoms, six fluorine atoms, or seven fluorine atoms, preferably seven fluorine atoms.

In at least one embodiment, R⁴ is independently naphthyl comprising one fluorine atom, two fluorine atoms, three fluorine atoms, four fluorine atoms, five fluorine atoms, six fluorine atoms, or seven fluorine atoms.

In at least one embodiment, each of R⁴, R⁵, R⁶, and R⁷ is independently each a fluorinated hydrocarbyl group having 1 to 30 carbon atoms, more preferably each of R⁴, R⁵, R⁶, and R⁷ is independently a fluorinated aryl (such as phenyl, biphenyl, [(C₆H₃(C₆H₅)₂)₄B], or naphthyl) group, and most preferably each of R⁴, R⁵, R⁶, and R⁷ is independently is a perflourinated aryl (such as bi-phenyl, [(C₆H₃(C₆H₅)₂)₄B], or naphthyl) group, preferably at least one R⁴, R⁵, R⁶, and R⁷ is not perfluorophenyl.

In at least one embodiment, the borate activator comprises tetrakis(heptafluoronaphth-2-yl)borate.

Anions for use in the non-coordinating anion activators described herein may include those represented by Formula 1 below:

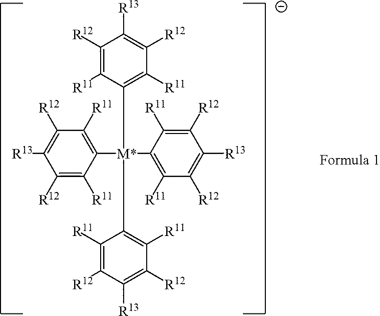

where:
M* is a group 13 atom, preferably B or Al, preferably B;
each R¹¹ is, independently, a halide, preferably a fluoride;
each R¹² is, independently, a halide, a C₆ to C₂₀ substituted aromatic hydrocarbyl group or a siloxy group of the formula -O-Si-R^{a}, where R^{a} is a C₁ to C₂₀ hydrocarbyl or hydrocarbylsilyl group, preferably R¹² is a fluoride or a perfluorinated phenyl group;
each R¹³ is a halide, a C₆ to C₂₀ substituted aromatic hydrocarbyl group or a siloxy group of the formula -O-Si-Rₐ, where R^{a} is a C₁ to C₂₀ hydrocarbyl or hydrocarbylsilyl group, such as R¹³ is a fluoride or a C₆ perfluorinated aromatic hydrocarbyl group;
where an R¹² and R¹³ can form one or more saturated or unsaturated, substituted or unsubstituted rings, preferably an R¹² and R¹³ form a perfluorinated phenyl ring. Preferably the anion has a molecular weight of greater than 700 g/mol, and, preferably, at least three of the substituents on the M* atom each have a molecular volume of greater than 180 cubic Å.

“Molecular volume” is used herein as an approximation of spatial steric bulk of an activator molecule in solution. Comparison of substituents with differing molecular volumes allows the substituent with the smaller molecular volume to be considered “less bulky” in comparison to the substituent with the larger molecular volume. Conversely, a substituent with a larger molecular volume may be considered “more bulky” than a substituent with a smaller molecular volume.

Molecular volume may be calculated as reported in Girolami, G. S. (1994) “A Simple “Back of the Envelope″ Method for Estimating the Densities and Molecular Volumes of Liquids and Solids,” Journal of Chemical Education, v.71(11), November 1994, pp. 962-964. Molecular volume (MV), in units of cubic Å, is calculated using the formula: MV = 8.3Vₛ, where Vₛ is the scaled volume. Vₛ is the sum of the relative volumes of the constituent atoms, and is calculated from the molecular formula of the substituent using Table 2 below of relative volumes. For fused rings, the Vₛ is decreased by 7.5% per fused ring. The Calculated Total MV of the anion is the sum of the MV per substituent, for example, the MV of perfluorophenyl is 183 Å³, and the Calculated Total MV for tetrakis(perfluorophenyl)borate is four times 183 Å³, or 732 Å³.

TABLE 2

| Element | Relative Volume |
|---|---|
| H | 1 |
| 1^{st} short period, Li to F | 2 |
| 2^{nd} short period, Na to Cl | 4 |
| 1^{st} long period, K to Br | 5 |
| 2^{nd} long period, Rb to I | 7.5 |
| 3^{rd} long period, Cs to Bi | 9 |

Exemplary anions useful herein and their respective scaled volumes and molecular volumes are shown in Table 3 below. The dashed bonds indicate bonding to boron.

TABLE 3

| Ion | Structure of Boron Substituents | Molecular Formula of Each Substituent | Vₛ | MV Per subst. (Å³) | Calculated Total MV (Å³) |
|---|---|---|---|---|---|
| tetrakis(perfluorophenyl)borate | 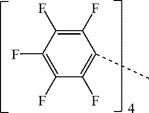 | C₆F₅ | 22 | 183 | 732 |
| tris(perfluorophenyl)-(perfluoronaphthyl)borate | 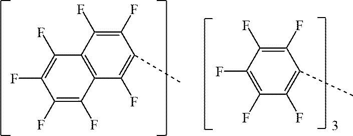 | C₆F₅ C₁₀F₇ | 22 34 | 183 261 | 810 |
| (perfluorophenyl)tris-(perfluoronaphthyl)borate | 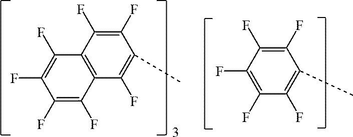 | C₆F₅ C₁₀F₇ | 22 34 | 183 261 | 966 |
| tetrakis(perfluoronaphthyl) borate | 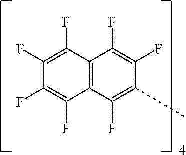 | C₁₀F₇ | 34 | 261 | 1044 |
| tetrakis(perfluorobipheny) borate | 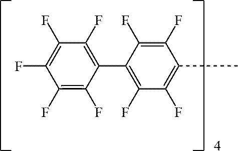 | C₁₂F₉ | 42 | 349 | 1396 |
| [(C₆F₃(C₆F₅)₂)₄B] | 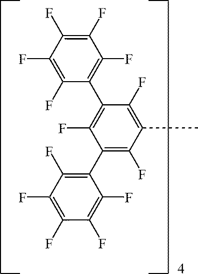 | C₁₈F₁₃ | 62 | 515 | 2060 |

The activators may be added to a polymerization in the form of an ion pair using, for example, [DEBAH]+ [NCA]- in which the 4-butyl-N,N-bis(isotridecyl)benzenaminium-(“DEBAH)”) cation reacts with a basic leaving group on the transition metal complex to form a transition metal complex cation and [NCA]-. Alternatively, the transition metal complex may be reacted with a neutral NCA precursor, such as B(C₁₀F₇)₃, which abstracts an anionic group from the complex to form an activated species.

In at least one embodiment, the activators obtained in their salt form used for a borate activator compound are: Lithium tetrakis(heptafluoronaphthalen-2-yl)borate etherate (Li-BF28), N,N-Dimethylanilinium tetrakis(heptafluoronaphthalen-2-yl)borate (DMAH-BF28), Sodium tetrakis(heptafluoronaphthalen-2-yl)borate (Na-BF28) and N,N-dimethylanilinium tetrakis(heptafluoronaphthalen-2-yl)borate (DMAH-BF28).

In at least one embodiment of the activator represented by formula (AI), when Q is a fluorophenyl group, then R² is not a C₁-C₄₀ linear alkyl group, such as R² is not an optionally substituted C₁-C₄₀ linear alkyl group (alternately when Q is a substituted phenyl group, then R² is not a C₁-C₄₀ linear alkyl group, preferably R² is not an optionally substituted C₁-C₄₀ linear alkyl group). Optionally, when Q is a fluorophenyl group (alternately when Q is a substituted phenyl group), then R² is a meta- and or para-substituted phenyl group, where the meta and para substituents are, independently, an optionally substituted C₁ to C₄₀ hydrocarbyl group (such as a C₆ to C₄₀ aryl group or linear alkyl group, a C₁₂ to C₃₀ aryl group or linear alkyl group, or a C₁₀ to C₂₀ aryl group or linear alkyl group), an optionally substituted alkoxy group, or an optionally substituted silyl group. Optionally, each Q is a fluorinated hydrocarbyl group having 1 to 30 carbon atoms, more preferably each Q is a fluorinated aryl (such as phenyl or naphthyl) group, and most preferably each Q is a perflourinated aryl (such as phenyl or naphthyl) group. Optionally, at least one Q is not substituted phenyl. Optionally all Q are not substituted phenyl. Optionally at least one Q is not perfluorophenyl. Optionally all Q are not perfluorophenyl.

In some embodiments, R¹ is not methyl, R²is not C₁₈ alkyl and R³ is not C₁₈ alkyl, alternately R¹ is not methyl, R² is not C₁₈ alkyl and R³ is not C₁₈ alkyl and at least one Q is not substituted phenyl, optionally all Q are not substituted phenyl.

Useful cation components in formulas (AI) or (I) include those represented by the formula:

| | | | | | |
|---|---|---|---|---|---|
| 1 | 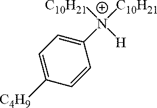 | 2 | 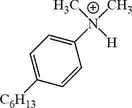 | 3 | 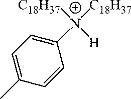 |
| 4 | 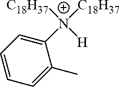 | 5 | 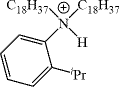 | 6 | 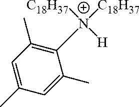 |
| 7 | 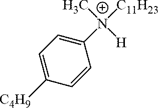 | 8 | 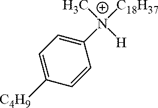 | 9 | 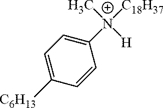 |
| 10 | 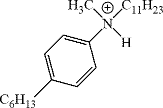 | 11 | 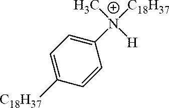 | 12 | 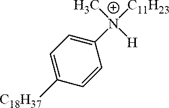 |
| 13 | 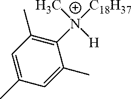 | 14 | 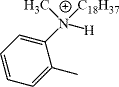 | 15 | 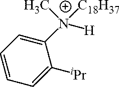 |
| 16 | 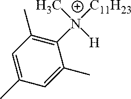 | 17 | 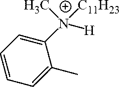 | 18 | 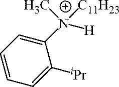 |
| 19 | 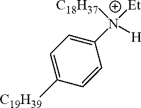 | 20 | 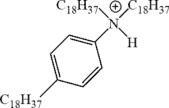 | 21 | 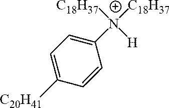 |
| 22 | 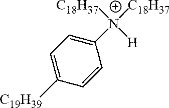 | 23 | 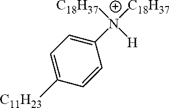 | 24 | 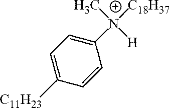 |
| 25 | 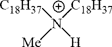 | 26 | 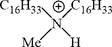 | 27 | 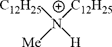 |

Useful cation components in formulas (AI) or (I) include those represented by the formula:

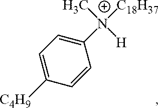

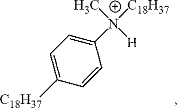

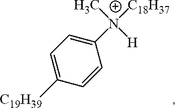

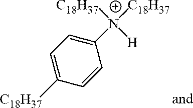

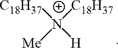

The activators may be added to a polymerization in the form of an ion pair using, for example, [M2HTH]+ [NCA]- in which the di(hydrogenated tallow)methylamine (“M2HTH”) cation reacts with a basic leaving group on the transition metal complex to form a transition metal complex cation and [NCA]-. Alternatively, the transition metal complex may be reacted with a neutral NCA precursor, such as B(C₆F₅)₃, which abstracts an anionic group from the complex to form an activated species. Useful activators include di(hydrogenated tallow)methylammonium[tetrakis(pentafluorophenyl)borate] (i.e., [M2HTH]B(C₆F₅)₄) and di(octadecyl)tolylammonium [tetrakis(pentafluorophenyl)borate] (i.e., [DOdTH]B(C₆F₅)₄).

Activator compounds can include one or more of:
N,N-di(hydrogenated tallow)methylammonium [tetrakis(perfluorophenyl)borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-methyl-4-nonadecyl-N-octadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

Activator compounds can include one or more of:
N,N-di(hydrogenated tallow)methylammonium tetrakis(perfluoronaphthalen-2-yl)borate,
N-methyl-4-nonadecyl-N-octadecylanilinium tetrakis(perfluoronaphthalen-2-yl)borate,
N-methyl-4-hexadecyl-N-octadecylanilinium tetrakis(perfluoronaphthalen-2-yl)borate,
N-methyl-4-tetradecyl-N-octadecylanilinium tetrakis(perfluoronaphthalen-2-yl)borate,
N-methyl-4-dodecyl-N-octadecylanilinium tetrakis(perfluoronaphthalen-2-yl)borate,
N-methyl-4-decyl-N-octadecylanilinium tetrakis(perfluoronaphthalen-2-yl)borate,
N-methyl-4-octyl-N-octadecylanilinium tetrakis(perfluoronaphthalen-2-yl)borate,
N-methyl-4-hexyl-N-octadecylanilinium tetrakis(perfluoronaphthalen-2-yl)borate,
N-methyl-4-butyl-N-octadecylanilinium tetrakis(perfluoronaphthalen-2-yl)borate,
N-methyl-4-octadecyl-N-decylanilinium tetrakis(perfluoronaphthalen-2-yl)borate,
N-methyl-4-nonadecyl-N-dodecylanilinium tetrakis(perfluoronaphthalen-2-yl)borate,
N-methyl-4-nonadecyl-N-tetradecylanilinium tetrakis(perfluoronaphthalen-2-yl)borate,
N-methyl-4-nonadecyl-N-hexadecylanilinium tetrakis(perfluoronaphthalen-2-yl)borate,
N-methyl-4-nonadecyl-N-octadecylanilinium tetrakis(perfluoronaphthalen-2-yl)borate,
N-ethyl-4-nonadecyl-N-octadecylanilinium tetrakis(perfluoronaphthalen-2-yl)borate,
N-methyl-N,N-dioctadecylammonium tetrakis(perfluoronaphthalen-2-yl)borate,
N-methyl-N,N-dihexadecylammonium tetrakis(perfluoronaphthalen-2-yl)borate,
N-methyl-N,N-ditetradecylammonium tetrakis(perfluoronaphthalen-2-yl)borate,
N-methyl-N,N-didodecylammonium tetrakis(perfluoronaphthalen-2-yl)borate,
N-methyl-N,N-didecylammonium tetrakis(perfluoronaphthalen-2-yl)borate,
N-methyl-N,N-dioctylammonium tetrakis(perfluoronaphthalen-2-yl)borate,
N-ethyl-N,N-dioctadecylammonium tetrakis(perfluoronaphthalen-2-yl)borate,
N,N-di(octadecyl)tolylammonium tetrakis(perfluoronaphthalen-2-yl)borate,
N,N-di(hexadecyl)tolylammonium tetrakis(perfluoronaphthalen-2-yl)borate,
N,N-di(tetradecyl)tolylammonium tetrakis(perfluoronaphthalen-2-yl)borate,
N,N-di(dodecyl)tolylammonium tetrakis(perfluoronaphthalen-2-yl)borate,
N-octadecyl-N-hexadecyl-tolylammonium tetrakis(perfluoronaphthalen-2-yl)borate,
N-octadecyl-N-hexadecyl-tolylammonium tetrakis(perfluoronaphthalen-2-yl)borate,
N-octadecyl-N-tetradecyl-tolylammonium tetrakis(perfluoronaphthalen-2-yl)borate,
N-octadecyl-N-dodecyl-tolylammonium tetrakis(perfluoronaphthalen-2-yl)borate,
N-octadecyl-N-decyl-tolylammonium tetrakis(perfluoronaphthalen-2-yl)borate,
N-hexadecyl-N-tetradecyl-tolylammonium tetrakis(perfluoronaphthalen-2-yl)borate,
N-hexadecyl-N-dodecyl-tolylammonium tetrakis(perfluoronaphthalen-2-yl)borate,
N-hexadecyl-N-decyl-tolylammonium tetrakis(perfluoronaphthalen-2-yl)borate,
N-tetradecyl-N-dodecyl-tolylammonium tetrakis(perfluoronaphthalen-2-yl)borate,
N-tetradecyl-N-decyl-tolylammonium tetrakis(perfluoronaphthalen-2-yl)borate,
N-dodecyl-N-decyl-tolylammonium tetrakis(perfluoronaphthalen-2-yl)borate,
N-methyl-N-octadecylanilinium tetrakis(perfluoronaphthalen-2-yl)borate,
N-methyl-N-hexadecylanilinium tetrakis(perfluoronaphthalen-2-yl)borate,
N-methyl-N-tetradecylanilinium tetrakis(perfluoronaphthalen-2-yl)borate,
N-methyl-N-dodecylanilinium tetrakis(perfluoronaphthalen-2-yl)borate,
N-methyl-N-decylanilinium tetrakis(perfluoronaphthalen-2-yl)borate, and
N-methyl-N-octylanilinium tetrakis(perfluoronaphthalen-2-yl)borate.

Additional useful activators and the synthesis thereof, are described in USSN 16/394,166 filed Apr. 25, 2019, USSN 16/394,186, filed Apr. 25, 2019, and USSN 16/394,197, filed Apr. 25, 2019, which are incorporated by reference herein.

In at least one embodiment, the activator is not:

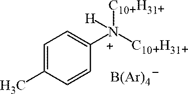

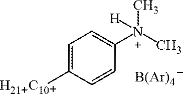

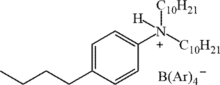

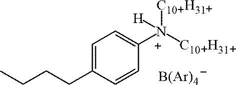

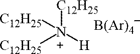

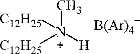

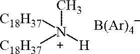

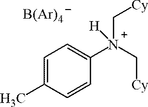

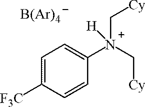

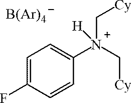

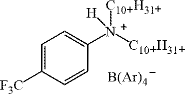

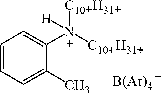

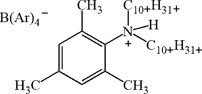

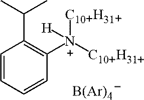

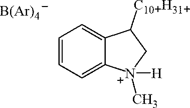

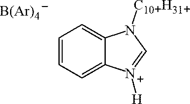

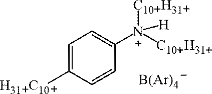

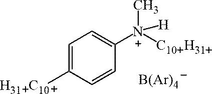

The typical activator-to-catalyst ratio, e.g., all NCA activators-to-catalyst ratio is about a 1:1 molar ratio. Alternate ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 5:1.

It is also within the scope of the present disclosure that the catalyst compounds can be combined with combinations of alumoxanes and the activators described herein.

### Synthesis of Activators

In at least one embodiment, the general synthesis of the activators can be performed using a two-step process. In the first step, an amine or phosphine is dissolved in a solvent (e.g. hexane, cyclohexane, methylcyclohexane, ether, dichloromethane, toluene) and an excess (e.g., 1.2 molar equivalents) of hydrogen chloride is added to form an ammonium or phosphonium chloride salt. This salt is typically isolated by filtration from the reaction medium and dried under reduced pressure. The isolated ammonium or phosphonium chloride is then heated to reflux with about one molar equivalent of an alkali metal metallate or metalloid (such as a borate or aluminate) in a solvent (e.g. cyclohexane, dichloromethane, methylcyclohexane) to form the desired borate or aluminate along with byproduct alkali metal chloride, the latter of which can typically be removed by filtration.

In at least one embodiment, the general synthesis of the ammonium borate activators can be performed using a two-step process. In the first step, an amine is dissolved in a solvent (e.g. hexane, cyclohexane, methylcyclohexane, ether, dichloromethane, toluene) and an excess (e.g., 1.2 molar equivalents) of hydrogen chloride is added to form an ammonium chloride salt. This salt is typically isolated by filtration from the reaction medium and dried under reduced pressure. The isolated ammonium chloride is then heated to reflux with about one molar equivalent of an alkali metal borate in a solvent (e.g. cyclohexane, dichloromethane, methylcyclohexane) to form the ammonium borate along with byproduct alkali metal chloride, the latter of which can typically be removed by filtration.

In at least one embodiment, an activator of the present disclosure is soluble in an aliphatic solvent at a concentration of about 10 mM or greater, such as about 20 mM or greater, such as about 30 mM or greater, such as about 50 mM or greater, such as about 75 mM or greater, such as about 100 mM or greater, such as about 200 mM or greater, such as about 300 mM or greater. In at least one embodiment, an activator of the present disclosure dissolves in isohexane or methylcyclohexane at 25° C. to form a homogeneous solution of at least 10 mM concentration.

In at least one embodiment, the solubility of the borate or aluminate activators of the present disclosure in aliphatic hydrocarbon solvents increases with the number of aliphatic carbons in the cation group (i.e., the ammonium or the phosphonium). In at least one embodiment, a solubility of at least 10 mM is achieved with an activator having an ammonium or phosphonium group of about 21 aliphatic carbon atoms or more, such as about 25 aliphatic carbons atoms or more, such as about 35 carbon atoms or more.

In at least one embodiment, the solubility of the ammonium borate activators of the present disclosure in aliphatic hydrocarbon solvents increases with the number of aliphatic carbons in the ammonium group. In at least one embodiment, a solubility of at least 10 mM is achieved with an activator having an ammonium group of about 21 aliphatic carbon atoms or more, such as about 25 aliphatic carbons atoms or more, such as about 35 carbon atoms or more.

Useful aliphatic hydrocarbon solvent can be isobutane, butane, n-pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In at least one embodiment, aromatics are present in the solvent at less than 1 wt%, such as less than 0.5 wt%, such as at 0 wt% based on the weight of the solvents. The activators of the present disclosure can be dissolved in one or more additional solvents. Additional solvent includes ethereal, halogenated and N,N-dimethylformamide solvents.

In at least one embodiment, the aliphatic solvent is isohexane and or methylcyclohexane.

### Multiple Activators

In some embodiments, two or more different activators are present in the catalyst system. In some embodiments, two or more different activators are present in the reaction zone where the polymerization process(es) occur. The two or more different activators can be introduced to a reactor (such as reactor (8) of FIG. 1) separately via two or more lines (e.g., activator solution line (7) and one or more additional lines (not shown) in fluid communication (e.g., directly coupled) with reactor (8)). The two or more different activators can be stored in two or more storage tanks. Alternatively, the two or more activators are combined in a single storage tank, diluted with one or more diluents, and introduced together via a line to a reactor (e.g., via activator solution line (7)).

When two activators are used in one reactor as a mixed activator system, the two activators may be chosen such that the two are compatible. The two activators may be used in any suitable ratio. Molar ratios of (A) activator to (B) activator may (A:B) may be from 1:1000 to 1000:1, from 1:100 to 500:1, from 1:10 to 200:1, from 1:1 to 100:1, from 1:1 to 75:1, or from 5:1 to 50:1. The particular ratio chosen will depend on the exact activators chosen, the method of activation, and the end product. In a particular embodiment, when using the two activators, useful mole percent, based on the molecular weight of the activators, are 10 to 99.9 mol% A to 0.1 to 90 mol% B, 25 to 99 mol% A to 0.5 to 50 mol% B, 50 to 99 mol% A to 1 to 25 mol% B, or 75 to 99 mol% A to 1 to 10 mol% B.

### Optional Scavengers or Co-Activators

In addition to these activator compounds, scavengers or co-activators may be used. Aluminum alkyl or organoaluminum compounds which may be utilized as scavengers or co-activators include, for example, trimethylaluminum, triethylaluminum, triisobutylaluminum, tri-n-hexylaluminum, tri-n-octylaluminum, and diethyl zinc.

In at least one embodiment, little or no scavenger is used in the process to produce the ethylene polymer. Scavenger (such as trialkyl aluminum) can be present at zero mol%, alternately the scavenger is present at a molar ratio of scavenger metal to transition metal of less than 100:1, such as less than 50:1, such as less than 15:1, such as less than 10:1.

### Polymers

Any suitable polymer can be produced using methods of the present disclosure. For example, a polymer can be a propylene-based polymer or ethylene-based polymer (such as an elastomer).

The polymers produced herein can contain 0 ppm (alternately less than 1 ppm, alternately less than 1 ppb) of aromatic hydrocarbon. For example, the polymers produced herein contain 0 ppm (alternately less than 1 ppm, alternately less than 1 ppb) of toluene.

### Elastomers

As described above, the processes described herein may be used to form elastomers, such as terpolymers comprising ethylene, an α-olefin and a diene, also referred to as EODE (Ethylene-alpha-Olefin-Diene Elastomer). For example, an EODE can have a high Mw and greater than 0.3 weight% diene content, such as greater than 2.0 weight% diene content. These polymers may be largely amorphous and have a low or zero heat of fusion. As used herein the term “EODE” encompasses elastomeric polymers having ethylene, an alphα-olefin, and one or more non-conjugated diene monomers. The non-conjugated diene monomer can be a straight chain, branched chain or cyclic hydrocarbon diene having from 6 to 15 carbon atoms. Examples of suitable non-conjugated dienes are straight chain acyclic dienes such as 1,4-hexadiene and 1,6-octadiene; branched chain acyclic dienes such as 5-methyl-1,4 -hexadiene; 3,7-dimethyl-1,6-octadiene; 3,7 -dimethyl-1,7 -octadiene and mixed isomers of dihydromyricene and dihydroocinene; single ring alicyclic dienes such as 1,4-cyclohexadiene; and 1,5-cyclododecadiene; and multi-ring alicyclic fused and bridged ring dienes such as tetrahydroindene, methyl tetrahydroindene, dicyclopentadiene; 5-ethylidene-bicyclo(2,2,1)hept-2-ene alkenyl, alkylidene, cycloalkylidene norbornenes such as 5-methylene-2-norbornene (MNB); 5-propenyl-2-norbornene, 5-isopropylidene-2-norbornene, 5-(4-cyclopentenyl)-2-norbornene, 5-cyclohexylidene-2-norbornene, 5-vinyl-2-norbornene and norbornadiene.

In at least one embodiment, the polymer being produced in the polymer production process is an ethylene-propylene rubber. For example, the polymer is an ethylene-propylene-diene rubber (EPDM). In a preferred embodiment, the plasticized polymer is an ethylene-propylene-diene rubber containing 10-100 phr of a plasticizer. As used herein, “phr” refers to parts per hundred of plasticizer ratioed to the neat polymer. In at least one embodiment, the ethylene-propylene-diene rubber contains about 15 to about 100 phr (about 13 to about 50 wt%) of a plasticizer, such as a plasticizer a Group I or Group II paraffinic oil (e.g., Sunpar 150, Chevron Paramount 6001).

Of the dienes typically used to prepare EPDMs, some example dienes are, 1,4-hexadiene (HD), 5-ethylidene-2-norbornene (Ethylidene Norbornene, ENB), 5-vinylidene-2-norbornene (VNB), 5-methylene-2-norbornene (MNB), and dicyclopentadiene (DCPD). In at least one embodiment, a diene is 5-ethylidene-2-norbornene (ENB) and/or 1,4-hexadiene (HD). Example EODEs may contain about 20 to about 90 weight% ethylene, such as about 30 to about 85 weight% ethylene, such as about 35 to about 80 weight% ethylene. An α-olefin suitable for use in the preparation of elastomers with ethylene and dienes may be propylene, 1-butene, 1-pentene, 1-hexene, 1-octene and 1-dodecene. The α-olefin is generally incorporated into the EODE polymer at about 10 to about 80 wt%, or about 20 to about 65 wt%. The non-conjugated dienes are generally incorporated into the EODE at about 0.5 to about 35 wt%, such as about 20 to about 35 wt%; or about 1 to about 15 wt%, or about 2 to about 12 wt%. If desired, more than one diene may be incorporated simultaneously, for example HD and ENB, with total diene incorporation within the limits specified above.

### Propylene-Based Polymers

As described above, the processes described herein may be used to form propylene-based polymers, such as one or more propylene-based elastomers (“PBEs”). The PBE comprises propylene and from about 5 to about 30 wt% of one or more alphα-olefin derived units, preferably ethylene and/or C₄-C₁₂ α-olefins. For example, the α-olefin derived units, or comonomer, may be ethylene, butene, pentene, hexene, 4-methyl-1-pentene, octene, or decene. In some embodiments, the comonomer is ethylene. In some embodiments, the PBE consists essentially of propylene and ethylene, or consists only of propylene and ethylene. Some of the embodiments described below are discussed with reference to ethylene as the comonomer, but the embodiments are equally applicable to PBEs with other α-olefin comonomers. In this regard, the copolymers may simply be referred to as propylene-based elastomers with reference to ethylene as the α-olefin.

The PBE may include at least about 5 wt%, at least about 6 wt%, at least about 7 wt%, at least about 8 wt%, at least about 9 wt%, at least about 10 wt%, at least about 12 wt %, or at least about 15 wt%, α-olefin-derived units, where the percentage by weight is based on the total weight of the propylene-derived and α-olefin-derived units. The PBE may include up to about 30 wt%, up to about 25 wt%, up to about 22 wt%, up to about 20 wt%, up to about 19 wt%, up to about 18 wt%, or up to about 17 wt%, α-olefin-derived units, where the percentage by weight is based on the total weight of the propylene-derived and α-olefin-derived units. In some embodiments, the PBE may comprise from about 5 wt% to about 30 wt%, from about 6 wt% to about 25 wt%, from about 7 wt% to about 20 wt%, from about 10 wt% to about 19 wt%, from about 12 wt% to about 18 wt%, or from about 15 wt% to about 17 wt %, α-olefin-derived units, where the percentage by weight is based on the total weight of the propylene-derived and α-olefin-derived units.

The PBE may include at least about 70 wt%, at least about 75 wt%, at least about 78 wt%, at least about 80 wt%, at least about 81 wt%, at least about 82 wt%, or at least about 83 wt%, propylene-derived units, where the percentage by weight is based on the total weight of the propylene-derived and α-olefin derived units. The PBE may include up to about 95 wt %, up to about 94 wt%, up to about 93 wt%, up to about 92 wt%, up to about 91 wt%, up to about 90 wt%, up to about 88 wt%, or up to about 85 wt%, propylene-derived units, where the percentage by weight is based on the total weight of the propylene-derived and α-olefin derived units.

The PBEs may be characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak. The Tm of the PBE (as determined by DSC) may be less than about 120° C., less than about 115° C., less than about 110° C., or less than about 105° C.

The PBE may be characterized by its heat of fusion (Hf), as determined by DSC. The PBE may have an Hf that is at least about 0.5 J/g, at least about 1.0 J/g, at least about 1.5 J/g, at least about 3.0 J/g, at least about 4.0 J/g, at least about 5.0 J/g, at least about 6.0 J/g, or at least about 7.0 J/g. The PBE may be characterized by an Hf of less than about 75 J/g, or less than about 70 J/g, or less than about 60 J/g, or less than about 50 J/g.

As used within this specification, DSC procedures for determining Tm and Hf are as follows. The polymer is pressed at a temperature of from about 200° C. to about 230° C. in a heated press, and the resulting polymer sheet is hung, under ambient conditions, in the air to cool. About 6 to 10 mg of the polymer sheet is removed with a punch die. This 6 to 10 mg sample is annealed at room temperature for about 80 to 100 hours. At the end of this period, the sample is placed in a DSC (Perkin Elmer Pyris One Thermal Analysis System) and cooled to about -30° C. to about -50° C. and held for 10 minutes at that temperature. The sample is then heated at 10° C./min to attain a final temperature of about 200° C. The sample is kept at 200° C. for 5 minutes. Then a second cool-heat cycle is performed, where the sample is again cooled to about -30° C. to about -50° C. and held for 10 minutes at that temperature, and then re-heated at 10° C./min to a final temperature of about 200° C. Events from both cycles are recorded. The thermal output is recorded as the area under the melting peak of the sample, which typically occurs from about 0° C. to about 200° C. It is measured in Joules and is a measure of the Hf of the polymer.

The PBE can have a triad tacticity of three propylene units (mmm tacticity), as measured by ¹³C NMR, of 75 or greater, 80 or greater, 85% or greater, 90% or greater, 92% or greater, 95% or greater, or 97% or greater. For example, the triad tacticity may range from about 75 to about 99%, from about 80 to about 99%, from about 85 to about 99%, from about 90 to about 99%, from about 90 to about 97%, or from about 80 to about 97%. Triad tacticity is determined as described in U.S. Pat. Application Publication No. 2004/0236042.

The PBE may have a tacticity index m/r ranging from a lower limit of 4 or 6 to an upper limit of 8 or 10 or 12. The tacticity index, expressed herein as “m/r”, is determined by ¹³C nuclear magnetic resonance (“NMR”). The tacticity index, m/r, is calculated as defined by H. N. Cheng in Vol. 17, MACROMOLECULES, pp. 1950-1955 (1984), incorporated herein by reference. The designation “m” or “r” describes the stereochemistry of pairs of contiguous propylene groups, “m” referring to meso, and “r” to racemic. An m/r ratio of 1.0 generally describes a syndiotactic polymer, and an m/r ratio of 2.0 describes an atactic material.

The PBE may have a percent crystallinity of from about 0.5% to about 40%, from about 1% to about 30%, or from about 5% to about 25%, determined according to DSC. Crystallinity may be determined by dividing the Hf of a sample by the Hf of a 100% crystalline polymer, which is assumed to be 189 J/g for isotactic polypropylene.

The PBE may have a density of from about 0.84 g/cm³ to about 0.92 g/cm³, from about 0.85 g/cm³ to about 0.90 g/cm³, or from about 0.85 g/cm³ to about 0.87 g/cm³ at room temperature, as measured per the ASTM D-1505 test method.

The PBE can have a melt index (MI) (ASTM D-1238, 2.16 kg @ 190° C.), of less than or equal to about 100 g/10 min, less than or equal to about 50 g/10 min, less than or equal to about 25 g/10 min, less than or equal to about 10 g/10 min, less than or equal to about 8 g/10 min, less than or equal to about 5 g/10 min, or less than or equal to about 3 g/10 min.

The PBE may have a melt flow rate (MFR), as measured according to ASTM D-1238 (2.16 kg weight @230° C.), greater than about 0.5 g/10 min, greater than about 1 g/ 10 min, greater than about 1.5 g/10 min, greater than about 2 g/10 min, or greater than about 2.5 g/10 min. The PBE may have an MFR less than about 100 g/10 min, less than about 50 g/10 min, less than about 25 g/10 min, less than about 15 g/10 min, less than about 10 g/10 min, less than about 7 g/10 min, or less than about 5 g/10 min. In some embodiments, the PBE may have an MFR from about 0.5 to about 10 g/10 min, from about 1 to about 7 g/10 min, or from about 1.5 to about 5 g/10 min.

The PBE may have a g′ index value of 0.95 or greater, or at least 0.97, or at least 0.99, wherein g′ is measured at the Mw of the polymer using the intrinsic viscosity of isotactic polypropylene as the baseline. For use herein, the g′ index is defined as:

$${\text{g}}^{′} = η \text{b} η \text{l}$$

where ηb is the intrinsic viscosity of the polymer and η1 is the intrinsic viscosity of a linear polymer of the same viscosity-averaged molecular weight (Mv) as the polymer. η1=KMvα, K and α are measured values for linear polymers and should be obtained on the same instrument as the one used for the g′ index measurement.

The PBE may have a weight average molecular weight (Mw), as measured by DRI, of from about 50,000 to about 1,000,000 g/mol, or from about 75,000 to about 500,000 g/mol, from about 100,000 to about 350,000 g/mol, from about 125,000 to about 300,000 g/mol, from about 150,000 to about 275,000 g/mol, or from about 200,000 to about 250,000 g/mol.

The PBE may have a number average molecular weight (Mn), as measured by DRI, of from about 5,000 to about 500,000 g/mol, from about 10,000 to about 300,000 g/mol, from about 50,000 to about 250,000 g/mol, from about 75,000 to about 200,000 g/mol, or from about 100,000 to about 150,000 g/mol.

The PBE may have a z-average molecular weight (Mz), as measured by MALLS, of from about 50,000 to about 1,000,000 g/mol, or from about 75,000 to about 500,000 g/mol, or from about 100,000 to about 400,000 g/mol, from about 200,000 to about 375,000 g/mol, or from about 250,000 to about 350,000 g/mol.

The molecular weight distribution (MWD, equal to Mw/Mn) of the PBE may be from about 0.5 to about 20, from about 0.75 to about 10, from about 1.0 to about 5, from about 1.5 to about 4, or from about 1.8 to about 3.

Optionally, the PBE may also include one or more dienes. The term “diene” is defined as a hydrocarbon compound that has two unsaturation sites, i.e., a compound having two double bonds connecting carbon atoms. Depending on the context, the term “diene” as used herein refers broadly to either a diene monomer prior to polymerization, e.g., forming part of the polymerization medium, or a diene monomer after polymerization has begun (also referred to as a diene monomer unit or a diene-derived unit). In some embodiments, the diene may be selected from 5-ethylidene- 2-norbornene (ENB); 1,4-hexadiene; 5-methylene-2-norbornene (MNB); 1,6-octadiene; 5-methyl- 1,4-hexadiene; 3,7-dimethyl-1,6-octadiene; 1,3-cyclopentadiene; 1,4-cyclohexadiene; vinyl norbornene (VNB); dicyclopentadiene (DCPD), and combinations thereof. In embodiments where the propylene-based elastomer composition comprises a diene, the diene may be present at from 0.05 wt% to about 6 wt%, from about 0.1 wt% to about 5.0 wt%, from about 0.25 wt% to about 3.0 wt%, from about 0.5 wt% to about 1.5 wt%, diene-derived units, where the percentage by weight is based on the total weight of the propylene-derived, α-olefin derived, and diene-derived units.

Optionally, the PBE may be grafted (i.e., “functionalized”) using one or more grafting monomers. As used herein, the term “grafting” denotes covalent bonding of the grafting monomer to a polymer chain of the PBE. The grafting monomer can be or include at least one ethylenically unsaturated carboxylic acid or acid derivative, such as an acid anhydride, ester, salt, amide, imide, or acrylates. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2)octene- 2,3-dicarboxylic acid anhydride, 1,2,3,4,5,8,9,10-octahydronaphthalene-2,3-dicarboxylic acid anhydride, 2-oxa-1,3-diketospiro(4.4)nonene, bicyclo(2.2.1)heptene-2,3-dicarboxylic acid anhydride, maleopimaric acid, tetrahydrophthalic anhydride, norbornene-2,3 -dicarboxylic acid anhydride, nadic anhydride, methyl nadic anhydride, himic anhydride, methyl himic anhydride, and 5-methylbicyclo(2.2.1)heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. In at least one embodiment, a grafting monomer includes maleic anhydride. In embodiments wherein the graft monomer is maleic anhydride, the maleic anhydride concentration in the grafted polymer can be from about 1 to about 6 wt%, at least about 0.5 wt%, or at least about 1.5 wt%.

In some embodiments, the PBE is a reactor blended polymer. That is, the PBE is a reactor blend of a first polymer component (“R1”) made in a first solution polymerization reactor and a second polymer component made in a second solution polymerization reactor, where the solution polymerization reactors are in a parallel configuration as described with reference to FIG. 1. Thus, the comonomer content of the propylene-based elastomer can be adjusted by adjusting the comonomer content of the first polymer component, adjusting the comonomer content of second polymer component, and/or adjusting the ratio of the first polymer component to the second polymer component present in the PBE.

In embodiments where the PBE is a reactor blended polymer, the α-olefin content of the first polymer component may be greater than 5 wt% α-olefin, greater than 7 wt% α-olefin, greater than 10 wt% α-olefin, greater than 12 wt% α-olefin, greater than 15 wt% α-olefin, or greater than 17 wt% α-olefin, where the percentage by weight is based on the total weight of the propylene-derived and α-olefin-derived units of the first polymer component. The α-olefin content of the first polymer component may be less than 30 wt% α-olefin, less than 27 wt% α-olefin, less than 25 wt% α-olefin, less than 22 wt% α-olefin, less than 20 wt% α-olefin, or less than 19 wt% α-olefin, where the percentage by weight is based on the total weight of the propylene-derived and α-olefin-derived units of the first polymer component. In some embodiments, the α-olefin content of the first polymer component is from about 5 wt% to about 30 wt% α-olefin, from about 7 wt% to about 27 wt% α-olefin, from about 10 wt% to about 25 wt% α-olefin, from about 12 wt% to about 22 wt% α-olefin, from about 15 wt% to about 20 wt% α-olefin, or from about 17 wt% to about 19 wt% α-olefin. Preferably, the first polymer component comprises propylene and ethylene, and in some embodiments the first polymer component consists only of propylene and ethylene derived units.

In embodiments where the PBE is a reactor blended polymer, the α-olefin content of the second polymer component (“R2”) may be greater than 1.0 wt% α-olefin, greater than 1.5 wt% α-olefin, greater than 2.0 wt% α-olefin, greater than 2.5 wt% α-olefin, greater than 2.75 wt% α-olefin, or greater than 3.0 wt% α-olefin, where the percentage by weight is based on the total weight of the propylene-derived and α-olefin-derived units of the second polymer component. The α-olefin content of the second polymer component may be less than 10 wt% α-olefin, less than 9 wt% α-olefin, less than 8 wt% α-olefin, less than 7 wt% α-olefin, less than 6 wt% α-olefin, or less than 5 wt% α-olefin, where the percentage by weight is based on the total weight of the propylene-derived and α-olefin-derived units of the second polymer component. In some embodiments, the α-olefin content of the second polymer component may be from about 1 wt% to about 10 wt% α-olefin, or from about 1.5 wt% to about 9 wt% α-olefin, or from about 2 wt% to about 8 wt% α-olefin, or from about 2.5 wt% to about 7 wt% α-olefin, or from about 2.75 wt% to about 6 wt% α-olefin, or from about 3 wt% to about 5 wt% α-olefin. In some embodiments, the second polymer component comprises propylene and ethylene, and in some embodiments the second polymer component consists only of propylene and ethylene derived units.

In embodiments where the PBE is a reactor blended polymer, the PBE may have about 1 to about 25 wt% of the second polymer component, from about 3 to about 20 wt% of the second polymer component, from about 5 to about 18 wt% of the second polymer component, from about 7 to about 15 wt% of the second polymer component, or from about 8 to about 12 wt% of the second polymer component, based on the weight of the propylene-based elastomer. The PBE may have about 75 to about 99 wt% of the first polymer component, about 80 to about 97 wt% of the first polymer component, about 85 to about 93 wt% of the first polymer component, or about 82 to about 92 wt% of the first polymer component, based on the weight of the propylene-based elastomer.

Commercial examples of polymers formed by processes of the present disclosure can include Vistamaxx® copolymers from ExxonMobil Chemical Company, Tafmer® elastomers from Mitsui Chemicals, and Versify® elastomers from Dow Chemical Company.

For example, Vistamaxx® is a propylene-based elastomer that extends the performance and processability of films, compounds, nonwovens and molded/extruded products. The free flowing pellets of Vistamaxx® are easy to incorporate and the broad compatibility allows dry blending operations. Vistamaxx® offers a range of applications such as, for example, 1) nonwovens (elasticity, softness and toughness; delivered with drop-in processing performance); 2) films (elasticity, sealability, toughness and tack); 3) polymer modification and compounds (impact strength, transparency, flexibility/stiffness, softness, high filler loading). Vistamaxx® copolymers are copolymers of propylene and ethylene. Vistamaxx® are propylene rich (>80%) and are semi-crystalline materials with high amorphous content. Their synthesis is based on ExxonMobil Chemical’s Exxpol® technology.

3980 propylene-ethylene performance polymer (“VM3980”) is available from ExxonMobil Chemical Company. VM3980 has an ethylene content of 9 wt% with the balance being propylene. Properties of VM3980 include: a density of 0.879 g/cm³ (ASTM D1505); a melt index of 3.6 g/10 min (ASTM D1238; 190° C., 2.16 kg); a melt mass flow rate of 8 g/10 min (230° C., 2.16 kg); a Shore D hardness of 34 (ASTM D2240); and a Vicat softening temperature (VST) of 77.3° C.

Vistamaxx® 6502 (VM6502) is a polymer having isotactic propylene repeat units with random ethylene distribution; the polymer having a density of 0.865 g/cm³; melt mass flow rate of 45.2 g/10 min (230° C., 2.16 kg); and an ethylene content of 13.1 wt%.

Vistamaxx® 3000 propylene-ethylene performance polymer (“VM3000”) is available from ExxonMobil Chemical Company. VM3000 has an ethylene content of 11 wt% with the balance being propylene. Properties of VM3000 include: a density of 0.873 g/cm³ (ASTM D1505); a melt index of 3.7 g/10 min (ASTM D1238; 190° C., 2.16 kg); a melt mass flow rate of 8 g/10 min (230° C., 2.16 kg); a Shore D hardness of 27 (ASTM D2240); and a Vicat softening temperature (VST) of 65.1° C.

Vistamaxx® 3588 propylene-ethylene performance polymer (“VM3588”) is available from ExxonMobil Chemical Company. VM3588 has an ethylene content of 4 wt% with the balance being propylene. Properties of VM3588 include: a density of 0.889 g/cm³ (ASTM D1505); a melt mass flow rate of 8 g/10 min (230° C., 2.16 kg); a Shore D hardness of 50 (ASTM D2240); and a Vicat softening temperature (VST) of 103° C.

Vistamaxx® 6202 (“VM6202”) is a propylene-ethylene copolymer having a density of 0.863 g/cm³, melt index (at 190° C., 2.16 kg) of 9.1 g/10 min, MFR of 20 g/10 min, and ethylene content of 15 wt%.

Vistamaxx® 6102 (“VM6102”) is a propylene-ethylene copolymer having a density of 0.862 g/cm³, melt index (at 190° C., 2.16 kg) of 1.4 g/10 min, MFR of 3 g/10 min, and ethylene content of 16 wt%.

Vistamaxx® 3020 (“VM3020”) is a propylene-ethylene copolymer having a density of 0.874 g/cm³, melt index (at 190° C., 2.16 kg) of 1.1 g/10 min, MFR of 3 g/10 min, and ethylene content of 11 wt%.

### ADDITIONAL ASPECTS

The present disclosure provides, among others, the following aspects, each of which may be considered as optionally including any alternate aspects.

Clause 1. A process comprising:
introducing a catalyst solution, via a first line, into a reactor, the catalyst solution comprising a catalyst and a first non-aromatic diluent;
introducing an activator solution, via a second line, into the reactor, the activator solution comprising an activator and a second non-aromatic diluent, wherein the second non-aromatic diluent is the same as or different than the first non-aromatic diluent;
operating the reactor under process conditions; and
obtaining an effluent from the reactor, the effluent comprising a polyolefin,
wherein the first line and the second line are coupled with the reactor.

Clause 2. The process of Clause 1, wherein the catalyst solution is free of the activator.

Clause 3. The process of Clauses 1 or 2, wherein the activator solution is free of the catalyst.

Clause 4. The process of any of Clauses 1 to 3, wherein the catalyst solution consists of the catalyst and the non-aromatic diluent.

Clause 5. The process of any of Clauses 1 to 4, wherein the activator solution consists of the activator and the non-aromatic diluent.

Clause 6. The process of any of Clauses 1 to 5, wherein the first non-aromatic diluent is selected from the group consisting of 2-methyl-pentane, isobutane, butane, n-pentane, isopentane, hexanes, isohexane, heptane, octane, dodecane, and mixture(s) thereof.

Clause 7. The process of any of Clauses 1 to 6, wherein the first non-aromatic diluent is 2-methyl-pentane.

Clause 8. The process of any of Clauses 1 to 7, wherein the second non-aromatic diluent is selected from the group consisting of 2-methyl-pentane, isobutane, butane, n-pentane, isopentane, hexanes, isohexane, heptane, octane, dodecane, and mixture(s) thereof.

Clause 9. The process of any of Clauses 1 to 8, wherein the second non-aromatic diluent is 2-methyl-pentane.

Clause 10. The process of any of Clauses 1 to 9, wherein the first non-aromatic diluent has about 1 wt% or less aromatics, based on the weight of first non-aromatic diluent + aromatics.

Clause 11. The process of any of Clauses 1 to 10, wherein the first non-aromatic diluent has 0 wt% aromatics, based on the weight of first non-aromatic diluent + aromatics.

Clause 12. The process of any of Clauses 1 to 11, wherein the second non-aromatic diluent has about 1 wt% or less aromatics, based on the weight of second non-aromatic diluent + aromatics.

Clause 13. The process of any of Clauses 1 to 12, wherein the second non-aromatic diluent has 0 wt% aromatics, based on the weight of second non-aromatic diluent + aromatics.

Clause 14. The process of any of Clauses 1 to 13, wherein the activator solution comprises the activator in an amount of about 0.01 wt% to about 20 wt%, based on the weight of the activator solution.

Clause 15. The process of any of Clauses 1 to 14, wherein the activator solution comprises the activator in an amount of about 0.15 wt% to about 0.3 wt%, based on the weight of the activator solution.

Clause 16. The process of any of Clauses 1 to 15, wherein introducing the activator solution to the reactor is performed at a feed rate of about 0.01 kg/hr to about 40 kg/hr, alternatively about 0.02 L/hr to about 60 L/hr.

Clause 17. The process of any of Clauses 1 to 16, wherein the catalyst solution comprises the catalyst in an amount of about 0.01 wt% to about 20 wt%, based on the weight of the catalyst solution.

Clause 18. The process of any of Clauses 1 to 17, wherein the catalyst solution comprises the catalyst in an amount of about 0.05 wt% to about 0.1 wt%, based on the weight of the catalyst solution.

Clause 19. The process of any of Clauses 1 to 18, wherein introducing the catalyst solution to the reactor is performed at a feed rate of about 0.003 kg/hr to about 40 kg/hr, alternatively about 0.004 L/hr to about 60 L/hr.

Clause 20. The process of any of Clauses 1 to 19, wherein the process conditions comprise a temperature delta of about 0° C. to about 20° C. during a substantial entirety of the process.

Clause 21. The process of any of Clauses 1 to 20, wherein the temperature delta is about 1° C. to about 3° C. during a substantial entirety of the process.

Clause 22. The process of any of Clauses 1 to 22, wherein the effluent has an aromatic content of about 1 wt% or less, based on the weight of the effluent.

Clause 23. The process of any of Clauses 1 to 22, wherein the polyolefin has an aromatic content of about 1 wt% or less, based on the weight of the polyolefin.

Clause 24. The process of any of Clauses 1 to 23, wherein the polyolefin has an aromatic content of 0 wt%, based on the weight of the polyolefin.

Clause 25. The process of any of Clauses 1 to 24, wherein:
the process conditions comprise a temperature of about 130° C. to about 200° C. and a pressure of about 100 bar to about 130 bar, and
the polyolefin is a plastomer.

Clause 26. The process of any of Clauses 1 to 25, wherein:
the process conditions comprise a temperature of about 85° C. to bout 150° C. and a pressure of about 100 bar to about 130 bar, and
the polyolefin is an elastomer.

Clause 27. The process of any of Clauses 1 to 26, wherein:
the process conditions comprise a temperature of about 50° C. to about 80° C. and a pressure of about 100 bar to about 130 bar, and
the polyolefin is a propylene-based polymer.

Clause 28. The process of any of Clauses 1 to 27, wherein the catalyst is represented by the formula:

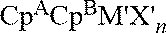

wherein each Cp^{A} and Cp^{B} is independently selected from cyclopentadienyl ligands or ligands isolobal to cyclopentadienyl, one or both Cp^{A} and Cp^{B} optionally contain heteroatoms, and one or both Cp^{A} and Cp^{B} are optionally substituted by one or more R″ groups; M′ is selected from Groups 3 through 12 atoms and lanthanide Group atoms; X′ is an anionic leaving group; n is 0 or an integer from 1 to 4; each R″ is independently selected from alkyl, heteroalkyl, alkenyl, heteroalkenyl, alkynyl, heteroalkynyl, alkoxy, aryloxy, alkylthio, arylthio, aryl, heteroaryl, aralkyl, aralkylene, alkaryl, alkarylene, haloalkyl, haloalkenyl, haloalkynyl, heteroalkyl, heterocyclyl, silyl, boryl, phosphino, phosphine, amino, ether, and thioether.

Clause 29. The process of any of Clauses 1 to 28, wherein the catalyst is represented by the formula:

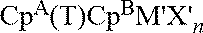

wherein each Cp^{A} and Cp^{B} is independently selected from cyclopentadienyl ligands or ligands isolobal to cyclopentadienyl, one or both Cp^{A} and Cp^{B} optionally contain heteroatoms, and one or both Cp^{A} and Cp^{B} are optionally substituted by one or more R″ groups; M′ is selected from Groups 3 through 12 atoms and lanthanide Group atoms; X′ is an anionic leaving group; n is 0 or an integer from 1 to 4; (T) is a bridging group selected from divalent alkyl, divalent heteroalkyl, divalent alkenyl, divalent heteroalkenyl, divalent alkynyl, divalent heteroalkynyl, divalent alkoxy, divalent aryloxy, divalent alkylthio, divalent arylthio, divalent aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocyclyl, divalent silyl, divalent boryl, divalent phosphino, divalent phosphine, divalent amino, divalent ether, divalent thioether; and R″ is selected from alkyl, heteroalkyl, alkenyl, heteroalkenyl, alkynyl, heteroalkynyl, alkoxy, aryloxy, alkylthio, arylthio, aryl, heteroaryl, aralkyl, aralkylene, alkaryl, alkarylene, haloalkyl, haloalkenyl, haloalkynyl, heteroalkyl, heterocyclyl, silyl, boryl, phosphino, phosphine, amino, germanium, ether, and thioether.

Clause 30. The process of any of Clauses 1 to 29, wherein the catalyst is selected from the group consisting of:
bis(cyclopentadienyl)zirconium dichloride,
bis(n-butylcyclopentadienyl)zirconium dichloride,
bis(n-butylcyclopentadienyl)zirconium dimethyl,
bis(pentamethylcyclopentadienyl)zirconium dichloride,
bis(pentamethylcyclopentadienyl)zirconium dimethyl,
bis(pentamethylcyclopentadienyl)hafnium dichloride,
bis(pentamethylcyclopentadienyl)zirconium dimethyl,
bis(1-methyl-3-n-butylcyclopentadienyl)zirconium dichloride,
bis(1-methyl-3-n-butylcyclopentadienyl)zirconium dimethyl,
bis(1-methyl-3-n-butylcyclopentadienyl)hafnium dichloride,
bis(1-methyl-3-n-butylcyclopentadienyl)zirconium dimethyl,
bis(indenyl)zirconium dichloride,
bis(indenyl)zirconium dimethyl,
bis(tetrahydro-1-indenyl)zirconium dichloride,
bis(tetrahydro-1-indenyl)zirconium dimethyl,
(n-propyl cyclopentadienyl, pentamethyl cyclopentadienyl)zirconium dichloride, and
(n-propyl cyclopentadienyl, pentamethyl cyclopentadienyl)zirconium dimethyl.

Clause 31. The process of any of Clauses 1 to 30, wherein the catalyst is selected from the group consisting of:
dimethylsilylbis(tetrahydroindenyl)MXₙ,
dimethylsilylbis(2-methylindenyl)MXₙ,
dimethylsilylbis(2-methylfluorenyl)MXₙ,
dimethylsilylbis(2-methyl-5,7-propylindenyl)MXₙ,
dimethylsilylbis(2-methyl-4-phenylindenyl)MXₙ,
dimethylsilylbis(2-ethyl-5-phenylindenyl)MXₙ,
dimethylsilylbis(2-methyl-4-biphenylindenyl)MXₙ,
dimethylsilylenebis(2-methyl-4-carbazolylindenyl)MXₙ,
rac-dimethylsilyl-bis-(5,6,7,8-tetrahydro-5,5,8,8-tetramethyl-2-methyl-1H-benz(f)indene)MXₙ,
diphenylmethylene (cyclopentadienyl)(fluorenyl)MXₙ,
bis(methylcyclopentadienyl)MXₙ,
rac-dimethylsilylbis(2-methyl,3-propyl indenyl)MXₙ,
dimethylsilylbis(indenyl)MXₙ,
Rac-meso-diphenylsilyl-bis(n-propylcyclopentadienyl)MXₙ,
1,1′-bis(4-triethylsilylphenyl)methylene-(cyclopentadienyl)(3,8-di-tertiary-butyl-1-fluorenyl)MXₙ (bridge is considered the 1 position),
bis-trimethylsilylphenyl-methylene(cyclopentadienyl)(di-t-butylfluorenyl)MXn,
bis-trimethylsilylphenyl-methylene(cyclopentadienyl)(fluorenyl)MXn,
bisphenylmethylene(cyclopentadienyl)(dimethylfluorenyl)MXn,
bis(n-propylcyclopentadienyl)MXₙ,
bis(n-butylcyclopentadienyl)MXₙ,
bis(n-pentylcyclopentadienyl)MXₙ,
(n-propyl cyclopentadienyl)(n-butylcyclopentadienyl)MXₙ,
bis[(2-trimethylsilylethyl)cyclopentadienyl]MXₙ,
bis(trimethylsilyl cyclopentadienyl)MXₙ,
dimethylsilylbis(n-propylcyclopentadienyl)MXₙ,
dimethylsilylbis(n-butylcyclopentadienyl)MXₙ,
bis(1-n-propyl-2-methylcyclopentadienyl)MXₙ,
(n-propylcyclopentadienyl)(1-n-propyl-3-n-butylcyclopentadienyl)MXₙ,
bis(1-methyl, 3-n-butyl cyclopentadienyl)MXₙ,
bis(indenyl)MXₙ,
dimethylsilyl (tetramethylcyclopentadienyl)(cyclododecylamido)MXₙ,
dimethylsilyl (tetramethylcyclopentadienyl)(t-butylamido)MXₙ,
µ-(CH₃)₂Si(cyclopentadienyl)(l-adamantylamido)MXₙ,
µ-(CH₃)₂Si(3-tertbutylcyclopentadienyl)(1-adamantylamido)MXₙ,
µ-(CH₃)₂(tetramethylcyclopentadienyl)(1-adamantylamido)MXₙ,
µ-(CH₃)₂Si(tetramethylcyclopentadienyl)(1-adamantylamido)MXₙ,
µ-(CH₃)₂C(tetramethylcyclopentadienyl)(1-adamantylamido)MXₙ,
µ-(CH₃)₂Si(tetramethylcyclopentadienyl)(1-tertbutylamido)MXₙ,
µ-(CH₃)₂Si(fluOrenyl)(1-tertbutylamido)MXₙ,
µ-(CH₃)₂Si(tetramethylcyclopentadienyl)(1-cyclododecylamido)MXₙ,
µ-(C₆H₅)₂C(tetramethylcyclopentadienyl)(1-cyclododecylamido)MXₙ, and
p-(CH₃)₂Si(_{η}⁵-2,6,6-trimethyl-1,5,6,7-tetrahydro-s-indacen-1-yl)(tertbutylamido)MXₙ,
wherein:
M is Ti, Zr, or Hf;
each X is independently selected from the group consisting of halogen, hydride, C₁₋₁₂ alkyl, C₂₋₁₂ alkenyl, C₆₋₁₂ aryl, C₇₋₂₀ alkylaryl, C₁₋₁₂ alkoxy, C₆₋₁₆ aryloxy, C₇₋₁₈ alkylaryloxy, C₁₋₁₂ fluoroalkyl, and C₆₋₁₂ fluoroaryl, and
n is zero or an integer from 1 to 4.

Clause 32. The process of claim 1, wherien the catalyst is selected from the group consisting of:
bis(1-methyl, 3-n-butyl cyclopentadienyl) M(R)₂;
dimethylsilyl bis(indenyl)M(R)₂;
bis(indenyl)M(R)₂;
dimethylsilyl bis(tetrahydroindenyl)M(R)₂;
bis(n-propylcyclopentadienyl)M(R)₂;
dimethylsilyl (tetramethylcyclopentadienyl)(cyclododecylamido)M(R)₂;
dimethylsilyl (tetramethylcyclopentadienyl)(cyclododecylamido)M(R)₂;
dimethylsilyl (tetramethylcyclopentadienyl)(t-butylamido)M(R)₂;
dimethylsilyl (tetramethylcyclopentadienyl)(t-butylamido)M(R)₂;
µ-(CH₃)₂Si(cyclopentadienyl)(1-adamantylamido)M(R)₂;
µ-(CH₃)₂Si(3-tertbutylcyclopentadienyl)(1-adamantylamido)M(R)₂;
µ-(CH₃)₂(tetramethylcyclopentadienyl)(1-adamantylamido)M(R)₂;
µ-(CH₃)₂Si(tetramethylcyclopentadienyl)(1-adamantylamido)M(R)₂;
µ-(CH₃)₂C(tetramethylcyclopentadienyl)(1-adamantylamido)M(R)₂;
µ-(CH₃)₂Si(tetramethylcyclopentadienyl)(1-tertbutylamido)M(R)₂;
µ-(CH₃)₂Si(fluorenyl)(1-tertbutylamido)M(R)₂;
µ-(CH₃)₂Si(tetramethylcyclopentadienyl)(1-cyclododecylamido)M(R)₂;
µ-(C₆H₅)₂C(tetramethylcyclopentadienyl)(1-cyclododecylamido)M(R)₂; and
µ-(CH₃)₂Si(η⁵-2,6,6-trimethyl-1,5,6,7-tetrahydro-s-indacen-1-yl)(tertbutylamido)M(R)₂;
wherein:
M is Ti, Zr, or Hf; and
R is selected from the group consisting of halogen and C₁ to C₅ alkyl.

Clause 33. The process of any of Clauses 1 to 32, wherein the catalyst is selected from the group consisting of:
dimethylsilyl (tetramethylcyclopentadienyl)(cyclododecylamido)titanium dimethyl;
dimethylsilyl (tetramethylcyclopentadienyl)(cyclododecylamido)titanium dimethyl;
dimethylsilyl (tetramethylcyclopentadienyl)(t-butylamido)titanium dimethyl;
dimethylsilyl (tetramethylcyclopentadienyl)(t-butylamido)titanium dimethyl;
µ-(CH₃)₂Si(cyclopentadienyl)(1-adamantylamido)titanium dimethyl;
µ-(CH₃)₂Si(3-tertbutylcyclopentadienyl)(1-adamantylamido)titanium dimethyl;
µ-(CH₃)₂(tetramethylcyclopentadienyl)(1-adamantylamido)titanium dimethyl;
µ-(CH₃)₂Si(tetramethylcyclopentadienyl)(1-adamantylamido)titanium dimethyl;
µ-(CH₃)₂C(tetramethylcyclopentadienyl)(1-adamantylamido)titanium dimethyl;
µ-(CH₃)₂Si(tetramethylcyclopentadienyl)(1-tertbutylamido)titanium dimethyl;
µ-(CH₃)₂Si(fluoenyl)(1-tertbutylamido)titanium dimethyl;
µ-(CH₃)₂Si(tetramethylcyclopentadienyl)(1-cyclododecylamido)titanium dimethyl;
µ-(C₆H₅)₂C(tetramethylcyclopentadienyl)(1-cyclododecylamido)titanium dimethyl; and
µ-(CH₃)₂Si(η⁵-2,6,6-trimethyl-1,5,6,7-tetrahydro-s-indacen-1-yl)(tertbutylamido)titanium dimethyl.

Clause 34. The process of any of Clauses 1 to 33, wherein the catalyst is selected from the group consisting of:
bis(1-methyl, 3-n-butyl cyclopentadienyl)hafnium dimethyl,
bis(1-methyl, 3-n-butyl cyclopentadienyl)zirconium dimethyl,
dimethylsilyl bis(indenyl)zirconium dimethyl,
dimethylsilyl bis(indenyl)hafnium dimethyl,
bis(indenyl)zirconium dimethyl,
bis(indenyl)hafnium dimethyl,
dimethylsilyl bis(tetrahydroindenyl)zirconium dimethyl,
bis(n-propylcyclopentadienyl)zirconium dimethyl,
dimethylsilylbis(tetrahydroindenyl)hafnium dimethyl,
dimethylsilyl bis(2-methylindenyl)zirconium dimethyl,
dimethylsilyl bis(2-methylfluorenyl)zirconium dimethyl,
dimethylsilyl bis(2-methylindenyl)hafnium dimethyl,
dimethylsilyl bis(2-methylfluorenyl)hafnium dimethyl,
dimethylsilyl bis(2-methyl-5,7-propylindenyl) zirconium dimethyl,
dimethylsilyl bis(2-methyl-4-phenylindenyl) zirconium dimethyl,
dimethylsilyl bis(2-ethyl-5-phenylindenyl) zirconium dimethyl,
dimethylsilyl bis(2-methyl-4-biphenylindenyl) zirconium dimethyl,
dimethylsilylenebis(2-methyl-4-carbazolylindenyl) zirconium dimethyl,
rac-dimethylsilyl-bis-(5,6,7,8-tetrahydro-5,5,8,8-tetramethyl-2-methyl-1H-benz(f)indene)hafnium dimethyl,
diphenylmethylene (cyclopentadienyl)(fluorenyl)hafnium dimethyl,
bis(methylcyclopentadienyl)zirconium dimethyl,
rac-dimethylsilylbis(2-methyl,3-propyl indenyl)hafnium dimethyl,
dimethylsilylbis(indenyl)hafnium dimethyl,
dimethylsilylbis(indenyl)zirconium dimethyl,
dimethyl rac-dimethylsilyl-bis-(5,6,7,8-tetrahydro-5,5,8,8-tetramethyl-2-methyl-1H-benz(f)indene)hafnium dimethyl,
Rac-meso-diphenylsilyl-bis(n-propylcyclopentadienyl)hafnium dimethyl,
1,1′-bis(4-triethylsilylphenyl)methylene-(cyclopentadienyl)(3,8-di-tertiary-butyl-1-fluorenyl)hafnium Xₙ (bridge is considered the 1 position),
bis-trimethylsilylphenyl-methylene(cyclopentadienyl)(di-t-butylfluorenyl)hafnium dimethyl,
bis-trimethylsilylphenyl-methylene(cyclopentadienyl)(fluorenyl)hafnium dimethyl,
bisphenylmethylene(cyclopentadienyl)(dimethylfluorenyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl, bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl,
bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl, and
dimethylsilyl(3-n-propylcyclopentadienyl)(tetramethylcyclopentadienyl)zirconium dimethyl.

Clause 35. The process of any of Clauses 1 to 34, wherein the catalyst is selected from the group consisting of:
dimethylsilyl bis(indenyl)zirconium dimethyl, and
dimethylsilyl bis(indenyl)hafnium dimethyl.

Clause 36. The process of any of Clauses 1 to 35, wherein the activator is represented by Formula (AI):

$${\left[{\text{R}}^{1} {\text{R}}^{2} {\text{R}}^{3} \text{EH}\right]}_{\text{d}} {}^{+} {\left[{\text{M}}^{\text{k+}} {\text{Q}}_{\text{n}}\right]}^{\text{d-}} \qquad \text{(AI)}$$

wherein:
E is nitrogen or phosphorous;
each d is the same and is 1, 2 or 3;
k is 1, 2, or 3;
n is 1, 2, 3, 4, 5, or 6;
n - k = d;
each of R¹, R², and R³ is independently selected from the group consisting of H, C₁-C₄₀ alkyl, and C₅-C₅₀-aryl; wherein R¹, R², and R³ together comprise 15 or more carbon atoms;
M is an element selected from group 13 of the Periodic Table of the Elements; and
each Q is independently selected from the group consisting of hydrogen, bridged or unbridged dialkylamido, halide, alkoxide, aryloxide, hydrocarbyl, halocarbyl.

Clause 37. The process of any of Clauses 1 to 36, wherein:
E is nitrogen,
M is boron, and
n is 4.

Clause 38. The process of any of Clauses 1 to 37, wherein each Q is a fluorinated aryl group.

Clause 39. The process of any of Clauses 1 to 38, wherein each Q is perfluoronaphthyl.

Clause 40. The process of any of Clauses 1 to 39, wherein R¹ of Formula (AI) is a C₁-C₃₀ alkyl group, and each of R² and R³ of Formula (AI) is independently branched or linear C₁-C₄₀ alkyl group or meta and or para-substituted phenyl group, wherein the meta or para substituents are, independently, a C₁ to C₄₀ hydrocarbyl group, an alkoxy group, a silyl group, a halogen, or a halogen containing group.

Clause 41. The process of any of Clauses 1 to 40, wherein R¹, R², and R³ together comprise 35 or more carbon atoms.

Clause 42. The process of any of Clauses 1 to 41, wherein:
R¹ is selected from the group consisting of methyl, ethyl, propyl, butyl, and pentyl, and
each of R² and R³ is independently C₁-C₄₀ branched or linear alkyl or C₅-C₅₀-aryl.

Clause 43. The process of any of Clauses 1 to 42, wherein [R¹R²R³EH] of Formula (AI) is selected from the group consisting of:

| | | | | | |
|---|---|---|---|---|---|
| 1 | 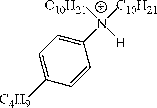 | 2 | 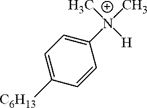 | 3 | 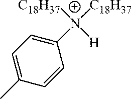 |
| 4 | 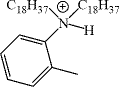 | 5 | 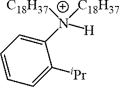 | 6 | 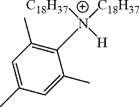 |
| 7 | 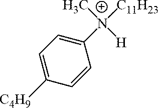 | 8 | 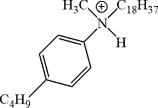 | 9 | 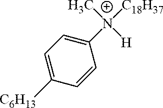 |
| 10 | 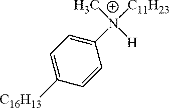 | 11 | 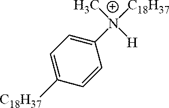 | 12 | 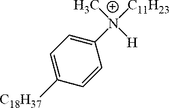 |
| 13 | 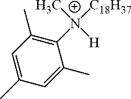 | 14 | 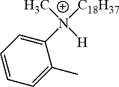 | 15 | 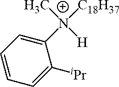 |
| 16 | 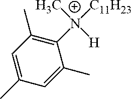 | 17 | 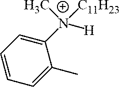 | 18 | 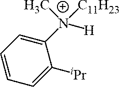 |
| 19 | 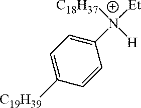 | 20 | 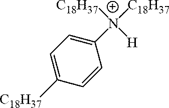 | 21 | 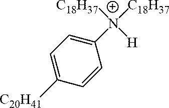 |
| 22 | 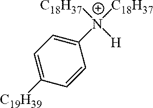 | 23 | 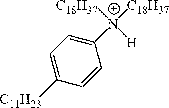 | 24 | 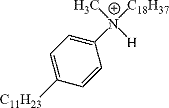 |
| 25 | 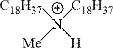 | 26 | 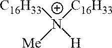 | 27 | 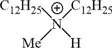 |

Clause 44. The process of any of Clauses 1 to 43, wherein the activator is selected from the group consisting of:
N,N-di(hydrogenated tallow)methylammonium [tetrakis(perfluorophenyl)borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-methyl-4-nonadecyl-N-octadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

Clause 45. The process of any of Clauses 1 to 44, wherein the activator is selected from the group consisting of:
N,N-di(hydrogenated tallow)methylammonium tetrakis(perfluoronaphthalen-2-yl)borate,
N-methyl-4-nonadecyl-N-octadecylanilinium tetrakis(perfluoronaphthalen-2-yl)borate,
N-methyl-4-hexadecyl-N-octadecylanilinium tetrakis(perfluoronaphthalen-2-yl)borate,
N-methyl-4-tetradecyl-N-octadecylanilinium tetrakis(perfluoronaphthalen-2-yl)borate,
N-methyl-4-dodecyl-N-octadecylanilinium tetrakis(perfluoronaphthalen-2-yl)borate,
N-methyl-4-decyl-N-octadecylanilinium tetrakis(perfluoronaphthalen-2-yl)borate,
N-methyl-4-octyl-N-octadecylanilinium tetrakis(perfluoronaphthalen-2-yl)borate,
N-methyl-4-hexyl-N-octadecylanilinium tetrakis(perfluoronaphthalen-2-yl)borate,
N-methyl-4-butyl-N-octadecylanilinium tetrakis(perfluoronaphthalen-2-yl)borate,
N-methyl-4-octadecyl-N-decylanilinium tetrakis(perfluoronaphthalen-2-yl)borate,
N-methyl-4-nonadecyl-N-dodecylanilinium tetrakis(perfluoronaphthalen-2-yl)borate,
N-methyl-4-nonadecyl-N-tetradecylanilinium tetrakis(perfluoronaphthalen-2-yl)borate,
N-methyl-4-nonadecyl-N-hexadecylanilinium tetrakis(perfluoronaphthalen-2-yl)borate,
N-methyl-4-nonadecyl-N-octadecylanilinium tetrakis(perfluoronaphthalen-2-yl)borate,
N-ethyl-4-nonadecyl-N-octadecylanilinium tetrakis(perfluoronaphthalen-2-yl)borate,
N-methyl-N,N-dioctadecylammonium tetrakis(perfluoronaphthalen-2-yl)borate,
N-methyl-N,N-dihexadecylammonium tetrakis(perfluoronaphthalen-2-yl)borate,
N-methyl-N,N-ditetradecylammonium tetrakis(perfluoronaphthalen-2-yl)borate,
N-methyl-N,N-didodecylammonium tetrakis(perfluoronaphthalen-2-yl)borate,
N-methyl-N,N-didecylammonium tetrakis(perfluoronaphthalen-2-yl)borate,
N-methyl-N,N-dioctylammonium tetrakis(perfluoronaphthalen-2-yl)borate,
N-ethyl-N,N-dioctadecylammonium tetrakis(perfluoronaphthalen-2-yl)borate,
N,N-di(octadecyl)tolylammonium tetrakis(perfluoronaphthalen-2-yl)borate,
N,N-di(hexadecyl)tolylammonium tetrakis(perfluoronaphthalen-2-yl)borate,
N,N-di(tetradecyl)tolylammonium tetrakis(perfluoronaphthalen-2-yl)borate,
N,N-di(dodecyl)tolylammonium tetrakis(perfluoronaphthalen-2-yl)borate,
N-octadecyl-N-hexadecyl-tolylammonium tetrakis(perfluoronaphthalen-2-yl)borate,
N-octadecyl-N-hexadecyl-tolylammonium tetrakis(perfluoronaphthalen-2-yl)borate,
N-octadecyl-N-tetradecyl-tolylammonium tetrakis(perfluoronaphthalen-2-yl)borate,
N-octadecyl-N-dodecyl-tolylammonium tetrakis(perfluoronaphthalen-2-yl)borate,
N-octadecyl-N-decyl-tolylammonium tetrakis(perfluoronaphthalen-2-yl)borate,
N-hexadecyl-N-tetradecyl-tolylammonium tetrakis(perfluoronaphthalen-2-yl)borate,
N-hexadecyl-N-dodecyl-tolylammonium tetrakis(perfluoronaphthalen-2-yl)borate,
N-hexadecyl-N-decyl-tolylammonium tetrakis(perfluoronaphthalen-2-yl)borate,
N-tetradecyl-N-dodecyl-tolylammonium tetrakis(perfluoronaphthalen-2-yl)borate,
N-tetradecyl-N-decyl-tolylammonium tetrakis(perfluoronaphthalen-2-yl)borate,
N-dodecyl-N-decyl-tolylammonium tetrakis(perfluoronaphthalen-2-yl)borate,
N-methyl-N-octadecylanilinium tetrakis(perfluoronaphthalen-2-yl)borate,
N-methyl-N-hexadecylanilinium tetrakis(perfluoronaphthalen-2-yl)borate,
N-methyl-N-tetradecylanilinium tetrakis(perfluoronaphthalen-2-yl)borate,
N-methyl-N-dodecylanilinium tetrakis(perfluoronaphthalen-2-yl)borate,
N-methyl-N-decylanilinium tetrakis(perfluoronaphthalen-2-yl)borate, and
N-methyl-N-octylanilinium tetrakis(perfluoronaphthalen-2-yl)borate.

Clause 46. The process of any of Clauses 1 to 45, wherein the polyolefin has:
an ethylene content of about 9 wt% with the balance being propylene;
a density of about 0.879 g/cm³ (ASTM D1505);
a melt index of about 3.6 g/10 min (ASTM D1238; 190° C., 2.16 kg);
a melt mass flow rate of about 8 g/10 min (230° C., 2.16 kg);
a Shore D hardness of about 34 (ASTM D2240); and
a Vicat softening temperature (VST) of about 77.3° C.

Clause 47. The process of any of Clauses 1 to 46, wherein the polyolefin has:
an ethylene content of about 11 wt% with the balance being propylene;
a density of about 0.873 g/cm³ (ASTM D1505);
a melt index of about 3.7 g/10 min (ASTM D1238; 190° C., 2.16 kg);
a melt mass flow rate of about 8 g/10 min (230° C., 2.16 kg);
a Shore D hardness of about 27 (ASTM D2240); and
a Vicat softening temperature (VST) of about 65.1° C.

Clause 48. The process of any of Clauses 1 to 47, wherein the polyolefin has:
an ethylene content of about 4 wt% with the balance being propylene;
a density of about 0.889 g/cm³ (ASTM D1505);
a melt mass flow rate of about 8 g/10 min (230° C., 2.16 kg);
a Shore D hardness of about 50 (ASTM D2240); and
a Vicat softening temperature (VST) of about 103° C.

Clause 49. The process of any of Clauses 1 to 48, wherein the polyolefin is a propylene-ethylene copolymer having:
a density of about 0.863 g/cm³ (ASTM D1505),
a melt index of about 9.1 g/10 min (ASTM D1238; 190° C., 2.16 kg),
a melt flow rate of about 20 g/10 min, and
an ethylene content of about 15 wt%.

Clause 50. The process of any of Clauses 1 to 49, wherein the polyolefin is a propylene-ethylene copolymer having:
a density of about 0.862 g/cm³ (ASTM D1505),
a melt index of about 1.4 g/10 min (ASTM D1238; 190° C., 2.16 kg),
a melt flow rate of about 3 g/10 min, and
an ethylene content of about 16 wt%.

Clause 51. The process of any of Clauses 1 to 50, wherein the polyolefin is a propylene-ethylene copolymer having:
a density of about 0.874 g/cm³ (ASTM D1505),
a melt index of about 1.1 g/10 min (ASTM D1238; 190° C., 2.16 kg),
a melt flow rate of about 3 g/10 min, and
an ethylene content of about 11 wt%.

Clause 52. The process of any of Clauses 1 to 51, wherein the polyolefin has:
isotactic propylene repeat units,
a density of about 0.865 g/cm³,
a melt mass flow rate of about 45.2 g/10 min (230° C., 2.16 kg), and
an ethylene content of about 13.1 wt%.

### EXAMPLES

The foregoing discussion can be further described with reference to the following non-limiting examples.

As used herein, M1 = Dimethylsilyl Bis (Indenyl) Hafnium Dimethyl and was obtained from W.R. Grace & Co.

N-methyl-4-nonadecyl-N-octadecylaniline was made from N-methylaniline. The aniline was alkylated with octadecylbromide, then formylated in the para position by reacting with dimethylformamide and phosphoryl chloride. A Grignard reaction using bromoctadecylmagnesium chloride followed by hydrogenation installed the nonadecyl group. This amine was dissolved in a solvent and a slight excess of hydrogen chloride in ether was added to form N-methyl-4-nonadecyl-N-octadecylanilinium chloride. To make the borate salt, the isolated ammonium chloride was heated to reflux with a molar equivalent of sodium tetrakis(perfluoronaphthalen-2-yl)borate. A 0.2344 wt% solution of N-methyl-4-nonadecyl-N-octadecylbenzenaminium tetrakis(perfluoronaphthalen-2-yl)borate was prepared in 2-methyl-pentane in a 4 L flask, and a separate solution of 0.0765 wt% M1 (metallocene) in 2-methyl-pentane was prepared in a 4 L flask in a nitrogen environment box at a Continuous Pilot Unit. These two solutions were withdrawn from the 4 L flasks into separate syringe pumps and then pumped through separate feed lines up to a mixing tee approximately 0.5 meters from the polymerization reactor.

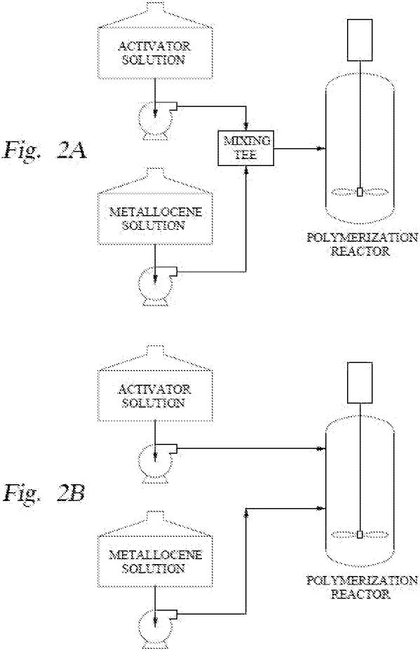

In Experiment A, the two solutions were mixed together at a tee and injected into the polymerization reactor. In Experiment B, the two solutions were injected into the polymerization reactor separately. FIG. 2A illustrates the line-up for Experiment A and FIG. 2B illustrates the line-up for Experiment B.

Vistamaxx® 3980 was produced in the reactor during both experiments following the reactor conditions given in Table 4. (Note: for Table 4, for Experiment A, the catalyst and activator concentrations and feed rates are with respect to injection into the mixing tee. For Experiment B, the catalyst and activator concentrations and feed rates are with respect to direct injection into the reactor.)

TABLE 4

Reactor conditions for Experiments A and B

| | | |
|---|---|---|
| Feed Temperature | deg C. | 12.8 |
| Reactor Outlet Temperature | deg C. | 75.6 |
| Ethylene feed rate | g/hr | 1.095 |
| Propylene feed rate | g/hr | 14.440 |
| Metallocene solution concentration | wt% | 0.0765 |
| Metallocene solution feed rate | mL/min | 2.95 |
| Activator solution concentration | wt% | 0.2344 |
| Activator solution feed rate | mL/min | 3.20 |
| Tri-n-octylaluminum solution feed rate | g/hr | 4.27 |
| Ethylene Conversion | wt% | 67.3 |
| Propylene Conversion | wt% | 49.7 |
| Ethylene Concentration | mol/L | 0.0450 |
| Propylene Concentration | mol/L | 1.2369 |
| C3=/C2= | w/w | 13.187 |

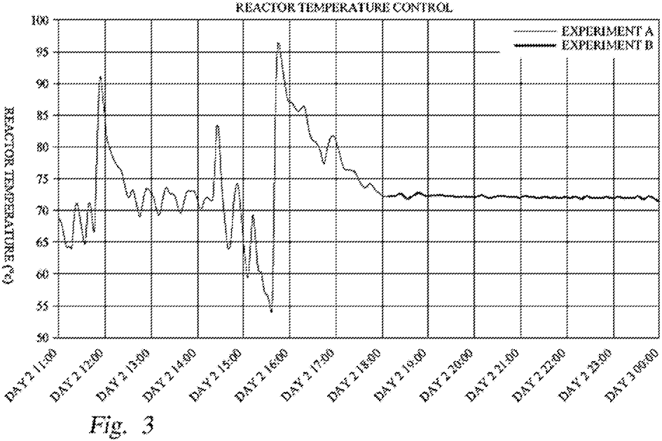

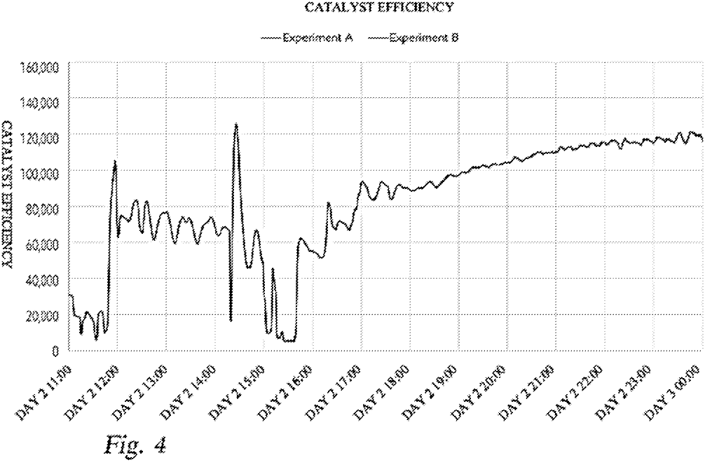

Experiment A, pre-mixing metallocene and activator, was conducted at the beginning of the run on Day 1 at approximately 15:00. The switch to Experiment B was made on Day 2 at approximately 18:00 without stopping the polymerization reaction by changing the valve lineup to separately inject the metallocene solution and activator solution. As seen in FIG. 3, this significantly improved reactor temperature control (e.g., small temperature delta), and illustrates an advantage for separate injection of the activator and metallocene solutions when using non-aromatic solvents at the concentrations typically used for injection into a polymerization reactor. Furthermore, as seen in FIG. 4, the switch from Experiment A to Experiment B both improved catalyst efficiency and reduced variation over time, illustrating a further advantage for separate injection of the activator and metallocene solutions.

Overall, the present disclosure provides activators that can be partially or completely soluble in non-aromatic diluent. Processes of the present disclosure can provide direct injection of activator and direct injection of catalyst independently into a reactor which provides reduced or eliminated temperature variations during polymerization. In addition, catalyst efficiency is also maintained or improved, as compared to polymerizations using premixing of catalyst with activator in toluene, even though direct injection of catalyst and activator provides very dilute concentrations of catalyst and activator in the reactor before the catalyst is activated. Because of the reduced temperature variations of the processes (as compared to conventional polymerization processes), processes of the present disclosure can provide uniform polymer properties in addition to low aromatic content of the polymers formed.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A process comprising:
introducing a catalyst solution, via a first line, into a reactor, the catalyst solution comprising a catalyst and a first non-aromatic diluent;
introducing an activator solution, via a second line, into the reactor, the activator solution comprising an activator and a second non-aromatic diluent, wherein the second non-aromatic diluent is the same as or different than the first non-aromatic diluent;
operating the reactor under process conditions; and
obtaining an effluent from the reactor, the effluent comprising a polyolefin,
wherein the first line and the second line are coupled with the reactor.

2. The process of claim 1, wherein the catalyst solution is free of the activator.

3. The process of claim 1, wherein the activator solution is free of the catalyst.

4. The process of claim 1, wherein the catalyst solution consists of the catalyst and the non-aromatic diluent.

5. The process of claim 1, wherein the activator solution consists of the activator and the non-aromatic diluent.

6. The process of claim 1, wherein the first non-aromatic diluent is selected from the group consisting of 2-methyl-pentane, isobutane, butane, n-pentane, isopentane, hexanes, isohexane, heptane, octane, dodecane, and mixture(s) thereof.

7. The process of claim 6, wherein the first non-aromatic diluent is 2-methyl-pentane.

8. The process of claim 1, wherein the second non-aromatic diluent is selected from the group consisting of 2-methyl-pentane, isobutane, butane, n-pentane, isopentane, hexanes, isohexane, heptane, octane, dodecane, and mixture(s) thereof.

9. The process of claim 8, wherein the second non-aromatic diluent is 2-methyl-pentane.

10. The process of claim 1, wherein the first non-aromatic diluent has about 1 wt% or less aromatics, based on the weight of first non-aromatic diluent + aromatics.

11. The process of claim 10, wherein the first non-aromatic diluent has 0 wt% aromatics, based on the weight of first non-aromatic diluent + aromatics.

12. The process of claim 1, wherein the second non-aromatic diluent has about 1 wt% or less aromatics, based on the weight of second non-aromatic diluent + aromatics.

13. The process of claim 12, wherein the second non-aromatic diluent has 0 wt% aromatics, based on the weight of second non-aromatic diluent + aromatics.

14. The process of claim 1, wherein the activator solution comprises the activator in an amount of about 0.01 wt% to about 20 wt%, based on the weight of the activator solution.

15. The process of claim 14, wherein the activator solution comprises the activator in an amount of about 0.15 wt% to about 0.3 wt%, based on the weight of the activator solution.

16. The process of claim 1, wherein introducing the activator solution to the reactor is performed at a feed rate of:
about 0.01 kg/hr to about 40 kg/hr, or
about 0.02 L/hr to about 60 L/hr.

17. The process of claim 1, wherein the catalyst solution comprises the catalyst in an amount of about 0.01 wt% to about 20 wt%, based on the weight of the catalyst solution.

18. The process of claim 17, wherein the catalyst solution comprises the catalyst in an amount of about 0.05 wt% to about 0.1 wt%, based on the weight of the catalyst solution.

19. The process of claim 1, wherein introducing the catalyst solution to the reactor is performed at a feed rate of:
about 0.003 kg/hr to about 40 kg/hr, or
about 0.004 L/hr to about 60 L/hr.

20. The process of claim 1, wherein the process conditions comprise a temperature delta of about 0° C. to about 20° C. during a substantial entirety of the process.

21. The process of claim 20, wherein the temperature delta is about 1° C. to about 3° C. during a substantial entirety of the process.

22. The process of claim 1, wherein the effluent has an aromatic content of about 1 wt% or less, based on the weight of the effluent.

23. The process of claim 1, wherein the polyolefin has an aromatic content of about 1 wt% or less, based on the weight of the polyolefin.

24. The process of claim 23, wherein the polyolefin has an aromatic content of 0 wt%, based on the weight of the polyolefin.

25. The process of claim 1, wherein:
the process conditions comprise a temperature of about 130° C. to about 200° C. and a pressure of about 100 bar to about 130 bar, and
the polyolefin is a plastomer.

26. The process of claim 1, wherein:
the process conditions comprise a temperature of about 85° C. to bout 150° C. and a pressure of about 100 bar to about 130 bar, and
the polyolefin is an elastomer.

27. The process of claim 1, wherein:
the process conditions comprise a temperature of about 50° C. to about 80° C. and a pressure of about 100 bar to about 130 bar, and
the polyolefin is a propylene-based polymer.

28. The process of claim 1, wherein the catalyst is represented by the formula: 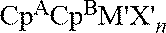
wherein each Cp
^{A} and Cp^{B} is independently selected from cyclopentadienyl ligands or ligands isolobal to cyclopentadienyl, one or both Cp^{A} and Cp^{B} optionally contain heteroatoms, and one or both Cp^{A}and Cp^{B} are optionally substituted by one or more R″ groups; M′ is selected from Groups 3 through 12 atoms and lanthanide Group atoms; X′ is an anionic leaving group; n is 0 or an integer from 1 to 4; each R″ is independently selected from alkyl, heteroalkyl, alkenyl, heteroalkenyl, alkynyl, heteroalkynyl, alkoxy, aryloxy, alkylthio, arylthio, aryl, heteroaryl, aralkyl, aralkylene, alkaryl, alkarylene, haloalkyl, haloalkenyl, haloalkynyl, heteroalkyl, heterocyclyl, silyl, boryl, phosphino, phosphine, amino, ether, and thioether.

29. The process of claim 1, wherein the catalyst is represented by the formula: 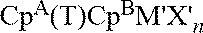
wherein each Cp
^{A} and Cp^{B} is independently selected from cyclopentadienyl ligands or ligands isolobal to cyclopentadienyl, one or both Cp^{A} and Cp^{B} optionally contain heteroatoms, and one or both Cp^{A}and Cp^{B} are optionally substituted by one or more R″ groups; M′ is selected from Groups 3 through 12 atoms and lanthanide Group atoms; X′ is an anionic leaving group; n is 0 or an integer from 1 to 4; (T) is a bridging group selected from divalent alkyl, divalent heteroalkyl, divalent alkenyl, divalent heteroalkenyl, divalent alkynyl, divalent heteroalkynyl, divalent alkoxy, divalent aryloxy, divalent alkylthio, divalent arylthio, divalent aryl, divalent heteroaryl, divalent aralkyl, divalent aralkylene, divalent alkaryl, divalent alkarylene, divalent haloalkyl, divalent haloalkenyl, divalent haloalkynyl, divalent heteroalkyl, divalent heterocyclyl, divalent silyl, divalent boryl, divalent phosphino, divalent phosphine, divalent amino, divalent ether, divalent thioether; and R″ is selected from alkyl, heteroalkyl, alkenyl, heteroalkenyl, alkynyl, heteroalkynyl, alkoxy, aryloxy, alkylthio, arylthio, aryl, heteroaryl, aralkyl, aralkylene, alkaryl, alkarylene, haloalkyl, haloalkenyl, haloalkynyl, heteroalkyl, heterocyclyl, silyl, boryl, phosphino, phosphine, amino, germanium, ether, and thioether.

30. The process of claim 1, wherein the catalyst is selected from the group consisting of:
bis(cyclopentadienyl)zirconium dichloride,
bis(n-butylcyclopentadienyl)zirconium dichloride,
bis(n-butylcyclopentadienyl)zirconium dimethyl,
bis(pentamethylcyclopentadienyl)zirconium dichloride,
bis(pentamethylcyclopentadienyl)zirconium dimethyl,
bis(pentamethylcyclopentadienyl)hafnium dichloride,
bis(pentamethylcyclopentadienyl)zirconium dimethyl,
bis(1-methyl-3-n-butylcyclopentadienyl)zirconium dichloride,
bis(1-methyl-3-n-butylcyclopentadienyl)zirconium dimethyl,
bis(1-methyl-3-n-butylcyclopentadienyl)hafnium dichloride,
bis(1-methyl-3-n-butylcyclopentadienyl)zirconium dimethyl,
bis(indenyl)zirconium dichloride,
bis(indenyl)zirconium dimethyl,
bis(tetrahydro-1-indenyl)zirconium dichloride,
bis(tetrahydro-1-indenyl)zirconium dimethyl,
(n-propyl cyclopentadienyl, pentamethyl cyclopentadienyl)zirconium dichloride, and
(n-propyl cyclopentadienyl, pentamethyl cyclopentadienyl)zirconium dimethyl.

31. The process of claim 1, wherein the catalyst is selected from the group consisting of:
dimethylsilylbis(tetrahydroindenyl)MX_{n,}
dimethylsilylbis(2-methylindenyl)MX_{n,}
dimethylsilylbis(2-methylfluorenyl)MXₙ,
dimethylsilylbis(2-methyl-5,7-propylindenyl)MXₙ,
dimethylsilylbis(2-methyl-4-phenylindenylMXₙ,
dimethylsilylbis(2-ethyl-5-phenylindenyl)MXₙ,
dimethylsilylbis(2-methyl-4-biphenylindenyl)MXₙ,
dimethylsilylenebis(2-methyl-4-carbazolylindenyl)MXₙ,
rac-dimethylsilyl-bis-(5,6,7,8-tetrahydro-5,5,8,8-tetramethyl-2-methyl-1H-benz(f)indene)MXₙ,
diphenylmethylene (cyclopentadienyl)(fluorenyl)MXₙ,
bis(methylcyclopentadienylMXₙ,
rac-dimethylsilylbis(2-methyl,3-propyl indenyl)MXₙ,
dimethylsilylbis(indenyl)MXₙ,
Rac-meso-diphenylsilyl-bis(n-propylcyclopentadienyl)MXₙ,
1,1′-bis(4-triethylsilylphenyl)methylene-(cyclopentadienyl)(3,8-di-tertiary-butyl-1-
fluorenyl)MXₙ (bridge is considered the 1 position),
bis-trimethylsilylphenyl-methylene(cyclopentadienyl)(di-t-butylfluorenyl)MXn,
bis-trimethylsilylphenyl-methylene(cyclopentadienyl)(fluorenyl)MXn,
bisphenylmethylene(cyclopentadienyl)(dimethylfluorenyl)MXn,
bis(n-propylcyclopentadienyl)MXₙ,
bis(n-butylcyclopentadienyl)MXₙ,
bis(n-pentylcyclopentadienyl)MXₙ,
(n-propyl cyclopentadienyl)(n-butylcyclopentadienyl)MXₙ,
bis[(2-trimethylsilylethyl)cyclopentadienyl]MXₙ,
bis(trimethylsilyl cyclopentadienyl)MXₙ,
dimethylsilylbis(n-propylcyclopentadienyl)MXₙ,
dimethylsilylbis(n-butylcyclopentadienyl)MXₙ,
bis(1-n-propyl-2-methylcyclopentadienyl)MXₙ,
(n-propylcyclopentadienyl)(1-n-propyl-3-n-butylcyclopentadienyl)MXₙ,
bis(1-methyl, 3-n-butyl cyclopentadienyl)MXₙ,
bis(indenyl)MXₙ,
dimethylsilyl (tetramethylcyclopentadienyl)(cyclododecylamido)MXₙ,
dimethylsilyl (tetramethylcyclopentadienyl)(t-butylamido)MXₙ,
µ-(CH₃)₂Si(cyclopentadienyl)(1-adamantylamido)MXₙ,
µ-(CH₃)₂Si(3-tertbutylcyclopentadienyl)(1-adamantylamido)MXₙ,
µ-(CH₃)₂(tetramethylcyclopentadienyl)(1-adamantylamido)MXₙ,
µ-(CH₃)₂Si(tetramethylcyclopentadienyl(1-adamantylamido)MXₙ,
µ-(CH₃)₂C(tetramethylcyclopentadienyl(1-adamantylamido)MXₙ,
µ-(CH₃)₂Si(tetramethylcyclopentadienyl)(1-tertbutylamido)MXₙ,
µ-(CH₃)₂Si(fluorenyl)(1-tertbutylamido)MXₙ,
µ-(CH₃)₂Si(tetramethylcyclopentadienyl)(1-cyclododecylamido)MXₙ,
µ-(C₆H₅)₂C(tetramethylcyclopentadienyl)(1-cyclododecylamido)MXₙ, and
µ-(CH₃)₂Si(η⁵-2,6,6-trimethyl-1,5,6,7-tetrahydro-s-indacen-1-yl)(tertbutylamido)MXₙ, wherein:
M is Ti, Zr, or Hf;
each X is independently selected from the group consisting of halogen, hydride, C₁₋₁₂ alkyl, C₂₋₁₂ alkenyl, C₆₋₁₂ aryl, C₇₋₂₀ alkylaryl, C₁₋₁₂ alkoxy, C₆₋₁₆ aryloxy, C₇₋₁₈ alkylaryloxy, C₁₋₁₂ fluoroalkyl, and C₆₋₁₂ fluoroaryl, and
n is zero or an integer from 1 to 4.

32. The process of claim 1, wherien the catalyst is selected from the group consisting of:
bis(1-methyl, 3-n-butyl cyclopentadienyl) M(R)₂;
dimethylsilyl bis(indenyl)M(R)₂;
bis(indenyl)M(R)₂;
dimethylsilyl bis(tetrahydroindenyl)M(R)₂;
bis(n-propylcyclopentadienyl)M(R)₂;
dimethylsilyl (tetramethylcyclopentadienyl)(cyclododecylamido)M(R)₂;
dimethylsilyl (tetramethylcyclopentadienyl)(cyclododecylamido)M(R)₂;
dimethylsilyl (tetramethylcyclopentadienyl)(t-butylamido)M(R)₂;
dimethylsilyl (tetramethylcyclopentadienyl)(t-butylamido)M(R)₂;
µ-(CH₃)₂Si(cyclopentadienyl)(1-adamantylamido)M(R)₂;
µ-(CH₃)₂Si(3-tertbutylcyclopentadienyl)(1-adamantylamido)M(R)₂;
µ-(CH₃)₂(tetramethylcyclopentadienyl)(1-adamantylamido)M(R)₂;
µ-(CH₃)₂Si(tetramethylcyclopentadienyl)(1-adamantylamido)M(R)₂;
µ-(CH₃)₂C(tetramethylcyclopentadienyl)(1-adamantylamido)M(R)₂;
µ-(CH₃)₂Si(tetramethylcyclopentadienyl)(1-tertbutylamido)M(R)₂;
µ-(CH₃)₂Si(fluorenyl)(1-tertbutylamido)M(R)₂;
µ-(CH₃)₂Si(tetramethylcyclopentadienyl)(1-cyclododecylamido)M(R)₂;
µ-(C₆H₅)₂C(tetramethylcyclopentadienyl)(1-cyclododecylamido)M(R)₂; and
µ-(CH₃)₂Si(η⁵-2,6,6-trimethyl-1,5,6,7-tetrahydro-s-indacen-1-yl)(tertbutylamido)M(R)₂; wherein:
M is Ti, Zr, or Hf; and
R is selected from the group consisting of halogen and C₁ to C₅ alkyl.

33. The process of claim 1, wherein the catalyst is selected from the group consisting of:
dimethylsilyl (tetramethylcyclopentadienyl)(cyclododecylamido)titanium dimethyl;
dimethylsilyl (tetramethylcyclopentadienyl)(cyclododecylamido)titanium dimethyl;
dimethylsilyl (tetramethylcyclopentadienyl)(t-butylamido)titanium dimethyl;
dimethylsilyl (tetramethylcyclopentadienyl)(t-butylamido)titanium dimethyl;
µ-(CH₃)₂Si(cyclopentadienyl)(1-adamantylamido)titanium dimethyl;
µ-(CH₃)₂Si(3-tertbutylcyclopentadienyl)(1-adamantylamido)titanium dimethyl;
µ-(CH₃)₂(tetramethylcyclopentadienyl)(1-adamantylamido)titanium dimethyl;
µ-(CH₃)₂Si(tetramethylcyclopentadienyl)(1-adamantylamido)titanium dimethyl;
µ-(CH₃)₂C(tetramethylcyclopentadienyl)(1-adamantylamido)titanium dimethyl;
µ-(CH₃)₂Si(tetramethylcyclopentadienyl)(1-tertbutylamido)titanium dimethyl;
µ-(CH₃)₂Si(fluorenyl)(1-tertbutylamido)titanium dimethyl;
µ-(CH₃)₂Si(tetramethylcyclopentadienyl)(1-cyclododecylamido)titanium dimethyl;
µ-(C₆H₅)₂C(tetramethylcyclopentadienyl)(1-cyclododecylamido)titanium dimethyl; and
µ-(CH₃)₂Si(η⁵-2,6,6-trimethyl-1,5,6,7-tetrahydro-s-indacen-1-yl)(tertbutylamido)titanium dimethyl.

34. The process of claim 1, wherein the catalyst is selected from the group consisting of:
bis(1-methyl, 3-n-butyl cyclopentadienyl)hafnium dimethyl,
bis(1-methyl, 3-n-butyl cyclopentadienyl)zirconium dimethyl,
dimethylsilyl bis(indenyl)zirconium dimethyl,
dimethylsilyl bis(indenyl)hafnium dimethyl,
bis(indenyl)zirconium dimethyl,
bis(indenyl)hafnium dimethyl,
dimethylsilyl bis(tetrahydroindenyl)zirconium dimethyl,
bis(n-propylcyclopentadienyl)zirconium dimethyl,
dimethylsilylbis(tetrahydroindenyl)hafnium dimethyl,
dimethylsilyl bis(2-methylindenyl)zirconium dimethyl,
dimethylsilyl bis(2-methylfluorenyl)zirconium dimethyl,
dimethylsilyl bis(2-methylindenyl)hafnium dimethyl,
dimethylsilyl bis(2-methylfluorenyl)hafnium dimethyl,
dimethylsilyl bis(2-methyl-5,7-propylindenyl) zirconium dimethyl,
dimethylsilyl bis(2-methyl-4-phenylindenyl) zirconium dimethyl,
dimethylsilyl bis(2-ethyl-5-phenylindenyl) zirconium dimethyl,
dimethylsilyl bis(2-methyl-4-biphenylindenyl) zirconium dimethyl,
dimethylsilylenebis(2-methyl-4-carbazolylindenyl) zirconium dimethyl,
rac-dimethylsilyl-bis-(5,6,7,8-tetrahydro-5,5,8,8-tetramethyl-2-methyl-1H-
benz(f)indene)hafnium dimethyl,
diphenylmethylene (cyclopentadienyl)(fluorenyl)hafnium dimethyl,
bis(methylcyclopentadienyl)zirconium dimethyl,
rac-dimethylsilylbis(2-methyl,3-propyl indenyl)hafnium dimethyl,
dimethylsilylbis(indenyl)hafnium dimethyl,
dimethylsilylbis(indenyl)zirconium dimethyl,
dimethyl rac-dimethylsilyl-bis-(5,6,7,8-tetrahydro-5,5,8,8-tetramethyl-2-methyl-1H-benz(f)indene)hafnium dimethyl,
Rac-meso-diphenylsilyl-bis(n-propylcyclopentadienyl)hafnium dimethyl,
1,1′-bis(4-triethylsilylphenyl)methylene-(cyclopentadienyl)(3,8-di-tertiary-butyl-1-fluorenyl)hafnium Xₙ (bridge is considered the 1 position),
bis-trimethylsilylphenyl-methylene(cyclopentadienyl)(di-t-butylfluorenyl)hafnium dimethyl,
bis-trimethylsilylphenyl-methylene(cyclopentadienyl)(fluorenyl)hafnium dimethyl,
bisphenylmethylene(cyclopentadienyl)(dimethylfluorenyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl,
bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl,
bis(n-propylcyclopentadienyl)hafnium dimethyl,
bis(n-butylcyclopentadienyl)hafnium dimethyl,
bis(n-pentylcyclopentadienyl)hafnium dimethyl,
(n-propyl cyclopentadienyl)(n-butylcyclopentadienyl)hafnium dimethyl,
bis[(2-trimethylsilylethyl)cyclopentadienyl]hafnium dimethyl,
bis(trimethylsilyl cyclopentadienyl)hafnium dimethyl,
dimethylsilylbis(n-propylcyclopentadienyl)hafnium dimethyl,
dimethylsilylbis(n-butylcyclopentadienyl)hafnium dimethyl,
bis(1-n-propyl-2-methylcyclopentadienyl)hafnium dimethyl,
(n-propylcyclopentadienyl)(1-n-propyl-3-n-butylcyclopentadienyl)hafnium dimethyl, and
dimethylsilyl(3-n-propylcyclopentadienyl)(tetramethylcyclopentadienyl)zirconium dimethyl.

35. The process of claim 31, wherein the catalyst is selected from the group consisting of:
dimethylsilyl bis(indenyl)zirconium dimethyl, and
dimethylsilyl bis(indenyl)hafnium dimethyl.

36. The process of claim 1, wherein the activator is represented by Formula (AI): 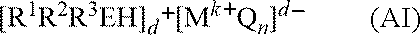
wherein:
E is nitrogen or phosphorous;
each d is the same and is 1, 2 or 3;
k is 1, 2, or 3;
n is 1, 2, 3, 4, 5, or 6;
n - k = d;
each of R¹, R², and R³ is independently selected from the group consisting of H, C₁-C₄₀ alkyl, and C₅-C₅₀-aryl; wherein R¹, R², and R³ together comprise 15 or more carbon atoms;
M is an element selected from group 13 of the Periodic Table of the Elements; and
each Q is independently selected from the group consisting of hydrogen, bridged or unbridged dialkylamido, halide, alkoxide, aryloxide, hydrocarbyl, halocarbyl.

37. The process of claim 36, wherein:
E is nitrogen,
M is boron, and
n is 4.

38. The process of claim 37, wherein each Q is a fluorinated aryl group.

39. The process of claim 38, wherein each Q is perfluoronaphthyl.

40. The process of claim 36, wherein R¹ of Formula (AI) is a C₁-C₃₀ alkyl group, and each of R² and R³ of Formula (AI) is independently branched or linear C₁-C₄₀ alkyl group or meta and or para-substituted phenyl group, wherein the meta or para substituents are, independently, a C₁ to C₄₀ hydrocarbyl group, an alkoxy group, a silyl group, a halogen, or a halogen containing group.

41. The process of claim 36, wherein R¹, R², and R³ together comprise 35 or more carbon atoms.

42. The process of claim 41, wherein:
R¹ is selected from the group consisting of methyl, ethyl, propyl, butyl, and pentyl, and
each of R² and R³ is independently C₁-C₄₀ branched or linear alkyl or C₅-C₅₀-aryl.

43. The process of claim 36, wherein [R¹R²R³EH] of Formula (AI) is selected from the group consisting of:

| | | | | | |
|---|---|---|---|---|---|
| 1 | 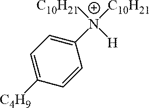 | 2 | 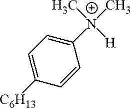 | 3 | 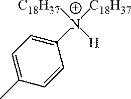 |
| 4 | 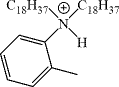 | 5 | 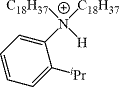 | 6 | 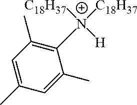 |
| 7 | 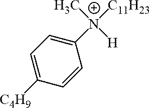 | 8 | 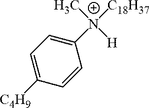 | 9 | 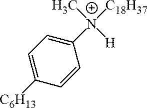 |
| 10 | 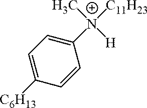 | 11 | 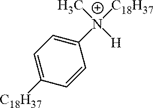 | 12 | 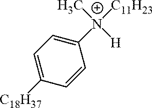 |
| 13 | 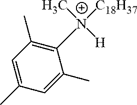 | 14 | 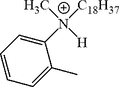 | 15 | 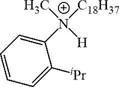 |
| 16 | 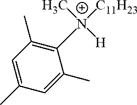 | 17 | 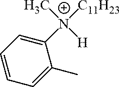 | 18 | 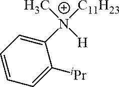 |
| 19 | 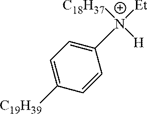 | 20 | 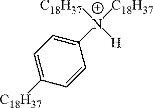 | 21 | 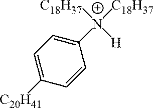 |
| 22 | 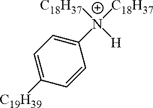 | 23 | 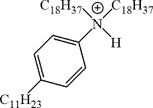 | 24 | 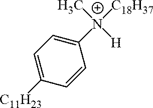 |
| 25 | 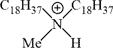 | 26 | 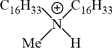 | 27 | 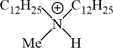 |

.

44. The process of claim 1, wherein the activator is selected from the group consisting of:
N,N-di(hydrogenated tallow)methylammonium [tetrakis(perfluorophenyl)borate],
N-methyl-4-nonadecyl-N-octadecylanilinium [tetrakis(perfluorophenyl)borate],
N-methyl-4-hexadecyl-N-octadecylanilinium [tetrakis(perfluorophenyl)borate],
N-methyl-4-tetradecyl-N-octadecylanilinium [tetrakis(perfluorophenyl)borate],
N-methyl-4-dodecyl-N-octadecylanilinium [tetrakis(perfluorophenyl)borate],
N-methyl-4-decyl-N-octadecylanilinium [tetrakis(perfluorophenyl)borate],
N-methyl-4-octyl-N-octadecylanilinium [tetrakis(perfluorophenyl)borate],
N-methyl-4-hexyl-N-octadecylanilinium [tetrakis(perfluorophenyl)borate],
N-methyl-4-butyl-N-octadecylanilinium [tetrakis(perfluorophenyl)borate],
N-methyl-4-octadecyl-N-decylanilinium [tetrakis(perfluorophenyl)borate],
N-methyl-4-nonadecyl-N-dodecylanilinium [tetrakis(perfluorophenyl)borate],
N-methyl-4-nonadecyl-N-tetradecylanilinium [tetrakis(perfluorophenyl)borate],
N-methyl-4-nonadecyl-N-hexadecylanilinium [tetrakis(perfluorophenyl)borate],
N-methyl-4-nonadecyl-N-octadecylanilinium [tetrakis(perfluorophenyl)borate],
N-ethyl-4-nonadecyl-N-octadecylanilinium [tetrakis(perfluorophenyl)borate],
N-methyl-N,N-dioctadecylammonium [tetrakis(perfluorophenyl)borate],
N-methyl-N,N-dihexadecylammonium [tetrakis(perfluorophenyl)borate],
N-methyl-N,N-ditetradecylammonium [tetrakis(perfluorophenyl)borate],
N-methyl-N,N-didodecylammonium [tetrakis(perfluorophenyl)borate],
N-methyl-N,N-didecylammonium [tetrakis(perfluorophenyl)borate],
N-methyl-N,N-dioctylammonium [tetrakis(perfluorophenyl)borate],
N-ethyl-N,N-dioctadecylammonium [tetrakis(perfluorophenyl)borate],
N,N-di(octadecyl)tolylammonium [tetrakis(perfluorophenyl)borate],
N,N-di(hexadecyl)tolylammonium [tetrakis(perfluorophenyl)borate],
N,N-di(tetradecyl)tolylammonium [tetrakis(perfluorophenyl)borate],
N,N-di(dodecyl)tolylammonium [tetrakis(perfluorophenyl)borate],
N-octadecyl-N-hexadecyl-tolylammonium [tetrakis(perfluorophenyl)borate],
N-octadecyl-N-hexadecyl-tolylammonium [tetrakis(perfluorophenyl)borate],
N-octadecyl-N-tetradecyl-tolylammonium [tetrakis(perfluorophenyl)borate],
N-octadecyl-N-dodecyl-tolylammonium [tetrakis(perfluorophenyl)borate],
N-octadecyl-N-decyl-tolylammonium [tetrakis(perfluorophenyl)borate],
N-hexadecyl-N-tetradecyl-tolylammonium [tetrakis(perfluorophenyl)borate],
N-hexadecyl-N-dodecyl-tolylammonium [tetrakis(perfluorophenyl)borate],
N-hexadecyl-N-decyl-tolylammonium [tetrakis(perfluorophenyl)borate],
N-tetradecyl-N-dodecyl-tolylammonium [tetrakis(perfluorophenyl)borate],
N-tetradecyl-N-decyl-tolylammonium [tetrakis(perfluorophenyl)borate],
N-dodecyl-N-decyl-tolylammonium [tetrakis(perfluorophenyl)borate],
N-methyl-N-octadecylanilinium [tetrakis(perfluorophenyl)borate],
N-methyl-N-hexadecylanilinium [tetrakis(perfluorophenyl)borate],
N-methyl-N-tetradecylanilinium [tetrakis(perfluorophenyl)borate],
N-methyl-N-dodecylanilinium [tetrakis(perfluorophenyl)borate],
N-methyl-N-decylanilinium [tetrakis(perfluorophenyl)borate], and
N-methyl-N-octylanilinium [tetrakis(perfluorophenyl)borate].

45. The process of claim 1, wherein the activator is selected from the group consisting of:
N,N-di(hydrogenated tallow)methylammonium tetrakis(perfluoronaphthalen-2-yl)borate,
N-methyl-4-nonadecyl-N-octadecylanilinium tetrakis(perfluoronaphthalen-2-yl)borate,
N-methyl-4-hexadecyl-N-octadecylanilinium tetrakis(perfluoronaphthalen-2-yl)borate,
N-methyl-4-tetradecyl-N-octadecylanilinium tetrakis(perfluoronaphthalen-2-yl)borate,
N-methyl-4-dodecyl-N-octadecylanilinium tetrakis(perfluoronaphthalen-2-yl)borate,
N-methyl-4-decyl-N-octadecylanilinium tetrakis(perfluoronaphthalen-2-yl)borate,
N-methyl-4-octyl-N-octadecylanilinium tetrakis(perfluoronaphthalen-2-yl)borate,
N-methyl-4-hexyl-N-octadecylanilinium tetrakis(perfluoronaphthalen-2-yl)borate,
N-methyl-4-butyl-N-octadecylanilinium tetrakis(perfluoronaphthalen-2-yl)borate,
N-methyl-4-octadecyl-N-decylanilinium tetrakis(perfluoronaphthalen-2-yl)borate,
N-methyl-4-nonadecyl-N-dodecylanilinium tetrakis(perfluoronaphthalen-2-yl)borate,
N-methyl-4-nonadecyl-N-tetradecylanilinium tetrakis(perfluoronaphthalen-2-yl)borate,
N-methyl-4-nonadecyl-N-hexadecylanilinium tetrakis(perfluoronaphthalen-2-yl)borate,
N-methyl-4-nonadecyl-N-octadecylanilinium tetrakis(perfluoronaphthalen-2-yl)borate,
N-ethyl-4-nonadecyl-N-octadecylanilinium tetrakis(perfluoronaphthalen-2-yl)borate,
N-methyl-N,N-dioctadecylammonium tetrakis(perfluoronaphthalen-2-yl)borate,
N-methyl-N,N-dihexadecylammonium tetrakis(perfluoronaphthalen-2-yl)borate,
N-methyl-N,N-ditetradecylammonium tetrakis(perfluoronaphthalen-2-yl)borate,
N-methyl-N,N-didodecylammonium tetrakis(perfluoronaphthalen-2-yl)borate,
N-methyl-N,N-didecylammonium tetrakis(perfluoronaphthalen-2-yl)borate,
N-methyl-N,N-dioctylammonium tetrakis(perfluoronaphthalen-2-yl)borate,
N-ethyl-N,N-dioctadecylammonium tetrakis(perfluoronaphthalen-2-yl)borate,
N,N-di(octadecyl)tolylammonium tetrakis(perfluoronaphthalen-2-yl)borate,
N,N-di(hexadecyl)tolylammonium tetrakis(perfluoronaphthalen-2-yl)borate,
N,N-di(tetradecyl)tolylammonium tetrakis(perfluoronaphthalen-2-yl)borate,
N,N-di(dodecyl)tolylammonium tetrakis(perfluoronaphthalen-2-yl)borate,
N-octadecyl-N-hexadecyl-tolylammonium tetrakis(perfluoronaphthalen-2-yl)borate,
N-octadecyl-N-hexadecyl-tolylammonium tetrakis(perfluoronaphthalen-2-yl)borate,
N-octadecyl-N-tetradecyl-tolylammonium tetrakis(perfluoronaphthalen-2-yl)borate,
N-octadecyl-N-dodecyl-tolylammonium tetrakis(perfluoronaphthalen-2-yl)borate,
N-octadecyl-N-decyl-tolylammonium tetrakis(perfluoronaphthalen-2-yl)borate,
N-hexadecyl-N-tetradecyl-tolylammonium tetrakis(perfluoronaphthalen-2-yl)borate,
N-hexadecyl-N-dodecyl-tolylammonium tetrakis(perfluoronaphthalen-2-yl)borate,
N-hexadecyl-N-decyl-tolylammonium tetrakis(perfluoronaphthalen-2-yl)borate,
N-tetradecyl-N-dodecyl-tolylammonium tetrakis(perfluoronaphthalen-2-yl)borate,
N-tetradecyl-N-decyl-tolylammonium tetrakis(perfluoronaphthalen-2-yl)borate,
N-dodecyl-N-decyl-tolylammonium tetrakis(perfluoronaphthalen-2-yl)borate,
N-methyl-N-octadecylanilinium tetrakis(perfluoronaphthalen-2-yl)borate,
N-methyl-N-hexadecylanilinium tetrakis(perfluoronaphthalen-2-yl)borate,
N-methyl-N-tetradecylanilinium tetrakis(perfluoronaphthalen-2-yl)borate,
N-methyl-N-dodecylanilinium tetrakis(perfluoronaphthalen-2-yl)borate,
N-methyl-N-decylanilinium tetrakis(perfluoronaphthalen-2-yl)borate, and
N-methyl-N-octylanilinium tetrakis(perfluoronaphthalen-2-yl)borate.

46. The process of claim 1, wherein the polyolefin has:
an ethylene content of about 9 wt% with the balance being propylene;
a density of about 0.879 g/cm³ (ASTM D1505);
a melt index of about 3.6 g/10 min (ASTM D1238; 190° C., 2.16 kg);
a melt mass flow rate of about 8 g/10 min (230° C., 2.16 kg);
a Shore D hardness of about 34 (ASTM D2240); and
a Vicat softening temperature (VST) of about 77.3° C.

47. The process of claim 1, wherein the polyolefin has:
an ethylene content of about 11 wt% with the balance being propylene;
a density of about 0.873 g/cm³ (ASTM D1505);
a melt index of about 3.7 g/10 min (ASTM D1238; 190° C., 2.16 kg);
a melt mass flow rate of about 8 g/10 min (230° C., 2.16 kg);
a Shore D hardness of about 27 (ASTM D2240); and
a Vicat softening temperature (VST) of about 65.1° C.

48. The process of claim 1, wherein the polyolefin has:
an ethylene content of about 4 wt% with the balance being propylene;
a density of about 0.889 g/cm³ (ASTM D1505);
a melt mass flow rate of about 8 g/10 min (230° C., 2.16 kg);
a Shore D hardness of about 50 (ASTM D2240); and
a Vicat softening temperature (VST) of about 103° C.

49. The process of claim 1, wherein the polyolefin is a propylene-ethylene copolymer having:
a density of about 0.863 g/cm³ (ASTM D1505),
a melt index of about 9.1 g/10 min (ASTM D1238; 190° C., 2.16 kg),
a melt flow rate of about 20 g/10 min, and
an ethylene content of about 15 wt%.

50. The process of claim 1, wherein the polyolefin is a propylene-ethylene copolymer having:
a density of about 0.862 g/cm³ (ASTM D1505),
a melt index of about 1.4 g/10 min (ASTM D1238; 190° C., 2.16 kg),
a melt flow rate of about 3 g/10 min, and
an ethylene content of about 16 wt%.

51. The process of claim 1, wherein the polyolefin is a propylene-ethylene copolymer having:
a density of about 0.874 g/cm³ (ASTM D1505),
a melt index of about 1.1 g/10 min (ASTM D1238; 190° C., 2.16 kg),
a melt flow rate of about 3 g/10 min, and
an ethylene content of about 11 wt%.

52. The process of claim 1, wherein the polyolefin has:
isotactic propylene repeat units,
a density of about 0.865 g/cm³,
a melt mass flow rate of about 45.2 g/10 min (230° C., 2.16 kg), and
an ethylene content of about 13.1 wt%.
